(19) United States
(12) Patent Application Publication
(10) Pub. No.: US 2024/0125030 A1
(43) Pub. Date: Apr. 18, 2024

(54) INTERACTIVE USER APPLICATIONS FOR REMOTELY COMMUNICATING WITH AND TRAINING AUTONOMOUS LAUNDRY SYSTEMS

(71) Applicant: Monotony.ai, Inc., Watertown, MA (US)

(72) Inventors: Benjamin D. Bixby, Newton Highlands, MA (US); Victoria L. Price, Somerville, MA (US); Jesse Sielaff, Norfolk, MA (US); Erin Winslow, Austin, TX (US)

(21) Appl. No.: 18/486,567

(22) Filed: Oct. 13, 2023

Related U.S. Application Data
(60) Provisional application No. 63/379,470, filed on Oct. 14, 2022.

(51) Int. Cl. D06F 33/50; D06F 34/04; D06F 34/32; D06F 89/02

(52) U.S. Cl. CPC D06F 33/50; D06F 34/04; D06F 34/32; D06F 89/02; D06F 2105/58

(57) ABSTRACT

Devices, systems, and methods for communicating between remote users and a system of autonomous robotic devices for processing residential loads of laundry are described. An autonomous robotic laundry system includes plurality of robotic devices configured to process one or more loads of household laundry from a mass of unwashed, non-uniform articles to individually separated, cleaned, folded, and packed laundry articles. In implementations, the autonomous robotic devices are configured to operate based on optional inputs communicated by a device of a remote user to at least one controller in operable communication with the autonomous robotic devices. The robotic devices are configured to determine how to process the deformable laundry articles based on at least one of applying sensor output to a machine learning model and executing routines incorporating the optional inputs. The at least one controller is configured to provide real-time updates of two or more process statuses of the system.

### CROSS-REFERENCE TO RELATED APPLICATIONS

This application claims priority under 35 U.S.C. § 119(e) to U.S. Provisional Patent Application Ser. No. 63/379,470 filed Oct. 14, 2022, titled “Interactive User Applications For Remotely Communicating With and Training Autonomous Laundry Systems,” the entirety of which application is hereby incorporated by reference.

### BACKGROUND

The present disclosure is directed to robotic laundry devices, systems, and methods.

Automating and outsourcing mundane, time-consuming household chores to robotic devices is increasingly common. Time-saving home robots include, for example, floor vacuuming and floor washing robots. Outsourcing responsibilities include, for example, engaging grocery shopping and delivery, and manually operated and human-operator dependent laundry washing and dry-cleaning pick up and return services.

Many homes are appointed with a dedicated washer and dryer for family use. Domestic washers and dryers are increasingly sophisticated and include IoT connectivity features and push notifications for alerting users about cycle progress and energy and resource usage. These technologically advanced machines, however, require human interaction and cannot eliminate the time and manual labor required for processing loads of laundry in the home. Although more modern, “high efficiency” machines are equipped with sensors for metering water usage and dryer temperatures, the efficiency gains are capped by the constraints of sequentially processing single loads of laundry. Additionally, grey water is output to the city water and sewer system for mitigation with each load of laundry processed, and energy is consumed with each load of laundry washed and dried.

Households can outsource laundry chores to laundromat facilities for a fee in exchange for time. Laundromats offering residential mixed load laundering services, however, require human interaction for intake and sorting of dirty laundry, transferring loads from washer to dryer, and then manually folding clean laundry. These are costly processes as measured in time, energy consumption, water consumption, and wastewater output, and they rely on human intervention to keep the process running at every transition and throughout several process steps. This invites delays at every stage. Because these processes are human-dependent and inefficient, the costs are passed along to the customers outsourcing their laundry for cleaning. Human-reliant laundering services also require that employees touch the belongings of the customer, potentially exposing the employee to contaminants in the dirty laundry and potentially exposing the clean laundry to transferable pathogens (e.g., contaminants, bacteria, and viral matter), dust, hair, and other debris emanating from a laundromat employee. In addition to potentially introducing undesirable contact contamination from the employees processing the loads of laundry, a privacy barrier is breached. Outsourcing household laundry to a laundromat involves employees interacting with customers' personal belongings including bodily worn garments. These human processes are inefficient, costly, lack real time communication of laundry processing during laundering operations, and produce inconsistent outcomes because they are subject to variable employee proficiency at each step of the sorting, washing, drying, folding and packing processes.

Autonomous robotic devices are provided to process loads of household laundry and intelligently fold and sort each household's laundry based in part on each household's communicated preferences and requests and to communicate data and query a customer for preferences in real time during laundry processing. Such devices eliminate human contact with deformable laundry articles and autonomously process batches of disparate article types and sizes. As such, the devices need to be designed to be efficient and reliable for replacing the common, human-dependent chore of laundry.

### SUMMARY

In one example, a remote device for displaying laundry status for a user account, includes a network interface configured to communicate over a wired or wireless communication network with at least one controller of an autonomous laundry system configured to wash, dry, and fold a plurality of laundry articles associated with the user account; a graphical user interface including a user display; and a processor configured to receive a communication from the at least one controller via the communication network, and display in response to real time communications from the autonomous laundry system a contemporaneous status of the plurality of laundry articles processed by one or more washing and drying devices and one or more folding devices of the autonomous laundry system, wherein the contemporaneous status includes a visual display of a percentage to completion of each of washing, drying, and folding processes for the plurality of laundry articles received by the autonomous laundry system.

Implementations of the device may include one or more of the following features.

In examples, the autonomous laundry system is configured to count the plurality of articles at an intake step prior to washing the plurality of articles.

In examples, the autonomous laundry system is configured to autonomously track progress of the plurality of articles through the one or more washing and drying devices and the one or more folding devices and the at least one controller is configured to calculate for display a percentage to completion of washing, drying, and folding the plurality of laundry articles.

In examples, the autonomous laundry system is further configured to autonomously track progress of the plurality of laundry articles through an autonomous packing process following the folding process and provide a real time packing status on the display, the autonomous packing process being implemented by an autonomous packing device including one or more sensors configured to detect the plurality of laundry articles processed by the autonomous packing device, the one or more sensors being configured to output one or more signals to the at least one controller indicative of processing one or more of the plurality of laundry articles.

In examples, the autonomous laundry system is configured to identify and track the processing progress of the plurality of laundry articles with one or more sensors disposed above and adjacent the one or more folding devices.

In examples, the autonomous laundry system is configured to identify the one or more washing and drying devices receiving the plurality of laundry articles by tracking one or more laundry bins transported to the one or more washing and drying devices, each one of the one or more laundry bins containing a load of laundry including one or more of the plurality of laundry articles. The one or more identified washing and drying devices are configured to communicate via the network a series of sequential processing updates including washing and drying cycle progress.

In examples, the device further includes an interactive user interface.

In examples, a user can request through the interactive user interface a display of a contemporaneous status of washing, drying, and folding.

In examples, the processor is configured to operate a local user application through which the contemporaneous status of washing, drying, and folding is displayed.

In examples, a device, wherein the at least one controller of the autonomous laundry system is configured to push the contemporaneous status of washing, drying, and folding to the local user application.

In examples, the user is configured to send at least one of a user preference and user instruction to the at least one controller of the autonomous laundry system.

In examples, the display of a contemporaneous status of washing, drying, and folding includes at least three concentric annuli, wherein the percentage of fill within a first annulus of the at least three concentric annuli represents the percentage to completion of washing the plurality of laundry articles, the percentage of fill of a second annulus of the at least three concentric annuli represents the percentage to completion of drying the plurality of laundry articles, and the percentage of fill of a third annulus of the at least three concentric annuli represents the percentage to completion of folding the plurality of laundry articles.

In examples, the display of a contemporaneous status of washing, drying, and folding includes at least one gradually filled status bar including an indication in order of washing, drying, and folding from one end of the bar to an opposite end of the bar.

In examples, the at least one status bar includes a plurality of status bars, wherein each bar represents a unique load of laundry displayed with a load identifier for one or more sorted loads of the plurality of laundry articles.

In examples, the display is generated by a user application program stored in a memory of the device, the user application program being configured to facilitate communication with the autonomous laundry system.

In examples, an autonomous laundry system includes at least one autonomous washing and drying device configured to wash and dry a plurality of household laundry articles associated with a user; at least one autonomous folding device configured to fold the washed and dried plurality of clean household laundry articles; one or more sensors disposed at least one of adjacent to and above at least one of the one or more autonomous folding devices, the one or more sensors being configured to detect the article of clean laundry and output a signal including image data of the article of laundry in at least one of a folded and unfolded state; and at least one controller in operative communication with one or more drives of the at least one autonomous washing and folding device, one or more drives of the at least one autonomous folding device, and the one or more sensors, the at least one controller configured to monitor one or more statuses of the plurality of household laundry articles, the one or more statuses including, a percentage completion of washing, drying, and folding the plurality of household laundry articles at one or more of the one or more autonomous washing and drying devices and one or more of the at least one autonomous folding device; and push a contemporaneous percentage completion status of each of washing, drying, and folding processes for the plurality of household laundry articles to a remote user device for display on a user interface, the remote user device being in communication with the at least one controller via a wired or wireless communication network.

Implementations of the system may include one or more of the following features.

In examples, the remote user device is at least one of a smartphone, a tablet, a smart watch, and a computer.

In examples, the remote user device includes a memory configured to store a user application and a processor configured to execute instructions for running the user application.

In examples, the washing, drying, and folding processes are configured to operate concurrently to process a plurality of laundry loads sorted from the plurality of laundry articles.

In examples, a display of the percentage completion of washing, drying, and folding processes includes a graphic display of concurrently operating processes.

In examples, the graphic display includes at least one of contemporaneous statuses of washing, drying, and folding represented as at three fillable concentric annuli and contemporaneous statuses of washing, drying, and folding represents by at least one gradually filled status bar with an indication in order of washing, drying, and folding from one end of the bar to an opposite end of the bar.

In one example, an autonomous laundry system includes one or more autonomous folding devices each configured to fold a plurality of clean household laundry articles, and at least one spreading station disposed adjacent the one or more autonomous folding devices configured to spread an article of laundry of the plurality of clean household laundry articles for delivery to one of the one or more folding devices, the article of laundry being associated with a user account of a plurality of user accounts stored in at least one memory. The system includes at least one sensor disposed at least one of adjacent to and above at least one of the at least one spreading station and the one or more autonomous folding devices. The at least one sensor is configured to detect the article of clean laundry and output a signal including image data of the article of laundry in at least one of a folded and unfolded state.

The system includes at least one controller in operable communication with the memory, the at least one sensor, one or more drives of each one of the one or more autonomous folding devices, and one or more drives of the at least one spreading station. The at least one controller is configured to receive the output signal of the one or more sensors, process the output signal with one or more machine learning models stored in the at least one memory, and identify, based on an output of processing with the machine learning model, two or more characteristics of the laundry article. The two or more characteristics include at least two of an article type, an unfolded article size, an article shape, one or more article features, and a profile of the user account stored in the at least one memory in communication with the controller. The profile is one of a plurality of profiles associated with the user account and representative of an individual wearer of the laundry article. The at least one controller is configured to retrieve from the at least one memory, based on the identified two or more characteristics, executable instructions executable by the controller for operably controlling the one or more drives of one of the one or more folding devices. The controller is configured to store the image data of the laundry article and a contemporaneous date in the at least one memory in cross-referenced relation to the user account. Storing the image data and contemporaneous date includes at least one of associating the stored image data with stored image data of the laundry article previously output by the at least one sensor and stored in the at least one memory and creating a unique entry for the stored image data and the contemporaneous date for the laundry article not previously detected by the at least one sensor. The at least one controller is configured to retrieve optionally provided user preference data associated with the user account and stored in the at least one memory. The user preference data includes at least one of one or more folding preferences associated with the laundry article and a cluster of laundry articles including the laundry article. The at least one memory is configured to receive and store user preference data including the at least one of one or more folding preferences and the cluster optionally inputted at a remote terminal of an owner of the user account. The at least one controller is configured to instruct the one or more drives of one of the one or more autonomous folding devices to operate to fold the laundry article based on at least one of the retrieved executable instructions and the retrieved optionally provided user preference data.

Implementations of the system may include one or more of the following features.

In examples, the system includes an autonomous queuing device configured to retrieve the folded laundry article from the at least one folding device and deliver the folded laundry article to an ordered location in a queue for packing in a container. In examples, the at least one controller is in operable communication with one or more drives of the autonomous queuing device, and the at least one controller is further configured to instruct, based on at least one of the identified two or more characteristics and the optionally provided user preference data, the autonomous queuing device to intelligently queue for packing the folded laundry article in the ordered location. In examples, the autonomous queuing device is configured to queue the folded laundry article at least one of adjacent to and atop one or more other folded laundry articles to be loaded together into the container. The one or more other folded laundry articles include the at least one of the identified two or more characteristics and the optionally provided user preference data associated with the folded laundry article. In examples, the folded laundry article and one or more other folded laundry articles are queued in one or more stacks in the queue.

In examples, the one or more stacks can include one or more folded laundry articles of similar size. The folded laundry article and one more other folded laundry articles can include the cluster associated with the identified profile. The cluster associated with the identified profile is one of at least one cluster of data stored in the at least one memory in communication with the at least one controller, the at least one cluster of data representing a subset of the plurality of laundry articles. The at least one cluster of data can include an image of each laundry article of the subset, the image being at least one of detected by the one or more sensors and provided by the wearer. A wearer provided image includes an image associated with an article not previously detected by the one or more sensors, and the at least one controller is further configured to replace in the at least one memory a wearer provided image with an image output from the one or more sensors.

In examples, the at least one cluster of data can include default characteristics including at least one of article folded size and article type.

In examples, a user associated with the profile can input commands on a remote device in communication with the at least one controller. The remote device operates at least one of an interactive application and a URL for displaying an image of each of the plurality of laundry articles in a selectable format for selecting one or more clusters by associating each image with one or more characteristics of the two or more characteristics. The user account can include one or more profiles each associated with a unique wearer of one or more of the plurality of laundry articles. The selectable format can include at least one of a selectable radio button, a check box, a drop down selection, a drag and drop selection, a hamburger menu, a text prompt, and a selectable action button accessible by a user input including a touch screen tap, a mouse click, a stylus tap, a voice command, and a keyboard entry.

In examples, the machine learning model includes a classification and object detection model. The machine learning model can include at least one of a decision tree, random forest, k-nearest neighborhood, Bayesian network, support vector machine, and neural network. The machine learning model can include a neural network, and the sensor output is processed with a neural network classifier.

In examples, the at least one sensor is disposed at least one of adjacent to or above the one or more folding devices. The at least one controller is further configured to determine the laundry article is folded and ready for packing based on at least one of: a user input on a remote device in communication with the at least one controller, and processing the received output signal of the one or more sensors with a machine learning model configured to classify an article of laundry as folded. The user input can include at least one of a touch screen tap, a mouse click, a stylus tap, a voice command, and a keyboard entry responsive to a prompt on the remote device in communication with the at least one controller. The at least one controller is further configured to train the machine learning model with the user input.

In examples, the machine learning model is trained on images of the plurality of laundry articles associated with the plurality of user accounts. The memory in communication with the controller is configured to store user defined folding preferences associated with a laundry article and input via a remote computing device in communication with the at least one controller. The at least one controller is further configured to instruct the two or more drives of the one or more folding devices to fold the laundry article according to the user defined folding preferences.

In examples, identifying a profile requires being above a threshold likelihood of accuracy. The at least one controller is configured to prompt a user to identify a profile associated with an image of the laundry article output by the at least one sensor if the determination of the profile is below the threshold likely of accuracy and two or more profiles are associated with a user account.

In examples, the at least one controller is further configured to receive an output from the at least one sensor and provide an image of each laundry article in a plurality of clean household laundry articles to a user account accessible through a user interface including at least one of a URL and a remote device application. The at least one sensor can include an image device disposed at least at two of the spreading station, the at least one folding device, a discharge station adjacent the one or more folding devices from which a queuing device retrieves each folded laundry article, and a queue location at which a folded laundry article is delivered by the queuing device for packing into a container. The at least one controller is further configured to determine whether to provide an image of the laundry article displayed at the user interface in a folded state or an unfolded state based on a determined size of the laundry article. An image of a small or medium size laundry article can be displayed in an unfolded state, and an image of a large laundry article can be displayed in a folded state.

In examples, the at least one controller is configured to push a notification to a user through the user interface to review an image of each one of the plurality of clean household laundry articles. The user interface can be configured to, for each image, provide a user with one or more interactive fields for instructing the at least one controller to take an action with the laundry article based on the image of each one of the clean household laundry articles. The action includes at least one of donate, reassign to another profile, sell, recycle, and store. The at least one controller is further configured to provide a “store” notification prompt on the user interface based on at least article type and season. The e at least one controller is further configured to delete from the at least one memory one or more stored images of a laundry article associated with an account in response to receiving an instruction to sell or donate. The at least one controller is further configured to push at least one of a visible, audible, and haptic prompt a remote user device running the user interface to delete one or more stored images of a laundry article if the at least one sensor has not detected the laundry article in a threshold period of time. The threshold period of time can include a range of about 1 to three months. The threshold period of time can be greater than one season beyond one year from a last date of detection stored in the at least one memory. In examples, the one or more interactive fields for instructing the at least one controller to take an action further includes merging an image of a laundry article with an image of another laundry article associated with the user account and stored in the at least one memory. In examples, the one or more interactive fields for instructing the at least one controller to take an action further includes unassigning an image of a laundry article from an identified laundry article associated with the user account and stored in the at least one memory.

In examples, the one or more autonomous folding devices includes two or more folding devices each disposed within corresponding ones of two or more tiered folding bays.

In examples, each of the one or more autonomous folding devices includes two or more drive motors configured to autonomously drive at least two of a clamp rod configured to clamp the article of laundry to a platter, a sweep rod configured to at least one of smooth the article on the platter and fold the article of laundry onto itself, a blade configured to fold the article of laundry onto itself, and a platter axle (e.g., platter coupling 7165) configured to rotate the platter about a rotational axis between folds.

In examples, the at least one spreading station includes a plurality of lifters disposed about a periphery of the at least one spreading station configured to lift and spread the laundry article above a spreading height in a series of consecutive grips, movements, and releases. The spreading height coincides with a bottom plane of a work volume within which a plurality of lifters receive the laundry article, move to spread the laundry article, and lay the spread laundry article on a top surface of a platter in a spread state for introduction into the one or more folding devices. The at least one sensor in communication with the at least one controller includes one or more sensors disposed about the work volume configured to detect at least one of a presence, orientation, article type, one or more laundry article features, laundry article shape, and spread status of a laundry article disposed within the work volume. Each one of the plurality of lifters includes a moveable arm configured to at least one of pan, tilt, and extend from a stationary support, the moveable arm terminating in an actuatable gripper. Each one of the plurality of lifters includes one or more motor drives in operable communication with the at least one controller.

In examples, the one or more sensors include at least one of a 3-D camera, an IR sensor, a 2-D camera, LIDAR, LADAR, a sonar proximity sensor, an ultrasonic ranging sensor, a radar sensor, and a pair of stereo depth cameras. In examples, the at least one controller is configured to receive an output signal including 3-D image data of the article of laundry. In examples, the at least one controller is configured to receive an output signal including one or more 2-D images of the article of laundry. Determining article type can include performing a size invariant imagery comparison to classified images stored in the at least one memory in communication with the at least one controller.

In examples, the plurality of clean household laundry articles includes two or more laundry articles including at least one of different article types, sizes, and shapes. In examples, each of the two or more articles includes a longest dimension of between about 4 cm to 500 cm. In examples, each one of the one or more folding devices is configured to sequentially receive each one of the plurality of clean household laundry articles thereon, the plurality of clean household laundry articles including at least one of non-identical article types, sizes, and shapes. The plurality of household laundry articles are worn by one or more household members (e.g., one or more wearers) each associated with a unique profile associated with the user account.

In one example, a method of autonomously grouping a plurality of household laundry articles for packing includes receiving at a controller an output signal of one or more sensors disposed adjacent to at least one of one or more autonomous folding devices and an autonomous spreading device, the controller being in operable communication with one or more drives of the at least one autonomous folding device, the autonomous spreading device, and at least one autonomous queuing device. The one or more sensors are configured to detect a laundry article of the plurality of household laundry articles. The method includes processing the output signal with one or more machine learning models stored in at least one memory in communication with the controller, and identifying, based on processing the output signal with the machine learning model, characteristics of the laundry article including at least two of an article type, an unfolded article size, an article shape, and one or more features of the laundry article. The method includes determining, based on at least one of the identified characteristics and data stored in the at least one memory, a profile associated with the laundry article, the profile being stored in the at least one memory in communication with the controller. The method includes identifying a group identifier associated with the laundry article based on at least one of: the two or more determined characteristics, and a group identifier associated with the profile and stored in the at least one memory in communication with the at least one controller. The method includes instructing a drive of a queuing device to queue the folded laundry article with one or more folded laundry articles in a queue including the identified group identifier.

Implementations of the method may include one or more of the following features.

In examples, queuing the folded laundry article includes stacking the folded laundry article on or adjacent to another laundry article in a packing queue.

In examples, the determined profile is one of a plurality of profiles associated with a user account and representative of an individual wearer of the laundry article. The method further includes receiving a group identifier from a remote user device in communication with the controller over a wired or wireless network, and storing the group identifier in the at least one memory. The group identifier is input by a user of the user account accessing an app or URL on the remote user device. In examples, the method further includes retrieving optionally provided user preference data associated with the user account and stored in the at least one memory. The user preference data includes at least one of one or more folding preferences associated with the laundry article and a cluster of laundry articles including the laundry article. The at least one memory is configured to receive and store user preference data including the at least one of one or more folding preferences and the cluster optionally inputted at a remote terminal of an owner of the user account. The method further includes instructing the one or more drives of one of the one or more autonomous folding devices to operate to fold the laundry article based on at least one of the retrieved executable instructions and the retrieved optionally provided user preference data.

In examples, the at least one sensor is disposed at least one of adjacent to and above at least one of the autonomous spreading device and the one or more autonomous folding devices, the at least one sensor being configured to detect the article of clean laundry and output a signal including image data of the article of laundry in at least one of a folded and unfolded state.

In examples, the method further includes storing image data of the laundry article and a contemporaneous date in the at least one memory in cross-referenced relation to a user account. Storing the image data and contemporaneous date includes at least one of associating the stored image data with stored image data of the laundry article previously output by the at least one sensor and stored in the at least one memory, and creating a unique entry for the stored image data and the contemporaneous date for the laundry article not previously detected by the at least one sensor.

### BRIEF DESCRIPTION OF THE DRAWINGS

FIG. 1 depicts a schematic of an example autonomous robotic laundry process line.

FIG. 2 depicts a schematic example of a system for controlling an autonomous robotic process line.

FIG. 3 depicts a schematic example of a system for controlling an autonomous robotic process line.

FIG. 4 depicts an example control system schematic for an autonomous tiered folding system.

FIG. 5 depicts an end perspective end view of an example of an autonomous tiered folding system within an autonomous robotic laundry process line.

FIG. 6 depicts a side view of the example of an autonomous tiered folding system of FIG. 5 within an autonomous robotic laundry process line.

FIG. 7 depicts a top view of an example of the autonomous tiered folding system of FIGS. 5-6 within an autonomous robotic laundry process line.

FIG. 8 depicts an end perspective view of the example of an autonomous tiered folding system of FIGS. 5-7 within an autonomous robotic laundry process line.

FIG. 9 depicts a perspective view of the underside surface of a rotatable platter and an example platter coupling of the autonomous tiered folding system of FIGS. 5-8.

FIG. 10A depicts an end view from an unloading end of a single folding bay of the example tiered folding system of FIGS. 5-8 depicting a rotatable, releasable platter lowered into engagement with a receiving coupling within the bay.

FIG. 10B depicts a partial cutaway perspective view from an unloading end (e.g., second open end) of an example folding bay of an autonomous tiered folding system of FIGS. 5-8 comprising a folding blade suspended above a platter from the top of a folding bay and a clamp rod and a sweep rod movably supported on rails disposed on both sides of the platter adjacent the bottom portion of the folding bay.

FIG. 10C depicts a perspective end view of a plurality of exemplary folding bays of the autonomous tiered folding system of FIGS. 5-8 including example lighting, sensors, folding rods, and a folding blade.

FIG. 11 depicts a schematic of example data stored in a memory in communication with a controller of an autonomous robotic laundry system.

FIGS. 12A-C depict example user interface screens for displaying to a user laundry processing status information communicated by a controller of an autonomous robotic laundry system during various laundry processing and handling stages.

FIG. 13 depicts an example user interface screen displaying to a user laundry processing status information communicated by a controller of an autonomous robotic laundry system.

FIGS. 14A-B depict example user interface screens for displaying to a user laundry processing status information communicated by a controller of an autonomous robotic laundry system during laundry processing by two or more robots.

FIGS. 15A-B depict example user interface screens for displaying to a user laundry processing status information communicated by a controller of an autonomous robotic laundry system.

FIGS. 16A-E depict example interactive user interface screens for displaying to a user laundry images and other information communicated by a controller of an autonomous robotic laundry system and optionally receiving input from the user for communicating information and/or instructions to the controller.

FIGS. 17A-B depict example interactive user interface screens for displaying to a user laundry images and information communicated by a controller of an autonomous robotic laundry system and optionally receiving input from the user for communicating information and/or instructions to the controller.

FIG. 18 depicts an example interactive user interface screen for selectively receiving input from the user communicating information and/or instructions to the controller about one or more laundry articles associated with the user's account.

FIG. 19 depicts an example user interface screen for displaying to a user a laundry article image and status information communicated by a controller of an autonomous robotic laundry system about a selected single laundry article.

FIG. 20 depicts an example interactive user interface screen for selectively receiving input from the user communicating information and/or instructions to the controller about the single displayed laundry article of FIG. 18.

FIGS. 21A-C depict example interactive user interface screens for selectively receiving interactive input from the user to sort and/or display laundry articles associated with the user account and having selected characteristics and/or identifiers.

FIG. 22 depicts a schematic of example communications between a user, the robotic laundry system, and a controller of the robotic laundry system for associating an article with a profile.

FIG. 23 depicts an example method for processing a laundry article through a robotic laundry system and optionally receiving user communications to control one or more devices of the autonomous laundry system.

FIG. 24 depicts an example method of processing a laundry article through a robotic laundry system and optionally receiving communicated user inputs to control one or more devices of the autonomous laundry system.

FIG. 25 depicts an example schematic of a neural network configured to be utilized by the autonomous laundry system of FIGS. 1 through 8.

### DETAILED DESCRIPTION

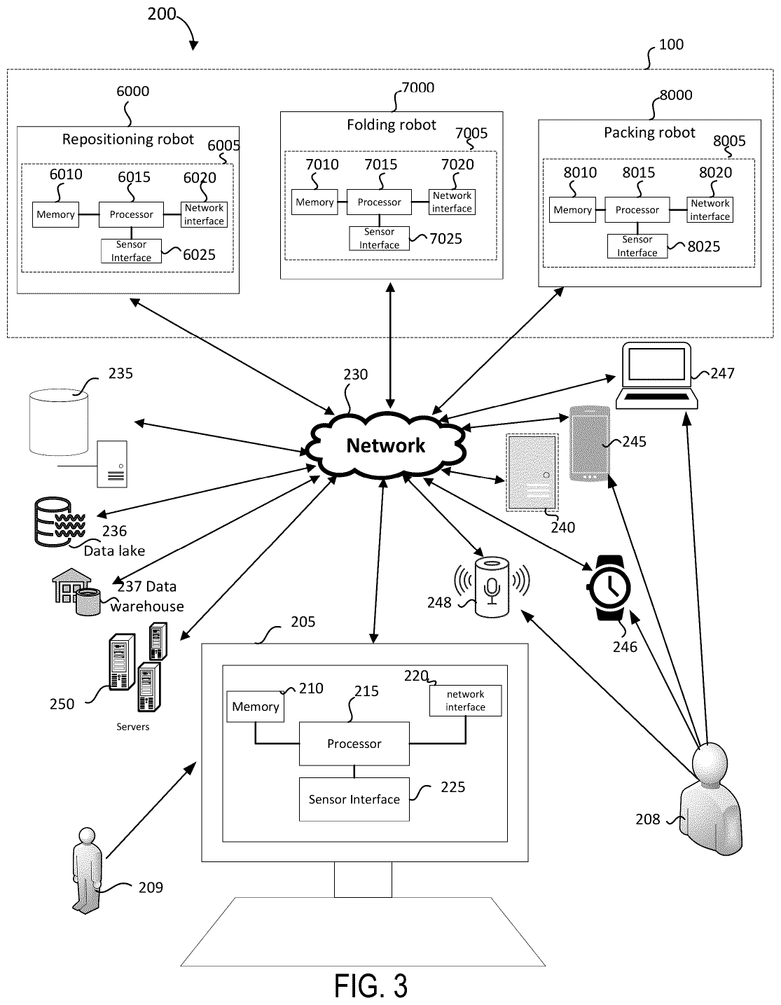

This disclosure relates to devices, systems, and methods for communicating between remote users (e.g., customers) and autonomous robotic devices and systems for handling residential loads of laundry. An autonomous robotic laundry system includes one or more autonomous process lines comprising a plurality of robotic devices configured to work in concert to process a dirty load of household laundry from a mass of dirty, non-uniform articles to individually separated, cleaned, and folded laundry articles. The laundry articles are collected from a household and delivered to an autonomous robotic process line for cleaning. The plurality of autonomous robotic devices in the process line operate without human intervention to efficiently and effectively launder a customer's dirty items and include autonomous robotic devices configured to autonomously spread and fold clean, deformable laundry articles for introduction to an autonomous packing robot. In implementations, the autonomous robotic devices are configured to operate based on optional inputs communicated by a device (e.g., smartphone 245 in FIG. 3) of a remote user (e.g., user 208 in FIG. 3) to at least one controller (e.g., controller 6005, 7005, 8005 in FIG. 3) in operable communication with the autonomous robotic devices (e.g., devices 6000, 7000, 8000 in FIG. 3). The autonomous robotic devices are configured to determine how to process the plurality of deformable laundry article types (e.g., operate various motor drives) based on at least one of applying sensor output to a machine learning model and applying the optional inputs of the remote user. The autonomous processes are time and cost efficient, eliminate human intervention-based delays, eliminate line workers and associated introduction of human contaminants introduced by line workers, and eliminate any concerns with having private personal items handled by strangers. Additionally, the autonomous robotic devices process real time data and track real time status of the plurality of deformable articles throughout the process (e.g., sorting, washing, drying, folding, and packing) and generate real time updates of the totality of processed laundry articles at one or more stages of processing. The real time updates are pushed to a remote device of the remote user for display on a graphical user interface. Additionally, the at least one controller can communicate with and query a user for inputs used to further improve autonomous processes over time. User feedback (e.g., quality of folding, clustering of garments for packing, etc.) therefore improves efficiency and efficacy of at least the folding and packing processes to address individual customer satisfaction and global customer satisfaction.

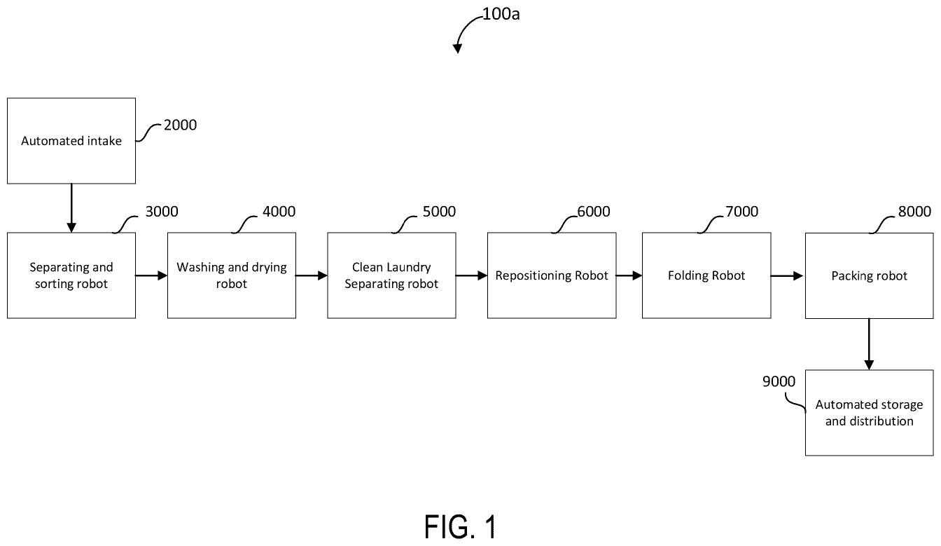

As shown in FIG. 1, in implementations of the system, a process line 100a comprises a plurality of autonomous robots configured to operate in series without human intervention to process and transport dirty laundry through the cleaning process and fold and repack the clean laundry for return to a household. In one implementation, the process line 100a comprises an autonomous intake robot 2000 for receiving a load of dirty household laundry comprising a plurality of deformable laundry articles. The deformable laundry articles can be non-uniform in type, size, shape, color, and fabric and can require particular treatment and handling. For example, the plurality of deformable laundry articles can include items commonly laundered in homes, such as sheets, towels, tablecloths, and adult and children's garments, for example, tee shirts, pants, socks, undergarments, hooded sweatshirts, baby socks, wash cloths, dresses, open front dress shirts, and blouses. The autonomous intake robot 2000 is configured to introduce the plurality of deformable laundry articles to a separating and sorting robot 3000 configured to separate out each one of the deformable laundry articles of the plurality of deformable laundry articles pertaining to a single customer and/or household. In implementations, the separating and sorting robot 3000 is configured to sort each one of the separated deformable laundry articles into one or more related batches for washing. In implementations, the separating and sorting robot 3000 is configured to intelligently batch the separated each one of the deformable laundry articles into its own dedicated load or into a load with at least one other separated deformable laundry article according to a programmed sorting algorithm. The programmed sorting algorithm can be based, for example, on criteria including at least one of material color, material type, customer washing preference, water temperature requirements, and load size. In implementations, the separating and sorting robot 3000 is configured to identify and record the number, types, and sizes of garments in the load of laundry and provide this information to one or more robots in the process line 100a.

The separating and sorting robot 3000 outputs one or more intelligently sorted batches of deformable laundry articles to one or more washing and drying robots 4000 for laundering. The one or more washing and drying robots 4000 output the clean laundry articles to a clean laundry separating robot 5000. Implementations of the clean laundry separating robot 5000 can be similar or identical to the separating and sorting robot 3000. The clean laundry separating robot 5000 is configured to separate a load of clean laundry into individual deformable laundry articles for introduction into a repositioning robot 6000. In implementations to be described herein in detail, the repositioning robot 6000 receives a single deformable laundry article and manipulates and repositions it for automated introduction into a folding robot 7000, which automatically folds the laundry article for introduction to a packing robot 8000. In implementations, the packing robot 8000 automatically packs the clean load of laundry comprising the plurality of clean and folded deformable laundry articles in a shipping container for automated redistribution to the customer. In implementations, the shipping container is a reusable container. In implementations, the shipping container is a disposable container. In implementations, the shipping container is a non-deformable container with an ingress protection rating that includes an intrusion protection rating of 5 or 6 and a moisture protection rating of any and all of 1 through 6 in accordance with the Ingress Protection Code, IEC standard 60529.

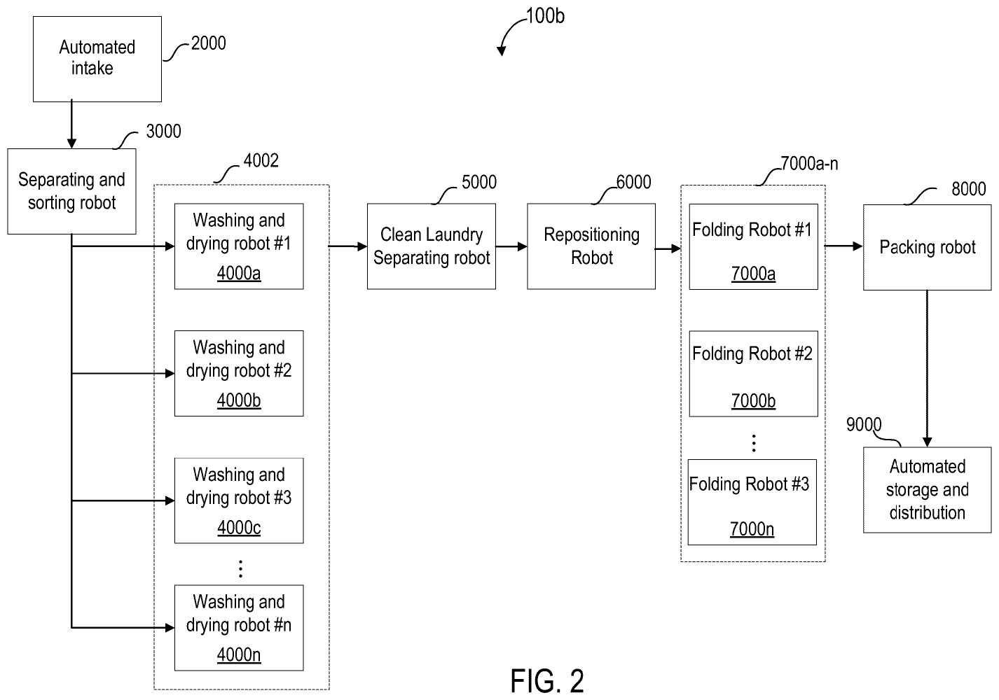

Implementations of the process line 100a of household laundry cleaning robots can comprise one or more of each of the robots depicted in FIG. 1. For example, as shown in FIG. 2, each autonomous process line 100b can include a plurality of washing and drying robots 4000a-n (where “n” represents a count of robots greater than 1). In implementations, the plurality of washing and drying robots 4000a-n comprises one or more clusters 4002 of washing and drying robots 4000a-n accessing shared services (e.g., water, air, washing chemicals, etc.) delivered to each cluster 4002. Additionally or alternatively, in implementations, the autonomous process line 100b includes a plurality of washing and drying robots 4000a-n shared by two or more sets of automated intake robots 2000 and dirty laundry separating and sorting robots 3000 and two or more sets of clean laundry separating robots 5000, repositioning robots 6000, folding robots 7000, and packing robots 8000.

Additionally or alternatively, the process line 100b can include a plurality of folding robots 7000a-n (where “n” represents a count of robots greater than 1) configured to receive spread apart and/or reposition clean laundry articles from one or more repositioning robots 6000. In implementations, having the number of folding robots 7000a-n exceed a number of repositioning robots can prevent a process bottleneck at the folding operation. In implementations, having one repositioning robot 6000 delivering spread laundry articles to at least 2 folding robots results in a throughput time savings in a range of between about 30% to 50% over a one-to-one pairing of a repositioning robot 6000 to a single folding robot 7000. Additionally or alternatively, in implementations, a plurality of folding robots 7000a-n can be stacked, or tiered, to reduce overall floor space occupancy of the process line 100b within a facility. Additionally, two or more of the robots in a process line 100, 100a-b (collectively referred to hereinafter as “process line 100”) can be combined in a single module in alternate implementations.

In implementations, one or more of the robots 1000-9000 in the process line 100 are configured to communicate over wired connections or wireless communication protocols. For example, in implementations, one or more robots in the process line 100 can communicate with another one or more robots in the process line 100 over a wired BUS, LAN, WLAN, 4G, 5G, LTE, Ethernet, BLUETOOTH, or other IEEE 801.11 standard. Referring to FIG. 3, an example of a system 200 of operatively connected autonomous robots is shown. FIG. 3 depicts a schematic implementation of a portion of an autonomous robotic process line 100 that processes the clean deformable laundry articles. Although each robot is referred to in singular form with regard to the schematic of FIG. 3, this is by way of example only, and, in implementations, each representative robot can represent a plurality of robots. Additionally, the subset of robots 6000-8000 are shown by way of example only, and a remote user 208 can communicate with and receive communications from any robots 2000-9000 in the process line 100. As shown in FIG. 3, folding robot 7000 is in operative communication with a repositioning robot 6000 configured to output a repositioned, or substantially spread (e.g., uncrumpled and laid flat), deformable laundry article to the folding robot 7000, and the folding robot is in communication with a packing robot 8000 configured to receive the folded article for packing for return to the customer (e.g., remote user 208). In implementations, each robot 6000, 7000, 8000 includes at least one controller 6005, 7005, 8005 configured to operate the associated robot. In implementations, a centralized controller (e.g, computing terminal 205) can communicate with and operate all the robots over a wired and/or wireless communication network.

In implementations, the folding robot 7000 includes a controller 7005. The controller 7005 includes a processor 7015 in communication with a memory 7010, a network interface 7020, and a sensor interface 7025. The processor 7015 can be a single microprocessor, multiple microprocessors, a many-core processor, a microcontroller, and/or any other general purpose computing system that can be configured by software and/or firmware. In implementations, the memory 7010 contains any of a variety of software applications, algorithms, data structures, files and/or databases as appropriate to address the requirements of repositioning a plurality of non-uniform (e.g., different article types, shapes, sizes, materials, etc.) deformable laundry articles. In one implementation, the controller 7005 includes dedicated hardware, such as single-board computers, one or more GPUs, application specific integrated circuits (ASICs), and field programmable gate arrays (FPGAs).

A network interface 7020 is configured to couple the controller 7005 to a network 230. The network 230 may include both private networks, such as local area networks, and public networks, such as the Internet. It should be noted that, in some examples, the network 230 may include one or more intermediate devices involved in the routing of packets from one endpoint to another. In implementations, the network interface 7020 is coupled to the network 230 via a networking device, such as a bridge, router, or hub. In other implementations, the network 230 may involve only two endpoints that each have a network connection directly with the other. In implementations, the network interface 7020 supports a variety of standards and protocols, examples of which include USB (via, for example, a dongle to a computer), TCP/IP, Ethernet, Wireless Ethernet, BLUETOOTH, ZigBee, M-Bus, CAN-bus, IP, IPV6, UDP, DTN, HTTP, FTP, SNMP, CDMA, NMEA and GSM. To ensure data transfer is secure, in some examples, the controller 7005 can transmit data via the network interface 7020 using a variety of security measures including, for example, TLS, SSL or VPN. In implementations, the network interface 7020 includes both a physical interface configured for wireless communication and a physical interface configured for wired communication. According to various embodiments, the network interface 7020 enables communication between the controller 7005 of the repositioning robot and at least one of the plurality of robots 2000, 3000, 4000, 5000, 6000, 8000, 9000 of the process line 100.

Additionally or alternatively, the network interface 7020 is configured to facilitate the communication of information between the processor 7020 and one or more other devices or entities over the network 230. For example, in implementations, the network interface 7020 is configured to communicate with a remote computing device such as a computing terminal 205, database 235, data lake 236, data warehouse 237, server 240, smartphone 245, and server farm 250. In implementations, the network interface 7020 can include communications circuitry for at least one of receiving data from and transmitting data to at least one of a database 235, data lake 236, data warehouse and a remote server 240 or server farm 250. In some implementations, the network interface 7020 can communicate with a remote entity over any of the wired protocols previously described, including a WI-FI communications link based on the IEEE 802.11 standard.

In some examples in accordance with FIG. 3, the network 230 may include one or more communication networks through which the various robots and computing devices illustrated in FIG. 3 may send, receive, and/or exchange data. In various implementations, the network 230 may include a cellular communication network and/or a computer network. In some examples, the network 230 includes and supports wireless network and/or wired connections. For instance, in these examples, the network 230 may support one or more networking standards such as GSM, CMDA, USB, BLUETOOTH®, CAN, ZigBee®, Wireless Ethernet, Ethernet, and TCP/IP, among others. In implementations, the network 230 can implement broadband cellular technology (e.g., 2.5 G, 2.75 G, 3 G, 4 G, 5 G cellular standards) and/or Long-Term Evolution (LTE) technology or GSM/EDGE and UMTS/HSPA technologies for high-speed wireless communication.

Although an embodiment of a controller 7005 of the folding robot 7000 is described herein in particular, one or more of the plurality of robots 2000, 3000, 4000, 5000, 6000, 8000, 9000 of the process line 100 includes similar components having similar functionality. In implementations, the at least one controller comprises any controller of the system 500 including a processor. The at least one controller comprises at least one of a controller of any robot 2000-8000 in the process line 100, 100a-b and a facility terminal 205 processing signals transmitted by sensors of one or more process lines 100, 100a-b. Additionally or alternatively, each robot controller 2005, 3005, 4005, 5005, 6005, 7005, 8005, 9005 is configured to communicate with one or more central processing controllers, such as a facility terminal 205 for processing data and receiving operational instructions.

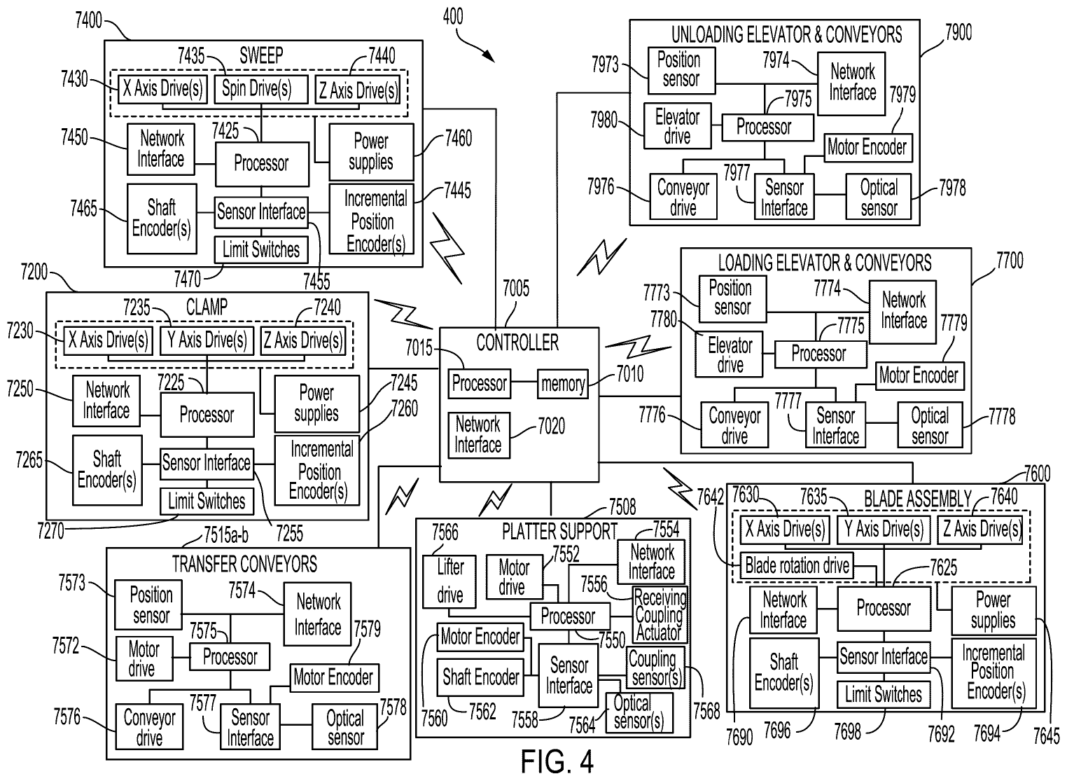

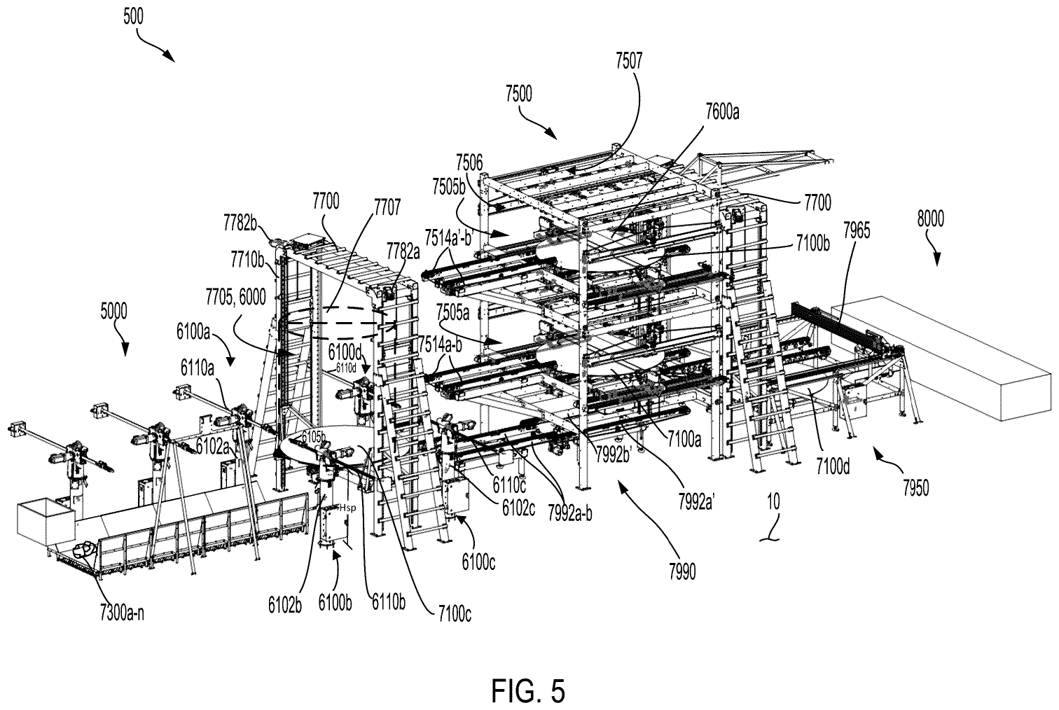

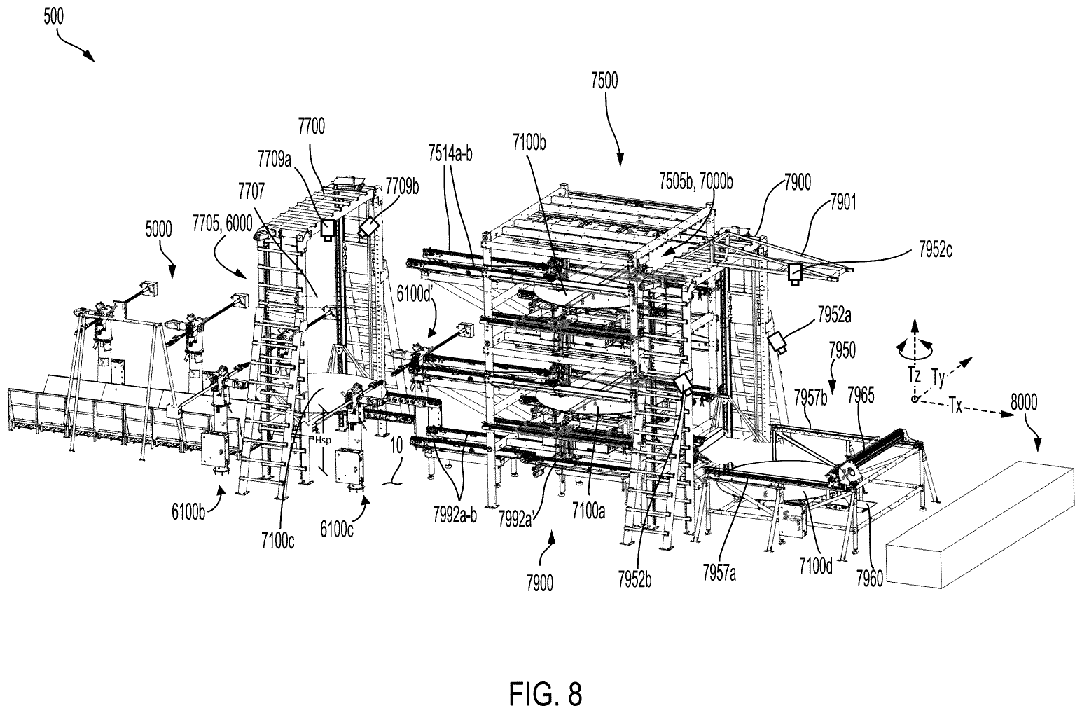

Turning to FIG. 4, a schematic implementation of a control system 400 of an autonomously operated tiered folding system 500 (FIGS. 5-8) is shown. FIG. 4 depicts an implementation of concurrently monitored and/or autonomously controlled components of each one of the plurality of folding bays 7505a-b in a tiered folding system 7500 and folding platter transfer elements in operable control with the one or more controllers 6005, 7005, 8005 of the controls system 400. Each of the folding bays 7505, 7505a-b is configured to function as a folding robot 7000. In implementations, each of the components in the controls system 400 comprises one or more elements having similar or identical functionality to the components described with regard to FIG. 3, such as processors, sensor interfaces, and networking interfaces for communicating with a controller 7005 and other components of the controls system 400 via at least one of a wired and wireless network 230. The controls system 400 includes one or more of the features described with regard to the embodiments of FIGS. 1-3, and includes drivers, processors, and other components in operable communication for autonomously handling and folding laundry articles via the folding system 500 depicted in implementations in FIGS. 5-8. Various control system 400 components will be described subsequently in detail with regard to various implementations of the folding system 500.

Turning to FIGS. 5-8, implementations of an autonomous tiered folding system 500 comprises a plurality of rotatable platters 7100a-n (where “n” represents a total number of platters greater than 1) configured to be conveyed into and out of a folding device 7500. As shown in FIGS. 5-9, the folding device 7500 comprises a plurality of tiered folding bays 7505a-n (where “n” represents a total number of bays equal to or greater than 2 and equal to or greater than the number of platters in the system 500) for folding a laundry article 7300 disposed on each of the plurality of platters 7100a-n. The autonomous tiered folding system 500 can comprise any of the implementations described in U.S. patent application Ser. No. 18/341,898, “AUTONOMOUS TIERED LAUNDRY FOLDING DEVICES, SYSTEMS, AND METHODS OF USE,” herein incorporated by reference in its entirety. (In implementations described herein with regard to a single folding bay 7505, it is intended that like elements exist within the other bays of the plurality of folding bays 7505a-n. Descriptions provided with regard to a single folding bay 7505 are intended as examples applicable to all folding bays 7505a-n.)

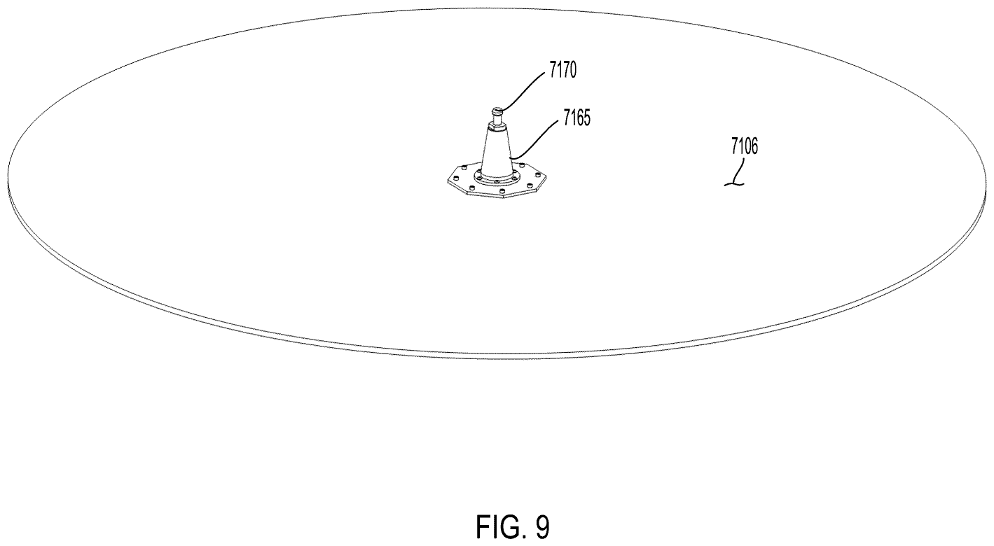

In implementations, the plurality of platters 7100a-n disposed within the system 500 is equal to at least a total number of tiered folding bays 7505a-n such that the autonomous assemblies (e.g., a folding robot 7000) disposed within folding bay 7505 can be simultaneously operating to fold laundry articles 7300a-n. Additionally, in implementations, two or more of the plurality of platters 7100a-n are configured to be disposed in at least two or more of the plurality of tiered folding bays 7505a-n and the loading elevator 7700. Each platter 7100 of the plurality of platters 7100a-n is interchangeable in each of the plurality of tiered folding bays 7505a-n. The plurality of platters 7100a-n comprise identical platter couplings 7165a-n (FIG. 9) for mating with any of a plurality of receiving couplings 7510a-n. In implementations, the plurality of platters 7100a-n are identical and interchangeable. In implementations, each one of the plurality of platters 7100a-n comprises a thickness of between about 5 mm and 45 mm. In implementations, each one of the plurality of platters 7100a-n comprises a thickness of between about 10 mm and 30 mm. In implementations, each one of the plurality of platters 7100a-n comprises a thickness of about 15 mm. In implementations, each one of the plurality of platters 7100a-n comprises a diameter of between about 75 cm to 304 cm. In implementations, each of the plurality of platters 7100a-n comprises a diameter of about 214 cm. Each one of the above-described plurality of elements is hereinafter referred to in examples in the singular interchangeably with and without particular designation (e.g., “the laundry article 7300,” “the folding bay 7505,” “the platter 7100,” “the platter coupling 7165”).

At least one controller 7005 of the autonomously operating system 500 is configured to identify an unoccupied folding bay 7505 of the plurality of folding bays 7505a-n and instruct a loading elevator 7700 to deliver one of the plurality of platters 7100a-n and an unfolded laundry article 7300 thereon to the identified one of the plurality of folding bays 7505a-n. Once a laundry article 7300 is autonomously folded, an unloading elevator 7900 of the autonomously operating system 500 is configured to deliver one of the plurality of platters 7100a-n and the folded laundry article 7300 thereon from one of the plurality of folding bays 7505a-n to an unloading station 7950 for packing and return to a customer (e.g., residential household). The system 500 autonomously transfers each emptied platter 7100 back to a spreading station 7705 for receiving a next spread laundry article 7300 in a load of clean laundry articles 7300a-n. Because the spreading process at the spreading station 7705 can take less time than a folding cycle, having more than one folding station 7505a-n available for concurrently folding a plurality of laundry articles prevents a production bottleneck in the process line 100. This ensures the system 500 efficiently delivers a load of cleaned and folded laundry to a packing robot 8000 for an expeditious return to a customer. Implementations of various autonomous robotic assemblies of the system 500 subsequently will be described in detail. As depicted in the implementation of FIGS. 5-8, the plurality of tiered folding bays 7505a-n comprises two bays, a lower folding bay 7505a and an upper folding bay 7505b and the number of platters 7100a-n in the system 5000 comprises at least four platters 7100a-d distributed throughout the various robotic stations (e.g., 7705, 6000, 7700, 7500, 7950, 7900) of the system 500.

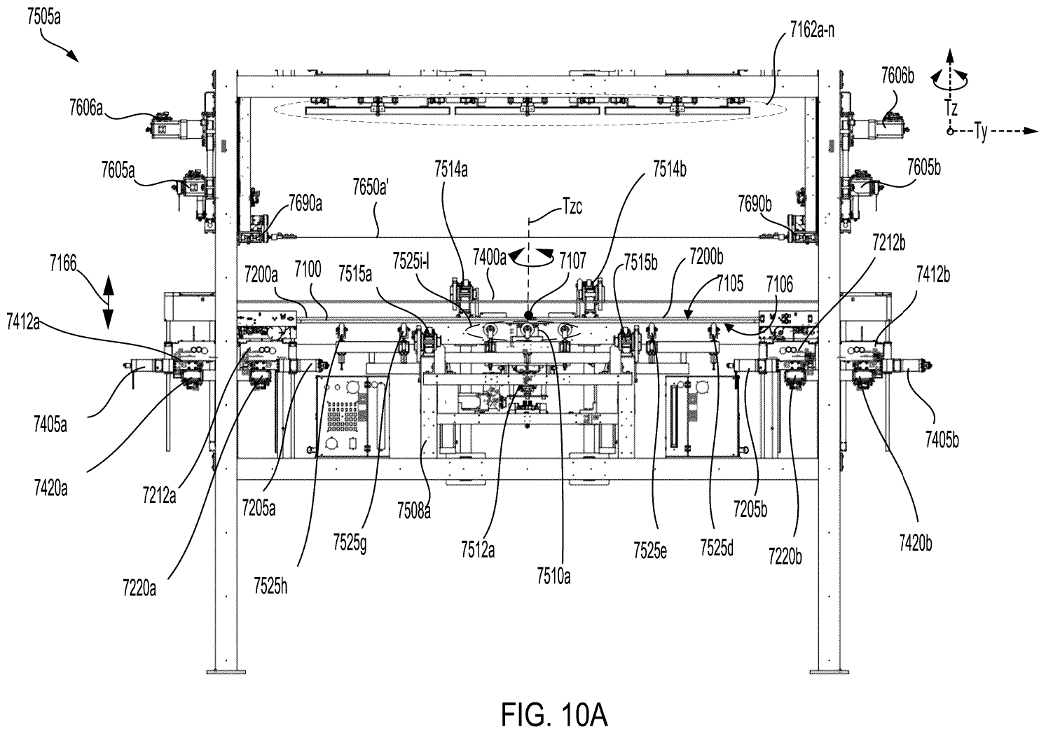

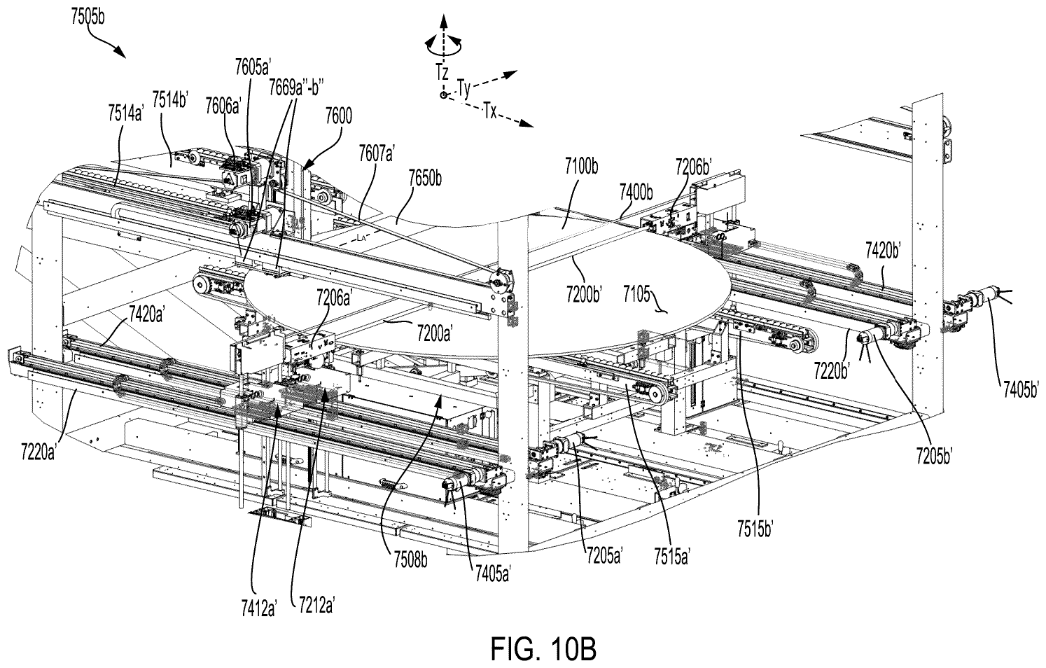

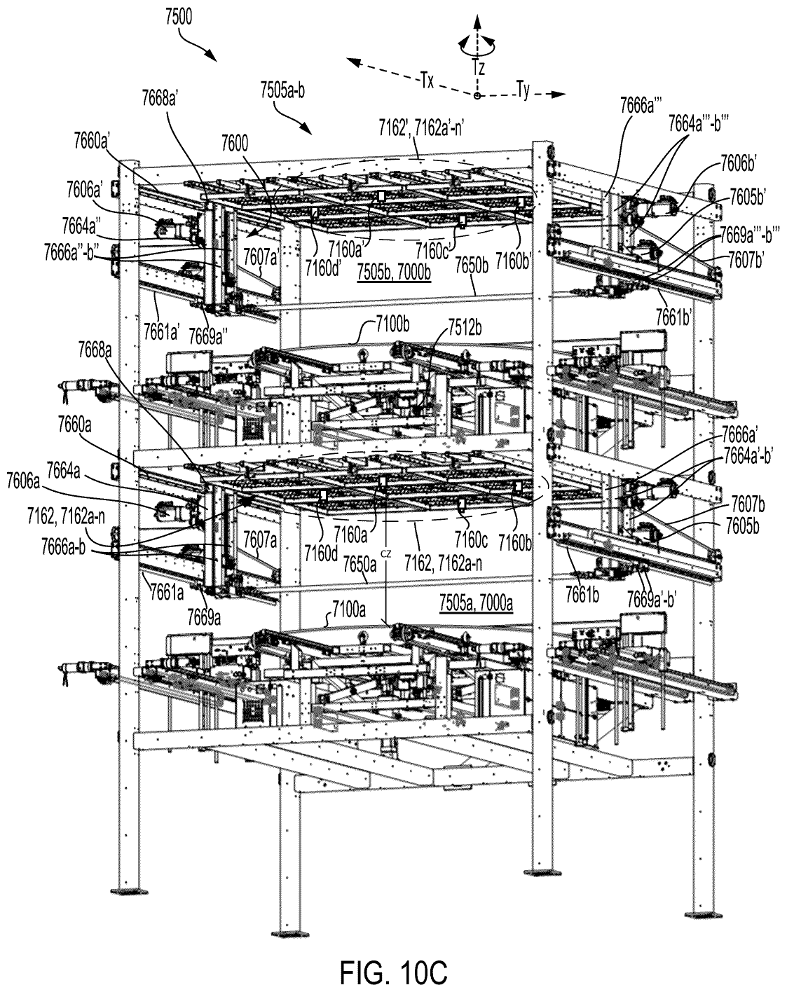

As shown in FIGS. 9-10A, each of the plurality of rotatable platters 7100, 7100a-n comprises a platter coupling 7165 (FIG. 9) configured to reversibly engage a receiving coupling 7510, 7510a-b (hereinafter referred to interchangeably as receiving coupling 7510) disposed with in a folding bay 7505, the receiving coupling 7510 being configured to rotate a received platter 7100 about a spin axis Tz (e.g., vertical axis Tz). The receiving coupling is one of a plurality of receiving couplings 7510a-b, each one of which is disposed within a single folding bay 7505 of the plurality of folding bays. (Each one of these plurality of elements is hereinafter referred to in examples in the singular interchangeably with and without particular designation.) In implementations, the spin axis Tz is vertically aligned through the center 7107 of the platter 7100. The platter coupling 7165 is configured to be disposed on an underside surface 7106 of the platter 7100. In implementations, as shown in FIG. 9, the platter coupling 7165 is a protrusion configured to extend from the underside surface 7106 of the platter 7100 and the receiving coupling 7510 is configured to receive the protruding platter coupling 7165 in a bore formed therein. In implementations, platter coupling 7165 can be affixed to an underside surface of the platter 7100 with one or more mechanical fasteners such as bolts, screws, rivets, clamps, and a press fit interlock. Alternatively, the platter coupling can be formed monolithically with the platter 7100.

A top surface 7105 of the platter 7100 is configured to receive thereon a laundry article 7300 of the plurality of laundry articles 7300a-n in a load of cleaned household laundry. The received laundry article 7300 is at least one of spread apart and partially folded by a preceding spreading station 7705. Returning to the system 500, of FIGS. 5-8, the spreading station 7705 functions as a repositioning robot 6000 when a rotatable platter 7100 is disposed therewithin, such as implementations of a repositioning robot described in U.S. Patent Publication No. US20210370517, “ROBOTIC LAUNDRY DEVICES AND METHODS OF USE,” herein incorporated by reference in its entirety.

Within the spreading station 7705, the laundry article is at least one of spread and at least partially folded by a plurality of lifters 6100a-n configured to lift and spread the laundry article above the spreading height Hsp (e.g., the vertical distance measured from the surface upon which the spreading station is mounted (e.g. a ground floor 10 or mezzanine floor) to a top surface 7105 of the platter 7100). In implementations, the plurality of lifters 6100a-n comprises at least three lifters. In implementations, the plurality of lifters 6100a-n comprises four lifters 6100a-d. Additionally, in implementations, no more than two the plurality of lifters 6100a-n are disposed along a straight line. In implementations, the plurality of lifters 6100a-n comprises four lifters 6100a-d disposed at each of four corners of a polygon (e.g., a rectangle, a square, a diamond, a trapezoid) defined by a straight lines connecting each lifter to the next as traced in a sequential order. Each of the plurality of lifters 6100a-n perform at least one of a grab, lift, pan, tilt, extend, and release of portions of the article to unfurl and spread apart the laundry article for folding as described in US20210370517. The plurality of liters 6100a-n are disposed about the top surface 7105 of the platter 7100 disposed within the loading elevator 7700 at the spreading height Hsp. The spreading height Hsp coincides with a bottom plane of a work volume 7707 (see FIGS. 5-8) within which a plurality of lifters 6100a-n receive the laundry article, spread the laundry article, and lay the spread laundry article on the top surface 7105 of the platter 7100 in a spread state. Each one of the plurality of lifters 6100a-n comprises an arm 6110 configured to at least one of pan, tilt, and extend from a stationary support 6102. The arm 6110 terminates in an actuatable gripper 6105. When the platter 7100 is received into the spreading station 7705, the platter 7100 defines a bottom surface of the work volume 7707 and is analogous to the conveyor at the bottom of the work volume of the repositioning robot 6000 of US20210370517. Additionally in implementations, as described in US20210370517, one or more sensors are disposed about the work volume 7707. The one or more sensors 7709a-n are configured to detect at least one of a presence, orientation, and spread status of a laundry article disposed within the work volume 7707. In implementations, the one or more sensors 7709a-n are disposed on at least one of one or more supports 6102a-n of the lifters 6100a-n and on the loading elevator 7700.

Following the spreading station 7705, the system 500 comprises the plurality of tiered folding bays 7505a-n. In implementations, the plurality of tiered folding bays 7505a-n comprise two or more folding bays 7505a-n stacked vertically atop one another in a tower formation. This reduces floor space occupied by the plurality of tiered folding bays 7505a-n to an area footprint of a single folding robot 7000. The process line 100 therefore comprises increased throughput of folded articles without increased cost associated with occupied square footage on a facility floor plan. Each bay of the plurality of tiered folding bays 7505a-n functions as a folding robot 7000a-n when a rotatable platter is disposed therewithin, such as a folding robot 7000 described in U.S. Pat. No. 11,486,084, “AUTONOMOUS LAUNDRY FOLDING DEVICES, SYSTEMS, AND METHODS OF USE”, herein incorporated by reference in its entirety.

As shown for example in FIGS. 5-8 and 10C, in implementations, the plurality of tiered folding bays 7505a-n comprises two folding bays, 7505a-b vertically stacked to define a folding device 7500 in the form of a tower. In implementations each bay 7505, 7505a-b (hereinafter referred to interchangeably with and without designation in the singular as “the folding bay 7505”) is configured to receive any one of the plurality of platters 7100a-n through a first open end 7506, 7506a-b (hereinafter referred to interchangeably with and without particular designation as the singular as “the open end 7506”). As depicted in FIG. 10A, in implementations, each folding bay 7505, 7505a-b of the plurality of tiered folding bays 7505a-n comprises a receiving coupling 7510 configured to receive and retain a platter coupling 7165 such that the top surface 7105 of the platter 7100 and a laundry article 7300 disposed thereon remain level during engagement, disengagement, and while rotating in an engaged state.

As shown in FIGS. 10A-B, each receiving coupling 7510 is configured to be disposed on and affixed to a support frame 7508, 7508a-b affixed within the bay 7505. Each folding bay 7505, 7505a-b comprises a lifting mechanism, for example one or more pneumatic pistons, configured to separate the platter coupling 7165 from the receiving coupling 7510 by simultaneously pushing upward to raise a pair of transfer conveyors 7515a-b, 7515a′-b′, supporting the platter 7100 within the folding bay 7505. FIGS. 10A and 10B show a respective end view from an unloading end of a lower folding bay 7505a and a partial cutaway perspective view from an unloading end of an upper folding bay 7505b with the platter 7100 lowered by the support frame 7508 such that the platter coupling 7165 mates with the receiving coupling 7510.

Following folding completion, the support frame 7508 is configured to raise the pair of transfer conveyors 7515a-b and the platter 7100a thereon thereby lifting the platter coupling 7165a from the receiving coupling 7510a. The pair of transfer conveyors 7515a-b is configured to discharge the platter 7100a and a folded laundry article (not shown for clarity) disposed thereon through a second open end 7507a opposite the first open end 7506a at the completion of a folding cycle. Folding cycle completion can be determined autonomously by one or more controllers and/or processors as described in U.S. Pat. No. 11,486,084, herein incorporated by reference.

Additionally or alternatively, folding completion can be determined by a user reviewing an image of the folded article 7300 on a GUI 300 and transmitting through the user interface 300 an acceptance of the fold as completed or at least acceptable. The acceptance can comprise a signal transmitted to the at least one controller responsive to an acceptance entry on one or more user display devices 245, 246, 247 comprising at least one of a tap, a click, a text input, and a voice command. In implementations, the user can be, for example, at least one of a process line facilities operator 209 and a customer user 208 who at least one of owns and manages the folded laundry article 7300. As will be described subsequently with regard to implementations, a user can receive an image of the folded article 7300 on a remote device display screen 300 (e.g., smartphone, tablet, a smart watch, a PC, etc.) and instruct a controller of the system 500 to deliver the folded laundry article 7300 to a packing robot 8000 or to deliver the folded laundry article back to the spreading station 7705 (e.g., a repositioning robot 6000) for spreading apart before attempting another folding cycle. In all implementations, one or more controllers 7005, 8005, 205 of the controls system 400 can learn to automatically detect acceptable folds for various types of articles (e.g., shirts, pants, dresses, etc.) over time using, for example, machine learning model. For example, each time a laundry article is subsequently washed and handled, the controls system 400 can detect the article as previously having been folded by the system 500 and automatically determine an acceptable fold without requiring user intervention. Such machine learning models can employ, for example, at least one of a decision tree, random forest, k-nearest neighborhood, Bayesian network, support vector machine, and neural network.

Each of the plurality of platters 7100a-n is delivered to one of the plurality of folding bays 7505a-n by a loading elevator 7700. As shown for example in FIGS. 5-7, in implementations the loading elevator 7700 is disposed adjacent the first open end 7506, 7506a-b of each folding bay 7505, 7505a-b of the folding device 7500 (e.g., tower of stacked folding bays 7505a-b). In implementations, the loading elevator 7700 is configured to raise a platter 7100 to an unoccupied one of the plurality of tiered folding bays 7505a-n from a spreading height Hsp (FIGS. 5-6 and 8) at which the laundry article 7300 is received onto the platter 7100 in at least one of a spread state and a partially folded state. Additionally or alternatively, in implementations, the loading elevator 7700 is configured to lower a platter 7100 disposed thereon into an unoccupied folding bay 7505 of the plurality of tiered folding bays 7505a-n. Additionally or alternatively, in implementations, the loading elevator 7700 need not raise or lower the platter 7100 to transfer the platter 7100 disposed into an unoccupied folding bay 7505 disposed adjacent to a spreading station 7705 at the spreading height Hsp.

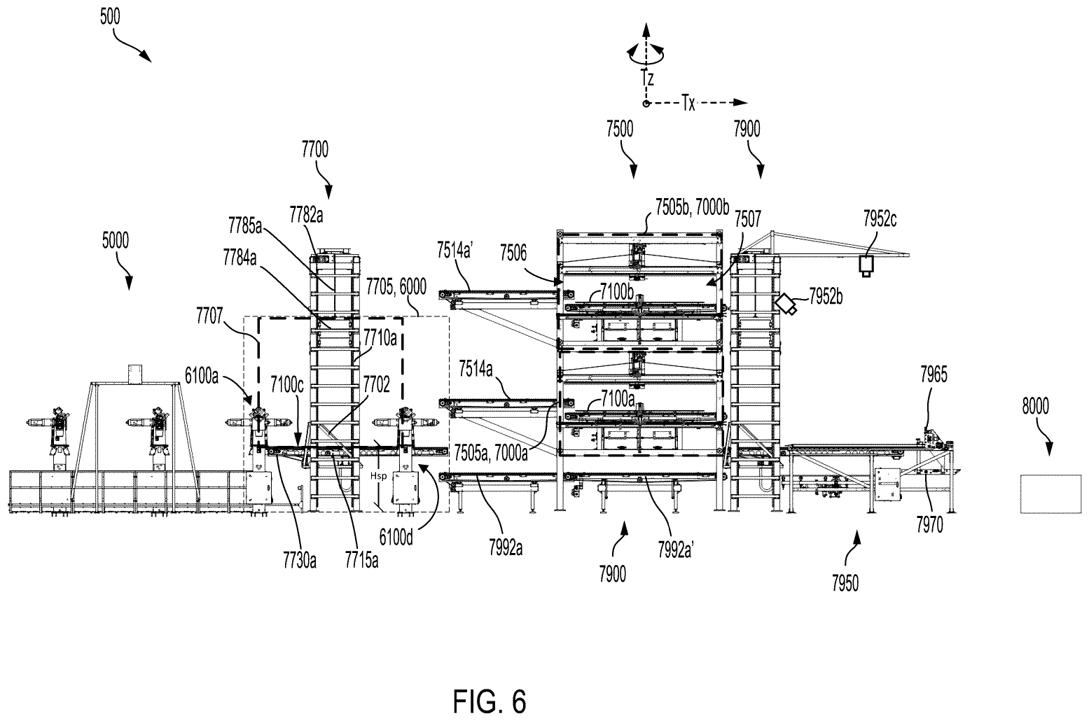

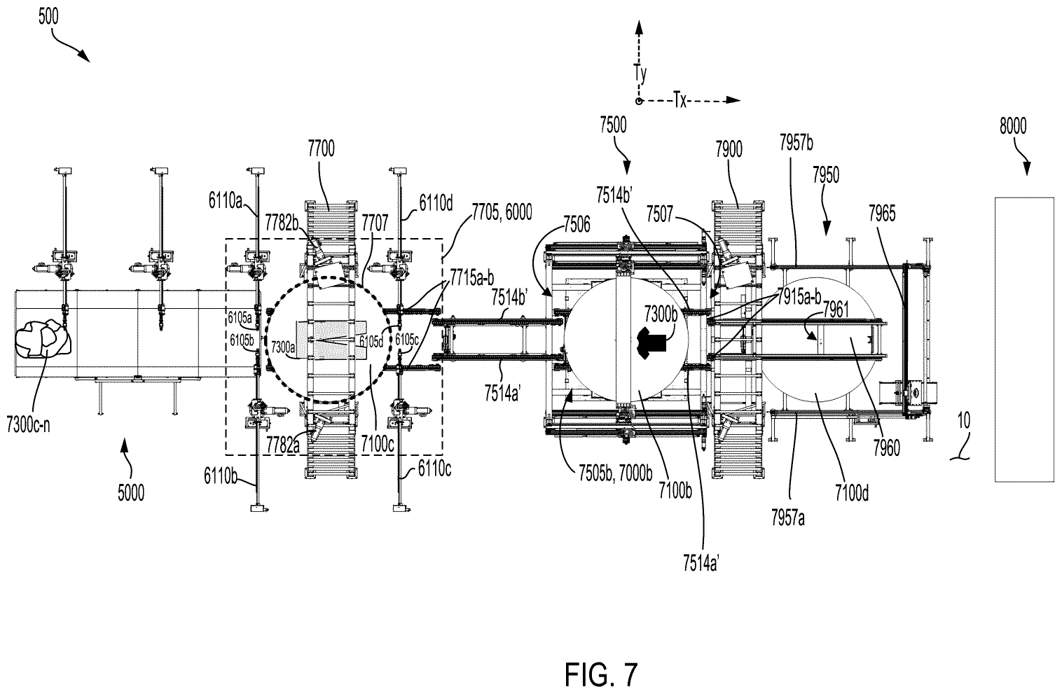

In implementations, as shown for example in FIGS. 6-7, the system 500 comprises a pair of loading conveyors 7715a-b disposed within the loading elevator 7700 configured to support a platter 7100 disposed thereon. The pair of loading conveyors 7715a-b is configured to contact a bottom surface 7106 of a platter 7100. A vertical drive 7780 of the loading elevator 7700 is configured to instruct one or more drive motors 7782, 7782a-b (FIG. 5-7) to raise and lower the pair of loading conveyors 7715a-b with a platter 7100 and laundry article 7300 disposed thereon to an unoccupied one of the plurality of tiered folding bays 7505a-n. Additionally, the vertical drive 7780 of the loading elevator 7700 is configured is configured to instruct the one or more drive motors 7782 to raise and lower the pair of loading conveyors 7715a-b to align with and receive an empty platter 7100 of the plurality of rotatable platters 7100a-n from a return conveyor 7990 disposed at least one of beneath and laterally adjacent the plurality of folding bays 7505a-n. The one or more drive motors 7782, 7782a-b are configured to raise the empty platter 7100 from the return conveyor 7990 to the spreading height Hsp. The return conveyor 7990 is configured to at least one of receive and store an empty platter 7100 from an unloading elevator 7900 and return the empty platter 7100 to the loading elevator 7700 for raising to the spreading height Hsp. In implementations, as shown in FIGS. 5-6 and 8, the return conveyor 7990 comprises one or more pairs driven conveyors 7992a-b, 7992a′-b′ disposed on a floor 10 beneath the folding device 7500 (e.g., folding tower), the return conveyor 7990 extending between an unloading elevator 7900 and the loading elevator 7700. The return conveyor 7990 is configured to at least one of receive and store an empty platter 7100 from an unloading elevator 7900 and return the empty platter 7100 to the loading elevator 7700 for raising to the spreading height Hsp. In implementations, the return conveyor 7990 is configured to store one or more empty platters of the plurality of rotatable platters 7100a-n. In implementations, the return conveyor 7990 is configured to store a queue of two or more empty platters of the plurality of platters 7100a-n.

Once conveyed from the return conveyor 7990 into the loading elevator 7700 and raised to the spreading height Hsp, a platter 7100 is positioned to receive a next spread laundry article 7300. The loading elevator 7700 is configured to operate concurrently with at least one of folding operations within one or more of the plurality of folding bays 7505a-n and discharge operations comprising the unloading elevator 7900 unloading a platter 7100 and folded laundry article 7300 thereon from one of the plurality of tiered folding bays 7505a-n. The folding system 500 is thus configured to enable multiple concurrent processes to increase process line throughput of folded laundry articles. As shown in FIGS. 5-8, each of the folding bays 7505a-b can have disposed therein a platter 7100a-b and article (e.g., 7300b in upper folding bay 7505b) thereon for folding while simultaneously, the spreading station 7705, 6000 receives an empty platter 7100c therein for the start of a spreading operation on another laundry article 7300a. Also simultaneously, the unloading elevator 7900 can be delivering a folded laundry article on another platter 7100d to an unloading station for automated retrieval to a packing robot 8000.

As shown in FIGS. 5-8, in implementations, the unloading elevator 7900 is disposed adjacent the second open end 7507 of the plurality of tiered folding bays 7505a-n (e.g., the tower of stacked folding bays 7505a-b, or folding device 7500) and is configured to retrieve and lower a platter 7100 having a folded laundry article disposed thereon to an unloading station 7950. The unloading elevator 7900 is configured to raise and lower a platter 7100 thereon in a level orientation such that a folded laundry article 7300 thereon does not topple and/or unfold during discharge to the unloading station 7950 for transfer to a packing robot 8000.

Once the platter coupling is securely seated within and retained by the receiving coupling, the controller 7005 receives a signal to begin a folding sequence as described, for example, with regard to the folding robot 7000 of U.S. Pat. No. 11,486,084. Each folding bay 7505 of the plurality of tiered folding bays 7505a-n comprises at least two of one or more sliding sweep rods 7400 (e.g., for smoothing and folding the article), one or more sliding clamping rods 7200, and a tiltable folding blade 7650 collectively configured to clamp, smooth, and fold the laundry article disposed on the top surface 7105 of the platter 7100. The platter 7100 engaged with the receiving coupling 7510 within a bay 7505 effectively establishes a folding robot 7000.

Each folding robot 7000 within each bay 7505 comprises a rotatable platter 7100 secured to the rotatable receiving coupling 7510 and at least two of the following, as depicted in FIGS. 4 and 10A-C: at least one movable sweep rod 7400, at least one clamp rod 7200, 7200a-b, and at least one blade assembly 7600 in wired or wireless communication with the at least one controller 7005. In implementations, the platter 7100 transferred into the bay 7505 on transfer conveyors 7515a-b is configured to deliver a repositioned deformable laundry article 7300 for folding. The repositioned deformable laundry article 7300 can be at least one of spread out, oriented, and partially folded by a preceding autonomous robot, for example a repositioning robot 6000 configured to manipulate the repositioned article 7300 and lay it in a spread state (e.g., flattened state) on the top surface 7105 of the platter 7100.

In addition to comprising at least one of at least one movable sweep rod 7400, at least one clamp rod 7200, and at least one blade assembly 7600, in implementations, as shown in FIG. 10C, the system 500 further comprises one or more sensors 7160, 7160a-n, a′-n′ (referred to collectively as one or more sensors 7160) in operable communication with the controller 7005. The one or more sensors 7160 are configured to detect at least one of a presence, position, size, flatness, article type, one or more article features, and depth of the laundry article 7300 disposed on the top surface 7105 of the platter 7100 within a bay 7505. Each bay 7505 comprises one or more sensors 7160, 7160a-n, a′-n′ and one or more light sources 7162a-n, a′-n′ configured to illuminate the laundry article disposed on the top surface of the platter 7100. In implementations the one or more light sources 7162a-n, a′-n′ are in operable communication with the controller 7005. Additionally, in implementations, the one or more light sources 7162a-n are adjustable for changing hue and luminosity. The controller 7005 is configured to control one or more adjustable outputs of the one or more light sources 7162a-n, a′-n′ to eliminate, diminish, and/or augment reflection, shadows, and visibility of each laundry article 7300 in accordance with fabric type and characteristics.

As shown in FIG. 10C, in implementations, the one or more light sources 7162, 7162a-n, a′-n′ comprise a plurality of diffuse light panels each having a corresponding one of a plurality of lights disposed at least one of on, within, and above the light panel. In implementations the plurality of diffuse light panels comprise LED edge lit acrylic panels. In implementations, each one of the plurality of light panels of the plurality of light sources 7162a-n, a′-n′ is configured to slide into rails suspended at the top of each individual folding bay 7505 of the plurality of tiered folding bays 7505a-n and lock into place in an array 7163 for ease of installation and maintenance while providing full coverage lighting within the folding bay 7505 for accurate sensor perception of a deformable laundry article 7300 during folding operations. Additionally or alternatively, in implementations, at least one of the plurality of light panels of the plurality of light sources 7162a-n, a′-n′ comprises disposed therethrough, therein, or thereon one of the one or more sensors 7160a-n, a′-n′.

In implementations, the at least one sensor 7160, 7160a-c, 7709, 7709a-n, 7952, 7952a-n comprises at least one of a 3-D camera, a 2-D camera, LIDAR (Light Detection And Ranging, which can entail optical remote sensing that measures properties of scattered light to find range and/or other information of a distant target), LADAR (Laser Detection and Ranging), a sonar proximity sensor, an ultrasonic ranging sensor, a radar sensor (e.g., including Doppler radar and/or millimeter-wave radar), a video camera from which still images can be extracted, and a pair of stereo depth cameras. In implementations, each one of the one or more sensors 7160a-n, 7709a-n, and 7952a-n is a camera calibrated at a fixed position and orientation relative to the platter 7100. Additionally or alternatively, in implementations, the one or more sensors 7160a-n, 7709a-n, and 7952a-n output to at least one controller 6005, 7005 at least one of a depth map, RGB images, and IR images. In implementations at least one of the one or more sensors 7160a-n comprises a REALSENSE camera configured to output any of a depth map, RGB images, and IR images. In implementations, the one or more sensors 7160a-n, 7709a-n, and 7952a-n can be configured to output 3-D image data to at least one controller 6005, 7005, 205. Additionally or alternatively, in implementations, at least one of the at least one sensor 7160, 7160a-c, 7709, 7709a-n, 7952, 7952a-n can be configured to output one or more 2-D images (e.g., 2D RGB images) to at least one controller 6005, 7005, 205. In implementations, the one or more sensors 7160a-n, 7709a-n, and 7952a-n comprise one or more features or attributes of the preceding implementations.

In one implementation, the one or more sensors 7160a-n, 7709a-n, and 7952a-n comprise imaging sensors including at least one of an infrared range sensor and a volumetric point cloud sensor configured to generate range value data representative of the deformable laundry article 7300 disposed on the platter 7100. The one or more sensors 7160a-n can be configured to generate presence value data representative of the deformable laundry article 7300. In implementations, the presence value data can indicate a position and orientation of the deformable laundry article on the platter 7100 disposed within a folding bay 7505.

The one or more sensors 7160a-n, 7709a-n, and 7952a-n are configured to at least one of detect one of one or more features and capture one or more images of one or more deformable articles 7300 disposed on at least one of a rotatable platter 7100 disposed within one of the plurality of tiered folding bays 7505a-n, a rotatable platter 7100 disposed at the spreading station 7705, and a rotatable platter disposed at the unloading station 7950. As described previously with regard to FIGS. 3-4 the folding robot 7000 further comprises a controller 7005 in operative communication with a motor drive 7552 of a table drive motor, at least one of a plurality of clamp rod, sweep rod, and folding blade Z-axis drive motors (e.g., respective motors 7205a-b, 7405a-b, 7605a-b), at least one clamp rod Y-axis drive motor 7206a-b, the at least one clamp rod, sweep rod, and folding blade X-axis drive motors (e.g. respective motors 7206, 7406, 7606), at least one sweep rod spin drive motor 7512, a blade rotational drive motor 7690, and the one or more sensors 7160a-n disposed within each individual the folding bay 7505 of the plurality of folding bays 7505a-n. The controller 7005 of the folding robot 7000 (e.g., each bay 7505a-n of the tiered folding tower 7500) is configured to instruct the various drive motors based on processing received sensor output with a machine learning model and data stored in a memory 7010, 210, 235, 240, 250 in communication with the controller 7005, 205.

In implementations, at least one controller (e.g., at least one of the folding controller 7005, the repositioning controller 6005 of the spreading station, and a controller 210 of a remote terminal 205) is further configured to determine, based on a comparison of a received output signal of the one or more sensors 7160a-n, 7709a-n, 7952a-n to data stored in a memory 7010, 235, 236, 237, 250 in communication with the controller 7005, at least one of an article type, an article shape (e.g., flatness, folded, twisted, etc.), an article feature (e.g., collar, waist, sleeve, etc.), an article size, a front side, a back side, and an inside surface of the deformable article 7300. Additionally, as previously described, in implementations the controller 7005 is further configured to determine, based on a comparison of a received output signal of the one or more sensors 7160a-n to data stored in a memory 7010 in communication with the controller 7005 that folding of an article is in a state of acceptable completion or unacceptable completion requiring reprocessing by one or more of the folding robot 7000 and spreading robot 6000, 7705 (e.g., a spreading device autonomously operating without human intervention). In implementations, at least one of the one or more sensors 7160a-n, 7709a-n, 7952a-n comprises a 2-D camera. In implementations, the data associated with repositioned deformable laundry article comprises size invariant image data.

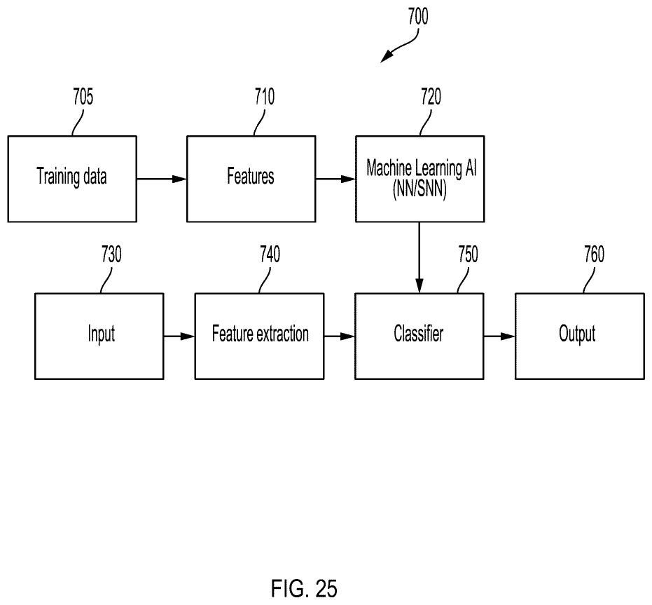

Additionally or alternatively, in implementations, a memory 210, 6010, 7010 of a controller 205, 6005, 7005 or a remote memory 235, 236, 237, 240, 250 in communication with a controller 205, 6005, 7005 comprises a neural network 700 (FIG. 25), and determining the one or more characteristics of each one of the plurality of deformable articles comprises processing the received output signal of at least one sensor of the one or more sensors 7160a-n, 7709a-n, 7952a-n with a neural network model. In implementations, the neural network model fulfills tasks comprising at least one of a classifying, detecting, and segmenting. In implementations, the neural network model is at least one of a supervised learning model (e.g., comprising at least one of a regression algorithm, a linear classifier, a support vector machine (SVM), a decision trees, and a random forest algorithm) configured to predict an outcome based on labeled data, and an unsupervised model (e.g., comprising at least one of K-Means clustering, principal component analysis (PCA), and autoencoding) configured to determine patterns and associations in unlabeled data. In implementations, supervised and unsupervised models are configured to implement deep learning techniques. In implementations, the neural network model can be a reinforcement learning model, which also can use deep learning techniques.

In implementations, as shown in FIG. 25, the neural network comprises a trained neural network model, for example a convolutional neural network that operates quickly on 3D and/or 2D data and is configured to classify images from one or more 3D and/or 2D cameras. In an implementation, the classification (e.g. by classifier 750) comprises generating a descriptor based on the output signal (e.g., input 730) of the one or more sensors 7160a-n, 7709a-n, 7952a-n and classifying, using the neural network, the output signal based on the descriptor. The neural network 700 is configured to output a probability that the output signal corresponds to a class of the stored data. For example, as shown in the implementation of FIG. 25, a neural network 700 can be trained with a set of training data 705, and after training, the neural network comprises a set of weights that can be used for neural network inference to determine whether an input 730 (e.g., output signal from one of the one or more sensors 7160a-n, 7709a-n, 7952a-n) is within one of the trained classes. In implementations, the classes of trained data in the neural network comprise data associated with many types of labels (e.g., classes). The plurality of classes, or labels, comprises at least two of type of article, a feature on an article (e.g., a pom pom, a tassel, a zipper, etc.), a location on the article (e.g., a waistband, a cuff, a pants crotch, etc.), the location of the article on the platter 7100, and one or more customer specific labels. A class can be indicative, for example, of one or more deformable article types that require particular folding maneuvers, for example. In implementations, the neural network model is configured to output a plurality of outputs 760 comprising at least one of key points, garment features, and a mask of the garment on the platter 7100. In implementations, the classes of trained data in the neural network comprise data associated with at least one of many types of deformable laundry articles, features, key points, etc. that influence cumulatively improved folding maneuvers to reach a final folded state within dimensions of one or more pre-set footprint areas, as level as possible (for stable stacking and packing) and without unfolding.

Additionally or alternatively, in implementations, a memory store 6010, 7010, 210 in communication with the controller 6005, 7005 comprises a trained regressor. The controller 7005 is configured to receive an input signal of the one or more sensors 7160a-n, 7709a-n, 7952a-n and, based on an output of the trained regressor, identify a feature of one or more article types to rotate in alignment with or perpendicular to one or more clamp rods 7200, 7200a-b during folding. For example, the trained regressor can identify a sagittal line of a shirt and the controller 7005 can instruct the drive motor 7110 of the receiving coupling to rotate the platter and shirt thereon such that the sagittal line rotates in one direction or the other (depending on the direction requiring moving through the fewest number of radians from a perpendicular orientation to the one or more clamp rods 7160a-n).

In implementations the one or more sensors 7160a-n comprises a depth camera that generates point clouds (e.g., a REALSENSE camera) or a stereoscopic arrangement of two or more 2D or 3D cameras positioned above the platter 7100 and aimed at the top surface 7105. In implementations, the one or more sensors 7160a-n comprise at least two depth cameras angled at the platter to capture the entire platter 7100. The at least one controller 7005, 205 is configured to combine the received point clouds from the at least two depth cameras and transform the combined received point clouds into a flattened, top down image of an article 7300 disposed on the platter 7100. The at least one controller 7005, 205 is configured to generate a non-warped view of the entire platter 7100 and an article disposed thereon. Additionally or alternatively, in implementations, the one or more sensors 7160a-n comprises a single depth camera mounted at a fixed location relative to the platter. In implementations, at least one controller 7005, 205 is configured to rotate the platter 7100 on which the single depth camera is aimed for continuously collecting data (e.g., a plurality of images or video). The single depth camera is configured to capture the platter 7100 and an article thereon in its entirety during a full 360 degree rotation. The at least one controller 7005, 205 is configured to construct a complete rendering of the article 7300. In implementations, the complete rendering can be flattened. In implementations, the complete rendering or flattened rendering can be provided to the neural network model for prediction. In implementations, the surface of the platter 7100 is non-speculative. In implementations, the top surface 7105 is a single color, such as white or gray, for providing readily detected contrast to most deformable articles 7300. In implementations, the top surface 7105 comprises two or more regions of at least one of different color and pattern for distinguishing the article 7300 from the top surface 7105.

Returning to FIG. 10C, the one or more sensors 7160a-n comprises a plurality of cameras 7160a-d positioned at a height of CZ above the rotatable platter. In implementations, the height CZ is in a range of between about 1 to 5 meters (e.g., 1 m, 1.5 m, 2 m, 2.5 m, 3 m, 3.5 m, 4 m, 4.5 m, 5 m). In implementations, the one or more sensors 7160a-n can be positioned directly above the center 7107 of the platter 7100. In implementations, the one or more sensors 7160a-n comprise four cameras 7160a-d evenly distributed about a central panel of the plurality of light panels 7162a-n. Additionally or alternatively, the one or more sensors 7160a-n may be offset from the center 7107 of the platter 7100 and/or angled from the vertical axis Tz (e.g., Z-axis). In all implementations, the one or more sensors 7160a-n are positioned at a fixed height and orientation relative to a platter 7100 having a platter coupling 7165 fully engaged with the receiving coupling 7510 within the folding bay 7505.

In implementations, at least one controller 6005, 7005, 205 is configured to receive one or more output signals from the one or more sensors 7160a-n, 7709a-n, 7952a-n and determine, based on the received one or more output signals, at least one of an article type, article shape, article feature(s), size, thickness, and location of the deformable article 7300 on the platter 7100. The at least one controller 6005, 7005, 205 is configured to determine based on the at least one of the determined article type, determined article size, determined article shape, determined article feature(s), determined article thickness, and the location, a first fold line of the deformable article, instruct a drive motor 7512, 7512a-b (FIGS. 10A and 10C) to rotate the platter 7100 to align the fold line of the deformable article with the at least one clamp rod suspended above the platter, and instruct the at least one clamp rod 7200, 7200a-b to lower onto the first fold line, the lowered at least one clamp rod 7200, 7200a-b configured to apply force and immobilize the fold line of the deformable laundry article 7300 against the surface 7105. The controller 7005 is further configured to instruct at least one of a blade 7650 and at least one movable sweep rod 7400 to slidably move in a first direction between the deformable article 7300 and the surface 7105 to a position adjacent and parallel to the at least one retractable clamp rod 7200, 7200a-b, and raise the deformable article up and over the at least one retractable clamp rod 7200, 7200a-b, slidably moving in the first direction at least until the article 7300 disengages from the blade 7650 or at least one movable sweep rod 7400. In examples, aligning the fold line (e.g., the location on the article 7300 where the clamp rod 7200, 7200a-b presses) of the deformable article 7300 with the at least one clamp rod 7200, 7200a-b comprises rotating the fold line to a substantially parallel position with the at least one clamp rod 7200, 7200a-b. In implementations, the blade 7650 is configured to fold portions of the deformable article 7300 onto itself without at least one clamp rod 7200, 7200a-b contacting the article 7300.

As described previously with regard to implementations, the system 500 comprises at least one of a local controller 7005 and remote controller 205 in operable communication with the one or more sensors 7160a-n of each of one of the plurality of tiered folding bays 7505a-n. As shown in the control system 400 schematic of FIG. 4, the controller 7005 is in operable communication with at least one or more sensors disposed about a work volume 7707 of the spreading station 7705 (e.g., repositioning robot 6000), one or more unloading station sensors 7952a-n disposed about an unloading station 7950, one or more sensors disposed about the return conveyor 7990, one or more elevator drive motors 7782a-b, 7982a-b, the drive motor 7512 of each of the plurality of tiered folding bays 7505a-n, and drives configured to move of each of the at least two of one or more sliding sweep rods 7400, a sliding clamp rod 7200, and a tiltable folding blade 7650 in at least two of the orthogonal Tx, Ty, and Tz coordinate directions.

As described previously, each folding bay 7505 of the plurality of tiered folding bays 7505a-n comprises at least two of one or more sliding sweep rods 7400, one or more sliding clamp rods 7200, and a tiltable folding blade 7650 collectively configured to clamp, smooth, and fold the laundry article disposed on the top surface 7105 of the platter 7100. In implementations, the device 7000 includes at least one clamp 7200, 7200a, 7200b configured to clamp a deformable article 7300 to the top surface 7105 of a platter 7100 in a lowered position. The at least one clamp rod 7200, 7200a-b is configured to raise and lower from the surface 7105 of the rotatable platter 7100 and slidably move parallel to the surface 7105. In implementations, the at least one clamp rod 7200, 7200a, 7200b is configured to be moved synchronously or asynchronously and in orthogonal coordinate in Tx, Ty, and Tz directions by drive motors in operable communication with corresponding clamp drives, e.g., X axis drive 7230, 7230a-b, Y axis drive 7235, 7235a-b, and Z axis drive 7240, 7240a-b (FIG. 4). In implementations, the at least one clamp 7200, 7200a-b can be an elongated rod. In other implementations, the at least one clamp 7200, 7200a-b can be an elongated flat, spatula-like bar. In implementations, the at least one clamp 7200 can comprise two retractable clamps 7200a, 7200b as shown in FIGS. 10A-C, configured to be simultaneously controlled for synchronized, coordinated movement.

As shown in FIGS. 10A and 10C, drive motor 7512, 7512a-b is configured to rotate the platter 7100 about a central axis Tzc (FIG. 10A). The drive motor 7512 is driven by a motor drive 7552 (FIG. 4) in operable communication with the controller 7005. The drive motor 7512 can include an encoder 7560 for determining rotational position of the platter 7100. The controller 7005 is configured to receive signals from the encoder 7560 and a positional feedback sensor (e.g., an optical sensor 7564 such as a break beam or a camera configured to detect one or more detectable fiducials, a hall sensor, etc.) for determining the rotational position such that an article on the platter 7100 can be rotated to a particular angle for at least one of clamping and folding. In implementations, the one or more encoders 7560 and sensors 7564 are in communication with a sensor interface 7558 configured to communicate with the controller 7005 via a network interface 7554. Additionally or alternatively, the platter support frame 7508 comprises a processor 7550 in operable communication with the motor drive 7552, the motor encoder 7560, a shaft encoder 7562, one or more sensors 7564a-n, 7568, the sensor interface 7558, a receiving coupling actuator 7556, a lifter drive 7566, and the network interface 7554 configured to communicate with the controller 7005 via wired or wireless communications.

The rotatable platter 7100 can be oriented like a compass with “North” N, indicating a beginning for rotation, regardless of the position of the platter 7100 as determined by encoder tics. The encoder tic position can inform a direction of travel (e.g., rotation) to arrive at a desired rotational position. In one implementation, a full rotation comprises 4096 tics. The number of tics in a full rotation can be specific to a particular encoder. In implementations, the rotatable platter 7100 is round and a complete rotation of the rotatable platter 7100 includes rotating a north most point by 360 degrees, or, 4096 tics. A deformable article 7300 can be disposed on the rotatable platter 7100 such that a clothing vector is at an initial angle to a radius through the northern most point. Rotating the platter 7100 counterclockwise until to a desired rotational position that can be selected to align the clothing vector and/or a fold line with a clamp rod 7200. The drive motor 7512 can rotate the rotatable platter 7100 such that the at least one clamp rod 7200, 7200a-b aligns with a first clamp position on the deformable article 7300. The first clamp position can be, for example, a fold line on the deformable article 7300, along which at least a portion of the article 7300 is folded.

As shown in FIGS. 10A-C, in implementations, at least one movable sweep rod 7400 is disposed parallel to the at least one clamp rod 7200, 7200a-b. In implementations, the at least one movable sweep rod 7400 is configured to be moved in at least Tx and Tz directions by drive motors (e.g., X axis drive motors 7405a-b and Z axis drive motors (not shown)) in operable communication with corresponding sweep drives, e.g., X axis drive 7430, 7430a-b and Z axis drive 7440, 7440a-b. Optionally, in some embodiments, the at least one movable sweep rod 7400 is configured to be moved in the Ty direction by at least one drive motor in operable communication with at least one Y axis drive. Additionally, in implementations, the at least one movable sweep rod 7400 is configured to be rotated about its longitudinal axis by a rotation motor in operable communication with a spin drive 7435, 7435a-b. The at least one Z-axis motor 7407 is configured to raise and lower the at least one movable sweep rod 7400 from the surface 7105 of the rotatable platter 7100. The at least one movable sweep rod 7400 is configured to slidably move parallel to the surface in alignment along and an X-Axis aligned with the “Tx” direction.

In implementations, under the operable control of the at least one controller 7005, the at least one movable sweep rod 7400 is configured to slide under an unclamped portion of the deformable article 7300, and lift the unclamped portion above the at least one clamp rod 7200. The at least one movable sweep rod 7400 is configured to pass, or carry, the unclamped portion over the at least one retractable clamp rod 7200, and dispose the lifted unclamped portion to a resting position atop another portion of the deformable article 7300 while continuing to move in the X-axis direction Tx to disengage from the article. In implementations, the at least one movable sweep rod 7400 can move in an arc while passing the unclamped portion deformable article 7300 over the at least one clamp rod 7200 at a peak height above the surface 7105 of the platter 7100 that clears the clamp rod and enables the article to wrap around the clamp rod. The controller 7005 is configured to instruct a drive 7430 of the X-axis drive motor 7405 and a drive 7440 of the Z-axis drive motor (not shown) to move the sweep rod 7400 simultaneously to follow an arcuate movement path. In implementation, the article wraps around the clamp rod 7200 in tension during folding for a tightest possible fold bend radius that ensures a stable fold.

Carrying the unclamped portion 7310a in an arc 7410 ensures the raised portion of the article 7300 is passed up, over, and away from the at least one clamp rod 7200, 7200a-b to land atop an unclamped portion of the article disposed on the rotatable platter 7100 in as tightly folded a layering as possible, wrapping the folded unclamped portion around the clamp rod 7200. Laying the folded layers as flat as possible ensures the final folded garment will be stackable in a packing queue without toppling and/or unfolding. With regard to implementations of methods of folding, at least one of article thickness and stiffness are considered in determining where to place a clamp rod 7200 such that the unclamped portion passed over the clamp does not resist folding and spring back to an unfolded state. In implementations, thicker and stiffer fabrics require clamping further into a garment from the edge than thinner, less stiff fabrics. In implementations, a default minimum clamp position from an edge (e.g., 5 cm, 5.5 cm, 6 cm, 6.5 cm, 7 cm, 7.5 cm, 8 cm, 8.5 cm, 9 cm, 9.5 cm, 10 cm, 10.5 cm, 11 cm, 11.5 cm, 12 cm, 12.5 cm) ensures successful folding regardless of fabric type or thickness.

As previously described, the folding robot 7000 (e.g., a movable, rotatable platter 7100 installed in a folding bay 7505 and the corresponding folding rods 7200, 7400 and blades 7650 in that folding bay 7505) is configured to fold a plurality of types of deformable articles autonomously. In implementations, the received deformable article 7300 is substantially extended (e.g., unfurled and flatted in a spread apart state). For example, a preceding robot in the process line (e.g., spreading station 7705, also a repositioning robot 6000 with a platter 7100 installed) can manipulate each of the deformable articles to spread each the article 7300 such that all extremities (hoods, torso portions, sleeves, legs, straps, skits, etc.) are fully spread or substantially spread to a flat or substantially flat condition. A substantially flat condition can include a deformable article 7300 having in a range of 1 to 5 tucked or twisted edges or corners of the article that can be resolved or accommodated by smoothing and folding processes executed by the folding robot 7000. Additionally or alternatively, in implementations, flat or substantially flat can include articles comprising a plurality of surface wrinkles that can be resolved and/or accommodated by smoothing and folding processes executed by the folding robot 7000 of each folding bay 7505 of the plurality of folding bays 7505a-n.

In implementations, the deformable article 7300 is one of a plurality of deformable laundry articles 7300a-n comprising two or more article types of at least one of different sizes and different shapes. For example, the deformable article 7300 can be one of a plurality of laundry articles comprising a single load of household laundry. Household laundry can comprise many types of bodily worn garments (undergarments, tee shirts, pants, dresses, skirts, shorts, pajamas, dress shirts, etc.) and cloth articles requiring washing (e.g., sheets, tablecloths, curtains, bath rugs, etc.). These garments and articles are deformable meaning they do not hold their shape. Because garments and other cloth articles are supple, they deform when manipulated. Different items of the plurality of laundry articles may have different thickness and stiffness values depending on the material and style of the item. For example, a woven bathmat will be stiffer than a silk blouse. The plurality of laundry articles in a single load of household laundry also can comprise many different laundry articles each having a different weight. Additionally, the size of each deformable article 7300 of the plurality of laundry articles can vary greatly within a single load of laundry, such that folding each deformable article 7300 requires maneuvers particular to each article. As will be described subsequently with regard to implementations, the controller 7005 will determine a folding process based on a determination of at least one of article type (e.g., shirt, pants, sock, bathrobe, zippered top, hooded sweatshirt, blouse, button front shirt, sweater, baby clothes, coats, blankets, coats, curtains, bed sheets, and towels), article size, article material thickness, material stiffness, remaining available volume in a receiving box (e.g. a packing box for return shipment to a household), one or more predetermined target final folded area footprint dimensions, and dynamical changing responses to each sequential maneuver.

In implementations, each of the two or more article types comprises a longest dimension of between about 4 cm to 500 cm. Accordingly, in examples, the rotatable platter 7100 has a shortest dimension in a range of between about 0.5 m to 5 m. In examples, such as those of the preceding examples, the rotatable platter 7100 is circular and the shortest dimension is a diameter. In implementations, each one of the plurality of platters 7100a-n in the system 500 comprises a diameter of between about 75 cm to 3 m. In implementations, the diameter is in a range of about 2.0 m to 2.6 m. In examples, the platter 7100 comprises a continuous flat top surface 7105. The continuous flat top surface 7105 can be opaque. In implementations, the continuous flat top surface 7105 comprises at least one of a solid color and pattern. Additionally or alternatively, in implementations, the continuous flat surface 7105 comprises at least one color. In implementations, the flat top surface 7105 can include one or more fiducial markers affixed to the flat top surface 7105 at known positions about a central z-axis Tzc for orienting the deformable article 7300 on the rotatable platter 7100. For example, the fiducial marker can be one or more visible markers (e.g., a line, a dot, a barcode tag, a letter, a number, a refractory disc, etc.) detectable by an optical sensor (e.g., sensor 7160) disposed adjacent the platter 7100 for sensing detectable fiducial markers on the top surface 7105 of the platter 7100. The one or more sensors can output a signal to the controller 7005, and at least one of the controller 7005 and remote terminal 205 (e.g., remote, or centralized, controller 205) can determine a rotational position of the platter 7100 based on the received signal indicative of a pose of one or more sensed fiducial markers relative to a known rotation position (e.g., a “home” position, such as a 0-degree rotational position). In implementations, the rotatable platter 7100 comprises a cross sectional thickness (in the direction of Tz) in a range of between about 0.5 inch to 2 inches (e.g., in a range of between about 1 cm to 5 cm). The rotatable platter 7100 comprises and/or is manufactured from at least one of foam core, polystyrene, balsa wood, aluminum, aluminum honeycomb, stainless steel, sign board, bamboo, and ULTRABOARD. The rotatable platter 7100 comprises and/or is manufactured from a stiff, lightweight material that has a low inertia under rotation for more immediate response to commands to rotate and stop in precise alignment to one or more of the at least one clamp rod 7200, 7200a-b, the sweep rod 7400, and another element, such as a folding blade 7650.

In examples, the spin drive motor 7512 is configured to rotate the platter 7100 at a fastest speed in a range of between about 30 RPM to 120 RPM. In implementations, the at least one controller 7005, 205 can determine a fastest rotational speed based on at least one of the size, weight, and type of laundry article 7300 disposed on the platter 7100. Intelligently limiting the rotational speed for lighter, thinner fabrics (e.g., as detected by at least one of the spreading station 7705 (e.g., repositioning robot 6000) and separating robot 5000) prevents the laundry article from flapping on top of itself when spread on the platter 7100 and/or toppling when at least partially folded. The drive motor 7512 can be reversible and configured to rotate the platter 7100 in at least one of a forward direction and reverse direction (e.g., clockwise and counterclockwise) depending on the most efficient rotation (e.g., a least amount of rotational distance) for orienting a received article 7300 with the at least one of at least one clamp rod 7200, a sweep rod 7400 and a folding blade 7650.

Returning to FIG. 10A, the folding robot 7000 (e.g., an autonomous device comprising a movable, rotatable platter 7100 installed in a folding bay 7505 and the corresponding folding rods and blades in that folding bay 7505) further comprises a first plurality of parallel support rails 7420a, 7220a secured to parallel sides in the folding bay 7505 and disposed adjacent the platter 7100, running lengthwise between the open ends 7506, 7507 of the bay. The first clamp rod 7200a of at least one clamp rod 7200 is configured to engage a first carrier 7212a slidably disposed on an inner one 7220a of the plurality of parallel support rails and the at least one sweep rod 7400 is configured to engage a second carrier 7412a slidably disposed on a next outer one 7420a of the plurality of parallel support rails. Alternatively, the at least one clamp rod 7200 can be configured to engage the second carrier slidably disposed on the outer one of the plurality of parallel support rails and the at least one sweep rod 7400 can be configured to engage the first carrier 7212a slidably disposed on the inner one of the parallel rails. In implementations, the first and second carrier 7212a, 7412a each further comprise at least one of a clamp Z-axis drive motor 7205a (not shown) and a sweep Z-axis drive motor (not shown) driven respectively by a clamp Z-axis drive 7240 (FIG. 4) and a sweep Z-axis drive 7440 (FIG. 4) in communication with the at least one controller 7005. In implementations, the at least one Z-axis clamp drive motor and the sweep rod Z-axis drive motor are linear drive motors configured to raise and lower the engaged at least one clamp rod 7200, 7200a-b and at least one sweep rod 7400 up and down, away from and toward, the top surface 7105 of the platter 7100. In implementations, the at least one clamp rod is a pair of clamp rods 7200a-b that can operate synchronously or asynchronously, lowering to different clamp heights to accommodate uneven thicknesses of an article disposed on the platter 7100. The height variations can be determined by the at least one controller 7005, 205 based on receiving at least one of a sensor signal from the one or more sensors 7160a-n indicating an article thickness at points of contact and a sensor signal of a feedback sensor configured to detect each clamp making contact with a laundry article.

In implementations, the folding robot 7000 (e.g., an autonomous device comprising a movable, rotatable platter 7100 installed in a folding bay 7505 and the corresponding folding rods and blades in that folding bay 7505) comprises similar components on both sides of the platter 7100. Z-axis drive motors (not shown) on either side of the platter 7100 are configured to be synchronously controlled for level raising and lowering the engaged respective sweep rod 7400 and one or more clamp rods 7200a-b evenly along their lengths. Alternatively, in implementations, the Z-axis drive motors 7205a-b, 7405a-b on either side of the platter 7100 can be asynchronously controlled, being operated one side at a time, for example, to accommodate clamping a particular article having a sensed uneven thickness (e.g., measured height from the top surface 7105). In implementations, the Z-axis drive motors further comprise a motor gear brake for preventing the raised sweep rod 7400 and one or more clamp rods 7200a-b from lowering in an uncontrolled and unexpected movement. In implementations, each of the Z-axis drive motors operates a linear actuator including at least one of a belt, chain and sprocket, a screw drive, a motor driven pinion gear configured to engage a vertical rack, and a pneumatic drive.

As shown in FIG. 10A, the first carrier 7212a can be configured to cantilever the engaged first clamp rod 7200a above the rotatable platter 7100, and a third carrier 7212b is configured to cantilever the engage second clamp rod 7200b above the rotatable platter 7100. Additionally or alternatively to the at least one clamp rod 7200, 7200a-b being retractable and/or telescoping, at least one of the first carrier 7212a and third carrier 7212b can further comprise a pivot joint (not shown) for tilting the engaged at least one clamp rod 7200, 7200a-b above the rotatable platter 7100. In examples, the at least one clamp rod 7200, 7200a-b is retractable, and the first carrier 7212a and third carrier 7212b further each comprise at least one friction wheel configured to engage the clamp rod 7200a-b for extending and retracting over the platter 7100 in the Ty coordinate direction. For example, as shown in the second bay 7505b of FIG. 10B, the at least one friction wheel is driven by a Y-axis drive motor 7206a-b, a′-b′ in operative communication via a drive belt or other similar motion transfer mechanism. The Y-axis drive motor 7206a′-b′a drives the friction wheel to rotate forward and in reverse to extend and retract the at least one clamp rod 7200a-b, a′-b′. The friction wheel engages a lower edge (e.g., a lowest corner, flat surface, lower half of the outer surface, and/or tangent point) of the at least one clamp rod 7200, 7200a-b to extend and retract the at least one clamp rod over the platter 7100 and a deformable article 7300 disposed thereon. In implementations, the at least one clamp rod 7200, 7200a-b can be supported by two or more rotatable guide wheels for supporting and aligning the at least one clamp rod 7200, 7200a-b at a fixed position parallel to the Y-axis Ty. In examples, the at least one clamp rod 7200, 7200a-b is telescoping and configured to extend and retract over the platter 7100.

As indicated in FIGS. 10A-B, the first and second carriers 7212a, a′, 7412a. a′ of each bay 7505a-b are driven to slide along two of the first plurality of parallel support rails 7420a, a′ 7220a, a′ by respective first and second X-axis drive motors 7205a, a′, 7405a, a′. In implementations, the X-axis drive motors 7205a, a′ 7405a, a′ power linear actuators configured to move the first and second carriers 7212a, a′, 7412a, a′ along their respective support rails 7420a, a′, 7220a, a′ in the X-axis (e.g., Tx coordinate). In implementations, the linear actuators comprise at least one of a belt, such as a timing belt, a chain, a reel and spool, and a pneumatic drive. In implementations, each of the X-axis drive motors 7206a, a′, 7406a, a′ comprises a shaft encoder 7265a-b, 7465a-b (FIG. 4). Additionally or alternatively, each of the support rails 7420a, a′, 7220a, a′ comprises a limit switch 7270, 7270a-b, 7470, 7470a-b (FIG. 4) for determining a starting, or home, position of each respective carrier 7212a, a′, 7412a, a′ and an incremental position encoder 7260, 7260a-b 7460, 7460a-b (FIG. 4) for subsequently tracking a location of each carrier 7212a, a′, 7412a, a′ along their respective support rail 7420a, a′, 7220a, a′ during folding and smoothing operations.

As described previously, a second plurality of parallel support rails 7420b, b′ 7220b, b′ of each bay 7505a-b are disposed parallel to the first plurality of parallel support rails 7420a, a′, 7220a, a′ and adjacent the rotatable platter 7100 such that the rotatable platter 7100 is disposed between the first plurality of parallel support rails 7420a, a′, 7220a, a′ and second plurality of parallel support rails 7420b,b′ 7220b, b′. The second plurality of parallel support rails 7420b, b′, 7220b, b′ comprises a second set of carriers 7212b, b′, 7412b, b′ and X-axis drive motors 7205b, b′, 7405b, b′, Y-axis drive motor 7206b, b′, and Z-axis drive motors 7207b, b′, 7405b, b′ and corresponding carriers 7212b, b′, 7412b, b, drives, linear actuators, shaft encoders, limit switches and incremental encoders as described previously with regard to the first plurality of parallel support rails 7420a, a′, 7220a, a′ of the top and bottom bays 7505a-b.

In implementations, the X-axis drive motors 7205a-b of the at least one clamp rod 7200, 7200a-b are configured to be synchronously controlled on both sides of the platter 7100 to maintain the carrier ends of the first and second clam clamp rods 7200a-b at matching positions along their respective rails and therefore in line with one another along a Y-axis oriented in the coordinate Ty direction. In implementations in which the at least one clamp rod 7200 is a single rod, the synchronized control of the X-axis drive motors 7205a-b prevents an uneven motion of the carrier ends that would result in twisting the unitary clamp rod 7200. Similarly, the X-axis drive motors 7405a-b of the sweep rod 7400 are configured to be synchronously controlled on both sides of the platter 7100 to maintain the carrier ends of the sweep rod 7400 at matching positions along their respective rails and therefore in line with one another along a Y-axis oriented in the coordinate Ty direction.

In implementations, as shown in FIG. 10A, the at least one clamp rod 7200 comprises a first clamp rod 7200a engaged with the first carrier 7212a and a second clamp rod 7200b engaged with a third carrier 7212b slidably engaged with another support rail 7220b. The third carrier 7212b can be engaged with an inner one 7220b of the second plurality of parallel support rails 7420b, 7220b disposed on an opposite side of the platter 7100 from the first plurality of support rails 7420a, 7220a. Alternatively, the third carrier 7212b can be slidably engaged with an outer one of the second plurality of parallel support rails 7420b, 7220b. Under operative control of the at least one controller 7005, the X-axis drive motors 7205a-b of the first and second clamp rods 7200a-b can be configured to transit synchronously the first and second clamp rods 7200a-b along their respective support rails 7220a-b in an X-axis Tx direction. Alternatively, the first and second clamp rods 7200a-b can be configured to slide asynchronously in an X-axis Tx direction, for example, when clamping an article in more than one location simultaneously or when clamping with only of the first and second clamp rods 7200a-b and stowing the other out of the way of the sweep rod 7400 during a folding motion. Under operative control of the at least one controller 7005, the Y-axis drive motors 7206a-b of the first and second clamp rods 7200a-b can be configured to extend and retract the first and second clamp rods 7200a-b synchronously along the Y-axis Ty direction. During operation, a central longitudinal axis of each of the first and second clamp rods 7200a, 7200b can align with a shared axis such that the rods align end-to-end over the platter 7100. In implementations, the first and second clamp rods 7200a-b comprise an end-to-end gap therebetween of between about 0 to 50 mm in a fully extended position. In implementations, the first and second clamp rods 7200a-b can extend to allow the sweep rod 7400 and blade 7650, 7650a-b to pass over the first and second clamp rods 7200a-b while moving along the X-axis Tx direction (e.g., forward and reverse in the Tx coordinate direction).

In alternate implementations, the at least one clamp rod comprises a single piece clamp rod engaged with the first carrier and a third carrier slidably engaged with an inner one of the second plurality of parallel support rails such that the single clamp rod extends across the entire rotatable platter 7100. The single piece clamp rod can be retractable and the first carrier can further comprise at least one friction wheel configured to engage the clamp rod for extending and retracting over the platter 7100. The at least one clamp rod can be telescoping and configured to extend and retract over the platter. In examples of at least one of a retractable and telescoping single clamp rod, the third carrier can be configured to selectively receive and release the single clamp rod when fully extended. In examples, the first carrier further comprises a pivot joint for tilting the engaged at least one clamp rod above the rotatable platter 7100, and the third carrier is configured to selectively receive and release the single clamp rod when tilted to a lowered position.

In alternate implementations, the at least one sweep rod 7400 comprises a first sweep rod configured to engage with the second carrier and a second sweep rod configured to engage with a fourth carrier slidably engaged with one of the second plurality of parallel support rails 7420b, 7220b. In examples, the fourth carrier is slidably engaged with an outer one of the second plurality of parallel support rails 7420b, 7220b. Alternatively, in examples, the fourth carrier is slidably engaged with an inner one of the second plurality of parallel support rails. In implementations, the at least one sweep rod 7400 comprises a single sweep rod 7400 engaged with the second carrier 7412a slidably engaged along a support rail 7420a of the first plurality of parallel support rails and a fourth carrier 7412b slidably engaged with a support rail 7420b of the second plurality of parallel support rails, the single sweep rod 7400 extending across the entire rotatable platter 7100. In implementations, each of the first and second pluralities of parallel support rails comprise two or more rails disposed on opposing sides of the support frame 7508 in each bay 7505 of the plurality of bays 7505a-b. For example, a third rail or pair of rails (one on each side of the platter) can support one or more of a pinpoint clamp, a robotic arm, and a rotatable (e.g., tiltable) blade, as will be described subsequently with regard to implementations.

In implementations, the folding robot 7000 (e.g., an autonomous device comprising a movable, rotatable platter 7100 installed in a folding bay 7505 and the corresponding folding rods and blades in that folding bay 7505) further comprises at least one spin drive motor (not shown) operating under the control of the spin drive 7435 (FIG. 4). The spin drive motor is configured to rotate (e.g., spin) the at least one movable sweep rod 7400 about a longitudinal axis at least one of parallel to or coaxial with a longitudinal central axis of the sweep rod 7400 while suspended above the platter 7100 and slidably moving in an X-axis direction (e.g., the Tx coordinate direction) along corresponding support rails 7420a-b. In implementations the at least one spin drive motor comprises a first spin drive motor disposed on the second carrier 7412a and a second spin drive motor disposed on the fourth carrier 7412b. Under operative control of the at least one controller 7005, the spin drive motors are configured to spin synchronously such that the entire length of the sweep rod 7400 rotates at the same revolution rate. In implementations, the spin drive motors each rotate a drive belt or other similar motion transfer mechanism to spin the sweep rod 7400. Rotating the entire length of the sweep rod 7400 at the same revolution rate and rotational position ensures that the rod 7400 does not twist or cause an article being swept smooth by the sweep rod 7400 to bunch up by moving up or beneath the article 7300 at variable rates of rotation. In implementations, the spin motors are configured to engage a shaft encoder for maintaining a rotational position and such that a controller can monitor for any slip.

In implementations, the at least one movable sweep rod 7400 is configured to slide under a terminal edge of an unclamped portion of the article 7300 while rotating. The one or more sensors 7160a-n can be configured to detect the terminal edge for aligning a length of the at least one movable sweep rod 7400 with the length of the terminal edge such that the terminal edge tangentially contacts movable sweep rod upon contact. This tangential contact assists with rotating the terminal edge up and onto the rotating sweep rod 7400 so that the rotating sweep rod 7400 can slide beneath the article 7300 disposed on the platter 7100. Alternatively, in implementations, the movable sweep rod 7400 operates without spinning (e.g., rotating about its longitudinal axis).

In implementations, the at least one clamp rod 7200 and at least one movable sweep rod 7400 each comprise, or are manufactured from, at least one of wood, stainless steel, aluminum, DELRIN, polycarbonate, graphite, titanium, PVC, bamboo, and chromoly. In implementations, the rods 7200, 7400 are stiff and resistant to bending in a fully extended position. In some examples, the at least one clamp rod 7200 and at least one movable sweep rod 7400 can be tubular to reduce weight while maintaining radial strength and stiffness along the length of the elongated rods. Additionally or alternatively, in implementations, the at least one movable sweep rod 7400 comprises a tensioned wire.

In all implementations herein described previously and hereafter with regard to a single bay 7505 of the plurality of folding bays 7505a-n, it is intended that all elements described with regard to the single bay 7505 are applicable to all others of the plurality of folding bays 7505a-n.

In implementations, the folding device 7000 (e.g., an autonomous device comprising a movable, rotatable platter 7100 installed in a folding bay 7505 and the corresponding folding rods and blades in that folding bay 7505) further comprises one or more force sensors disposed on at least one of the at least one clamp Z-axis drive motor 7205 and a contact surface of the at least one clamp rod 7200, 7200a-b configured to contact an article 7300 disposed on the platter 7100. In implementations, the one or more force sensors comprise at least one of a compression-type load cell, a compression-tension load cell, a pneumatic load cell, a hydraulic load cell, a capacitance load cell, a strain gauge, a bending beam, and a piezo sensor. The one or more force sensors are configured to be in operative communication with a sensor interface 7255 and the controller 7005 via a network interface 7250 as shown in FIG. 4. In implementations, at least one of the sweep rod 7400, one or more sweep rod Z-axis motors, and/or at least one carrier 7412a-b comprises a force sensor configured to detect an amount of force the sweep rod 7400 imparts on the article and output a signal indicative of the amount of force to the controller 7005 for instructing a drive 7440 of the one or more Z-axis motor (not shown) to maintain the downward force applied with a range of forces of between about 2.5N and 50N.

In implementations, as shown in FIGS. 10A-C, additionally or alternatively to the sweep rod 7400, the device 7000 comprises a blade assembly 7600. In implementations, the blade 7650 is configured to rotate to about a 60-degree angle with respect to the platter surface 7105. This approximate rotational angle may be advantageous for smoothing a deformable article when placing the blade 7650 under a clamped article and when moving the blade 7650 along a deformable article on the platter to smooth any wrinkles and/or unfurl any folded over portions of the article prior to folding. As will be described subsequently with regard to implementations, the blade 7650 is configured to rotate completely through one or more partial or full 360 degree rotations for lifting, flipping, and manipulating an article during smoothing and folding processes.

In implementations, the blade 7650 is a thin, substantially planar blade, and the surface of the blade 7650 is generally smooth to reduce catching on or creating friction with the deformable article. Alternatively, in implementations, at least one surface of the blade can be treated to create a higher frictional surface to retain more smooth fabric articles thereon without the articles sliding off during a folding operation. For example, an edge and/or planar contact surface of the blade 7650 can comprise at least one of a surface topography (e.g., peening, etching, raised textural bumps) and grippy surface material (e.g., a textured coating). The blade 7650 may be formed of a metal (e.g., aluminum, stainless steel, chromoly), carbon fiber, stretched canvas, nylon or plastic/elastomeric material; however, any suitable material configured to be held in tension along its length for maintaining a consistently straight edge.

In implementations, the length of the blade 7650 is generally sufficiently long so that it extends across the platter 7100 (e.g., from 0.5 m to 5.0 m). Alternatively, in implementations, the blade 7650 may extend across only a portion of the platter 7100. In implementations, the blade 7650 comprises a length in a range of between about 2.0 m to 3.2 m. The width of the blade 7650 may be from 5 or 10 cm to 20 cm, 30 cm, 40 cm, 50 cm or more. In implementations, the width of the blade 7650 is between 10 cm and 50 cm wide. In implementations, the thickness of the blade 7650 can be 5 mm to 3 mm or 2 mm or 1 mm or less. The dimensions of the blade 7650 may be selected to pass under a deformable article 7300 and/or to provide smoothing motions over a top of the deformable article 7300. Because the blade 7650 is relatively long compared to its thickness, the blade 7650 is held in tension across its length to prevent sagging over the platter 7100, which would result in less effective smoothing and folding of an article thereon because not all portions of the blade 7650 would contact the article evenly. In implementations, a ratio of the blade length to thickness comprises a range of between about 1500 to 1 to 3000 to 1.

In implementations each one of the plurality of tiered folding bays 7505a-n comprises a folding blade assembly 7600 suspended from a top portion of the bay 7505. The suspended folding blade assembly 7600 comprises symmetrical systems on both ends of blade 7650 and systems described herein with regard to one end are applicable to the other end. The suspended folding blade assembly 7600 is configured to move up and stow out of the way when the pair of transfer conveyors 7515a-b lift a platter 7100 into and out of a folding bay 7505. Additionally, in implementations, stowing a blade 7650 all the way up at the top of a folding bay prevents the blade 7650 from interfering with at least one of one or more clamp rods 7200, 7200a-b and a sweep rod 7400.

In implementations, a pair of upper and lower linear rails (e.g., SBR rail) 7660a-b, 7661a-b, 7660a′-b′, 7661a′-b′ can be disposed on both sides of the bay 7505, 7505a-b along the top of the bay, extending front-to-back (e.g., loading end to unloading end) between the open ends 7506, 7507. As shown in FIG. 10C, in implementations, the upper rails 7660a-b, 7660a′-b′ extend along an interior-facing surface and the lower rails 7661a-b, 7661a′-b′ each extend along a bottom-facing surface of the bay structure for withstanding moment forces applied by the rotating and sliding blade 7650a, 7650b. In implementations, the blade 7650, 7650a-b is mounted on both ends to corresponding arms 7666a-b, a′-b′, 7666a″-b″, a′″-b′″ configured raise and lower in the Z-axis direction (Tz coordinate direction) along stanchions 7664a-b, 7665a-b, 7664a′-b′, 7665a′-b′. The stanchions are mounted to upper and lower pairs of slidable carriages 7668a-b, a′-b′ 7669a-b, a′-b′, 7668a″-b″, a′″-b′″ 7669a″-b″, a′″-b′″, configured to move in the X-axis (Tx) direction along the upper and lower linear rails 7660a-b, 7661a-b, 7660a′-b′, 7661a′-b′. The upper and lower pairs of slidable carriages are constrained by the rails 7660a-b, 7661a-b to take up tension in the blade 7650 and, in implementations, to withstand the blade 7650 being lowered to apply a force to “pat down” a folded up laundry article, e.g., compressing the folded article to a shorter height for more stable folds and/or more compact packing into a customer return box and, subsequently, a household dresser drawer.

As with previously described implementations, one or more drive motors of the folding blade assembly 7600′ are in operable communication with the controller 7005, 205. In implementations, as shown in FIGS. 10B-C, an X-axis motor 7606a-b, 7606a′-b′ is configured to move the pair of slidable carriages in the x-axis (Tx) direction by pulling a tensioned timing belt 7607a-b, 7607a′-b′ one way or another toward either of the first and second open ends 7506, 7507 of a folding bay 7505. In implementations, the timing belt 7607a is anchored to the stanchions 7664 configured to move along the upper and lower linear rails 7660a, 7661a.

In implementations, a Z-axis motor 7605a-b, 7605a′-b′ is disposed on one of each end of the blade 7650, 7650a-b. Each Z-axis drive motor 7605a-b, 7605a′-b′ is configured to operate a linear actuator to raise and lower the arms 7666a-b, a′-b′, 7666a″-b″, a′″-b′″ in the Z-axis direction (Tz) along the stanchions 7664a-b, a′-b′, 7664a″-b″, a′″-b′″. In implementations, the linear actuator includes at least one of a belt, chain and sprocket, a screw drive, a motor driven pinion gear configured to engage a vertical rack, and a pneumatic drive. In implementations, a Z-axis motor 7605a-b. 7605a′-b′ drives a pinion gear configured to engage a rack disposed on at least one of the arms 7666a-ba′-b′, 7666a″-b″, a′″-b′″. This Z-axis drive mechanism is implemented on both ends of the blade 7650, 7650a-b. In implementations, each blade 7650 is configured to lower to a distance below the table height such that the controller 7005 can instruct the Z-axis motor 7605 to lower the blade 7650 at least to the top surface of a platter 7100 and apply additional compression force when a folded laundry article requires compression to at least one of secure folds and size the article to occupy a least amount of volume in a packing container. In implementations, the Z-axis motors 7605a-b, a′-b′ disposed at each end of the blade 7650a-b are configured to synchronously raise and lower both ends such that the blade 7650a-b remains level above the platter 7100 during raising and lowering and all sweep and folding operations.

Additionally, the blade 7650 is configured to rotate with an engaged, driven shaft disposed at each end of the blade 765′ in alignment with a central longitudinal axis L_{A} of the blade 7650. In implementations the blade shaft can be directly coupled to the drive motor 7670a. Alternatively, the shaft can be coupled to the drive motor 7690a via a pair of rotatable pulleys (or sprockets). In implementations, a first pulley is engaged with the shaft and a second pulley in vertical alignment with the first pully is engaged with a drive shaft of the motor 7690a. A drive belt (e.g., a timing belt) couples the motion of the second pulley to the first pulley to rotate the shaft. This drive configuration is replicated on both ends of the blade 7650 and the motors operate synchronously to drive the blade 7650 to rotate without twisting.

Because the blade 7650 is driven to rotate from the center of the blade (e.g., about the central longitudinal axis L_{A}) by a single shaft 7676a, the blade 7650 can rotate 360 degrees one or more times in the same direction (e.g., clockwise or counterclockwise). In implementations, the shaft comprises a magnet disposed thereon. A stationary sensor disposed on the arms detects a rotational position of the magnet and therefore the shaft and outputs a signal to the at least one controller 7005, 205 indicative of a rotational position of the blade 7650 attached to the shaft. The at least one controller 7005, 205 can control an angle of the blade 7650 relative to the top surface of the platter 7100 and a laundry article 7300 disposed thereon based on signals received form at least one of the sensor 7698a and a motor encoder 7691a disposed on the drive shaft of the rotational drive motor 7670a.

In all implementations herein described, the blade 7650, 7650′ can be used in operations analogous to the operations as described herein with respect to the sweep rod 7400. In examples, the blade Z-axis drive motors 7605a-b, 7605a′-b′ are configured to raise and lower the blade assembly 7600 relative to the platter surface 7105 and the X-axis drive motors 7606a-b, 7606a′-b′ are configured to move the blade assembly 7600 along the parallel support rails in the X-axis direction (Tx). The rotational drive motors 7670a-b, 7690a′-b′ are configured to rotate the blade 7650, 7650a-b, and in implementations, the rotational drive motors 7670a-b, 7690a′-b′ engaged with opposite ends of the blade 7650, 7650a-b are geared for synchronized motion to keep the surface of the blade flat (e.g., not twisted between the ends) in any position (e.g., any rotational angle relative to the top surface 7105 of the platter 7100). In implementations comprising both at least one clamp rod 7200, 7200a-b and a blade 7650, the at least one clamp rod 7200, 7200a-b is disposed parallel to the blade 7650 and is configured to raise and lower from the rotatable platter and slidably move parallel to the surface 7105 such that the clamp rod 7200, 7200a-b can clamp a deformable article to the surface 7105 of the platter 7100 prior to the blade 7650 acting upon the article. Similar to the sweep rod 7400, the blade assembly 7600 is operably controlled by the at least one controller 7005, 205 and comprises various drives, sensors, processors, and communication electronics as depicted in FIG. 4 for controlling operations of the blade assembly 7600.

As described previously, in implementations, the blade 7650, 7650a-b is configured to fold one portion of the deformable article 7300 over another by operating similarly to the sweep rod 7200. Additionally or alternatively, the blade 7650 can fold one portion of a deformable article 7300 over another portion by raising up the one portion and rotating while moving laterally (Tx direction) and tilting at an angle to flip the one portion atop the another portion. Additionally, the blade 7650 can spin one or more times (e.g., 180 degrees of rotation, 360 degrees of rotation, 540 degrees of rotation, 720 degrees of rotation, etc.) while in the lowered position to fully extend the one portion over the another portion and free the blade 7650 from beneath the lifted and folded over portion.

In implementations, the blade 7650, 7650a-b is configured to fold a portion of an article on top of itself without a clamp rod 7200, 7200a-b clamping the article. Optionally, the clamp rod 7200, 7200a-b is configured to first clamp an article prior to the blade 7650, 7650a-b performing folding operations. Based on received sensor signals, the at least one controller 7005, 205 is configured to determine whether an article 7300 requires clamping prior to each folding pass. Blade folding operations may be repeated with the platter 7100 optionally rotating one or more folding passes.

The blade 7650, 7650a-b can be used with any deformable article, but is particularly useful in operations involving heavier fabrics, such as denim, to form fold lines or to reduce wrinkles and smooth deformable articles 7300 as described herein. In examples, the blade 7650, 7650a-b and the sweep rod 7400 are provided on the same folding robot 7000 (e.g., within the same folding bay 7505 of the plurality of folding bays 7505a-n) with an optionally deployed at least one clamp rod 7200, 7200a-b. In implementations, the at least one controller 7005, 205 selects one or both of the blade 7650, 7650a-b and the sweep rod 7400 to form folds. In implementations, selecting one or the other of the blade 7650, 7650a-b or sweep rod 7400 for executing a fold is dependent on detected or provided characteristics of the deformable article, such as at least one of fabric type, weight, article size, article feature(s), shape of the deformable article, and user preferences stored in a memory 6010, 7010, 210,235, 240, 250 in communication with the at least one controller 7005, 205. For example, the legs of a pair of stiff, heavy jeans would be more easily lifted and folded by a planar blade 7650 than by a sweep rod 7400.

Additionally or alternatively to folding, the blade 7650, 7650a-b may be used to manipulate deformable articles using various operations. In examples, the blade 7650, 7650a-b is configured to sweep beneath and atop a deformable article 7300 to remove wrinkles and unfurl folded over portions. In examples, the blade 7650, 7650a-b is configured to transit at an angle over a top of a clamped deformable article 7300 such that at least an edge of the blade 7650 contacts the deformable article to reduce folds or wrinkles in the deformable article and unfurl any folded over portions. In implementations, the article can be clamped prior to a sweep pass by the blade 7650. In implementations, the topside sweep angle of the blade 7650, 7650a-b comprises a range of between about 5 to 90 degrees (with vertical being 0 degrees) formed between the plane of the tilted blade and the top surface of the platter 7100 and an article disposed thereon. In implementations, the top side sweep angle comprises a range of between about 15 to 45 degrees. In implementations, the top side sweep angle can be preset to an angle suitable for all article materials and types. Additionally or alternatively, the blade 7650, 7650a-b further comprises one or more feedback sensors configured to output measurements to the at least one controller 7005, 205 for dynamic control. Based on output signals received from the one or more sensors 7160a-n., the at least one controller 7005, 205 is configured to dynamically control the angle of the blade 7650, 7650a-b to ride up and over protrusions (e.g., buttons, sequins, embellishments) and not run into them and potentially damage the deformable article 7300.

In implementations, the at least one controller 7005, 205 determines, in response to receiving sensor signals from the one or more sensors 7160a-n, an edge of a folded article and operably controls the blade 7650, 7650a-b to slide under the edge. In implementations, the blade 7650, 7650a-b is configured to lift the fully folded deformable article and maintain the final folded configuration while moving the deformable article to another location (e.g., onto an unloading elevator or packing station conveyor (e.g. queuing and packing device)). In implementations, the blade 7650, 7650a-b is configured to contact the top surface 7105 of the platter 7100 or lower to just about the top surface while the platter 7100 rotates with an article thereon abutting the blade 7650 such that the article twists into a rolled spiral. This could be useful, for example, for spiral “folding” a large, heavy beach towel or a pair of pants that is otherwise unfoldable because one leg is inside out, for example.

As previously described with regard to implementations, once folding operations are determined to be completed, the folded article 7300 is transferred to an unloading elevator 7900 for delivery to an unloading station 7950. As shown in FIGS. 5-8, in implementations, the unloading station 7950 comprises a folded laundry article retrieval conveyor 7960 (herein after referred to as the “conveyor 7960”) suspended from a gantry rail 7955 by a carriage 7970. The carriage 7970 is configured to move in the y-axis direction Ty along the gantry rail 7955, and the gantry rail 7955 is configured to transit on a stationary pair of parallel rails 7957a-b in the x-axis Tx direction over a platter 7100 received within the unloading station 7950. The suspended conveyor 7960 is thus able to move in X and Y directions, Tx and Ty, and lower to the platter top surface 7105 retrieve a folded article 7300 disposed anywhere on the top surface 7105 of the platter 7100. Although the various controls of the unloading station are not shown in the controls system 400 of FIG. 4, the unloading station controls are analogous to those of the folding bay 7505 and the at least one controller 7005, 205 is in operative communication with the unloading station sensors and drive elements.

Once the carriage 7970 transits the conveyor 7960 to a location adjacent and above a folded article 7300, the at least one controller 7005, 205 instructs an actuator of the carriage 7970 to lower a leading edge 7961 (FIG. 7) of the conveyor 7960 onto the top surface 7105 of the platter 7100. In implementations, the leading edge 7961 is configured to be advanced to a position adjacent a folded edge of the folded article. Once the leading edge 7961 contacts the folded article, a rotating belt of the conveyor 7960 advances the article up onto the conveyor 7960. By contacting a folded edge, the conveyor 7960 is less likely to unfold the folded article 7300 than if the rotating conveyor were to contact a single, lower layer of the folded article and potentially unravel one or more folds of the article, pulling on one edge, while another slides off to lay the article out flat.

In implementations, as shown in FIGS. 5-8, the unloading station 7950 comprises one or more sensors 7952a-n configured to detect at least one of the presence, orientation, and height of the folded article disposed on a platter 7100 received within the unloading station 7950 and output a signal to the at least one controller 7005, 205 indicative of the at least one detected characteristic. In implementations, the one or more sensors 7952a-n comprise one or more optical sensors disposed at least one of above and adjacent to the unloading station 7950. In implementations, the one or more sensors 7952a-n comprise one or more optical sensors disposed on at least one of the gantry rail 7955 and the carriage 7970. Additionally or alternatively, in implementations, the one or more sensors 7952a-n comprise one or more optical sensors disposed on at least one of the unloading elevator 7900 and an unloading elevator cantilever 7901 extended about the unloading station. Additionally or alternatively, in implementations, the one or more sensors 7952a-n comprise one or more optical sensors disposed on a rail mounted above the unloading station 9750. In implementations, the one or more sensors 7952a-n are configured to detect one or more edges of the folded article disposed on a platter 7100 at the unloading station 7950. Additionally, in implementations, the at least one controller 7005, 205 is configured to determine a location and orientation of a folded edge along the top surface 7105 of the platter 7100 based on one or more received signals output by the one or more sensors 7952a-n.

Based on the received output signal of the one or more sensors 7952a-n, the at least one controller 7005 is configured to communicate with one or more drive motors configured to move carriage 7970 and the conveyor 7960 thereon in the X-axis and Y-axis directions (Tx and Ty) and position the leading edge 7961 of the conveyor 7960 adjacent an identified and located edge of the folded article. Additionally, in implementations, the unloading station 7950 comprises a receiving coupling similar to that disposed within each one of the tiered folding bays 7505a-n. A drive motor of the receiving coupling of the unloading station 7950 is configured to be in operative communication with at least one controller, e.g., controller 7005, remote terminal 205. In implementations, based on one or more received signals from the one or more sensors 7952a-n, the at least one controller 7005 can instruct the drive motor of the receiving coupling of the unloading station 7905 to rotate the platter 7100 coupled thereto (e.g., by a platter coupling 7165 seating in the receiving coupling in mated engagement) until the one or more sensors 7952a-n, detect an edge of the folded article 7300 being parallel with the leading edge 7961 of the conveyor 7960.

As described previously with regard to implementations, an autonomous laundry system 500 includes one or more autonomous folding robots 7000, 7000a-b each configured to fold a plurality of clean household laundry articles 7300a-n of a plurality of article types and sizes, and at least one spreading station 7705 disposed adjacent the one or more autonomous folding robots 7000, 7000a-b. As described previously with regard to implementations, the at least one spreading station 7705 is configured to spread an article of laundry 7300 of the plurality of clean household laundry articles 7300a-n for delivery to one of the one or more folding devices 7000, 7000a-b. The at least one controller 7005, 205 is configured to autonomously shuffle a plurality of rotatable platters 7300a-n into and out of the spreading station 7705 and a plurality of tiered laundry folding bays 7505a-n.

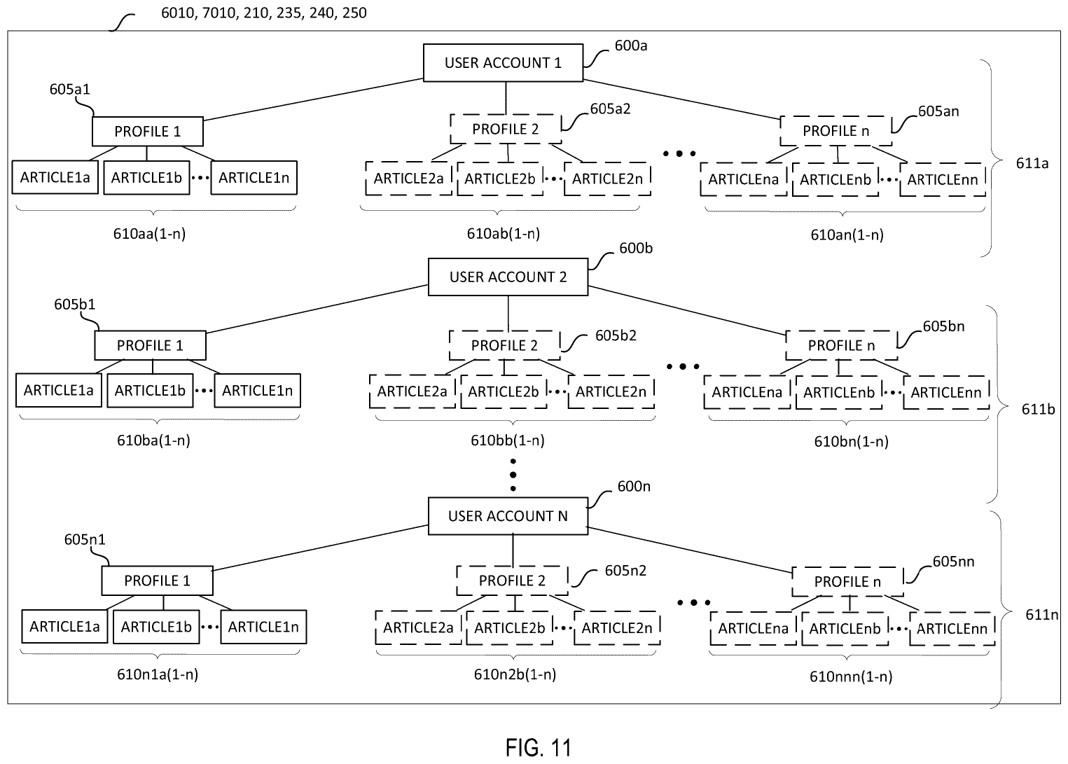

As shown in FIG. 11, the article of laundry 7300 is associated with a user account 600 of a plurality of user accounts 600a-n stored in at least one memory (e.g., memory 6010, memory 7010, memory 210, database 235, server 240, server farm 250). Each of the plurality of laundry articles 7300a-n can be stored as a representative datum 610, 610a-n in the at least one memory. As will be described subsequently with regard to implementations, the representative datum 610, 610a-n can comprise at least one of an image 306, 306a-n of a laundry article 7300, 7300a-n, a unique article identifier, and one or more article characteristics.

As described previously with regard to implementations, at least one sensor 7160,7160a-n, 7709, 7709a-n, 7952, 7952a-n is disposed at least one of adjacent to and above at least one of the at least one spreading station 7705, the one or more autonomous folding devices 7000, 7000a-b (e.g., folding robot 7000 (e.g., a movable, rotatable platter 7100 installed in a folding bay 7505 and the corresponding folding rods 7200, 7400 and blades 7650 in that folding bay 7505), and the discharge station 7950. The at least one sensor 7160,7160a-n, 7709, 7709a-n, 7952, 7952a-n is configured to detect the article of clean laundry 7300 and output a signal comprising at least one of an image 306, 306a-n (e.g., 3D point cloud data, 2D RGB image data) and image data 610, 610a-n (e.g., date, image quality, etc.) of the article of laundry 7300 in at least one of a folded and unfolded state. The system 500 comprises at least one controller 6005, 7005, 205 in operable communication with the at least one memory (e.g., memory 6010, memory 7010, memory 210, database 235, server 240, server farm 250), the at least one sensor 7160, 7160a-n, 7709, 7709a-n, 7952, 7952a-n one or more drives (as described previously with regard to FIG. 4) of each one of the one or more autonomous folding devices 7000a-n, and one or more drives of the at least one spreading station 7705, 6000 and unloading station 7950.

The at least one controller 6005, 7005, 205 is configured to receive the output signal of the one or more sensors 7160,7160a-n, 7709, 7709a-n, 7952, 7952a-n and process the output signal with one or more machine learning models stored in the at least one memory (e.g., memory 6010, memory 7010, memory 210, database 235, server 240, server farm 250). Based on the processing of the output signal with the machine learning model, the at least one controller 6005, 7005, 205 is configured to identify one or more characteristics of the laundry article 7300. In implementations, the two or more characteristics comprise at least two of an article type, an unfolded article size, a predicted folded article size, an article shape, one or more article features, and a profile 605 indicative human wearer or owner of the article associated with a user account 600 stored in the at least one memory in communication with the at least one controller 6005, 7005, 205. In implementations the article shape comprises article flatness, one or more twists, and one or more folds.

In implementations, as shown in FIG. 4, taking for exemplary purposes a first user account 600a, a profile 605 can be one of a plurality of profiles 605a1-an associated with a user account 600a. Each profile 605 is representative of an individual wearer or owner of each laundry article 7300, 7300a-n. Each profile 605 of the plurality of profiles 605a1-an is associated in the at least one memory 6010, 7010, 210, 235, 236, 237 240, 250 with a plurality of data 610aa(1-n) associated with a plurality laundry articles 7300a-n worn or owned by a single profile in a household (e.g., user account 600). The plurality of data 610aa(1-n) comprise attributes of the stored images. Such attributes can comprise, for example, a processing date stamp, an associated profile 605, an article type, an article color, one or more folded dimensions, a drawer (“cluster”), and other attributes and user defined preferences. In implementations, the plurality of data 610aa(1-n) comprises at least one of one or more characteristics identified by the at least one controller 6005, 7005, 205 and one or more characteristics or user preferences transmitted by a user 208 of an account 600 to the at least one controller and stored in the at least one memory.

For example, a user account 600a comprises a plurality of profiles 605a1-605an. A single profile, for example, profile 605al, is associated in the at least one memory with a plurality of articles 7300a(1-n) stored as a respective plurality of image data 610aa(1-n). The data can be stored, for example, in a database 235 in communication with the at least one controller 6005, 7005, 205. As previously described, the stored data 610aa(1-n) comprises at least one of an image 306 of an article 7300, article type, article size, user folding preferences, user clustering preferences, and any date information of previous detection of the article by the one or more sensors during previous cleaning and folding operations by robots in the system 500.

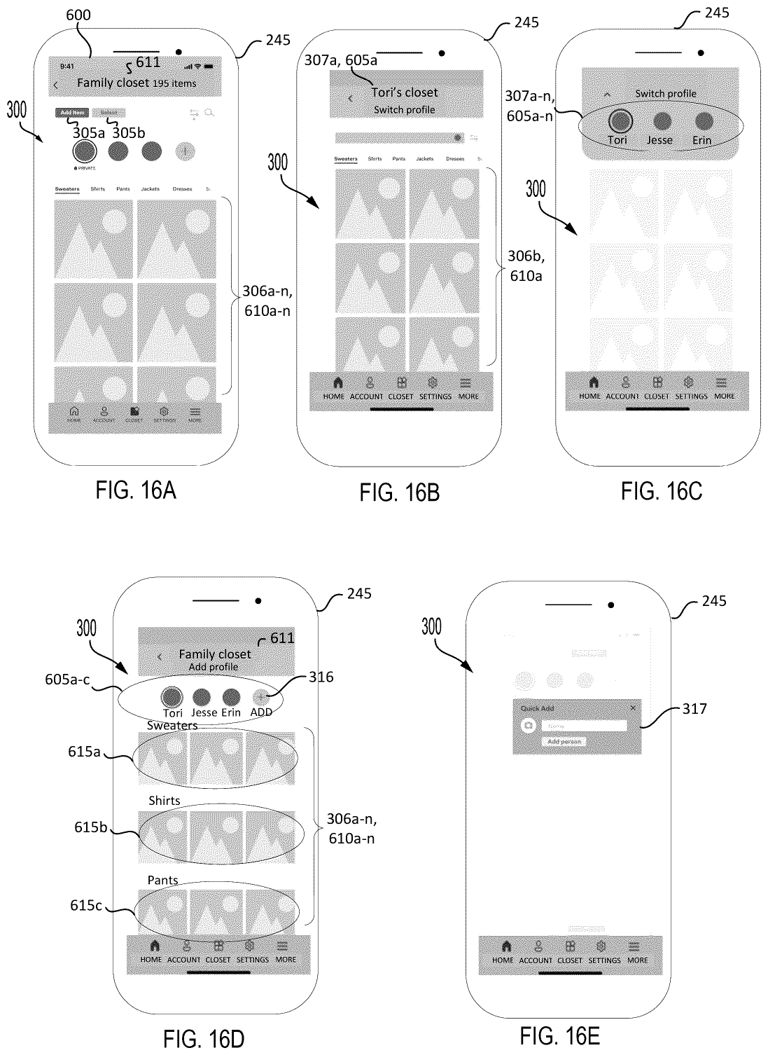

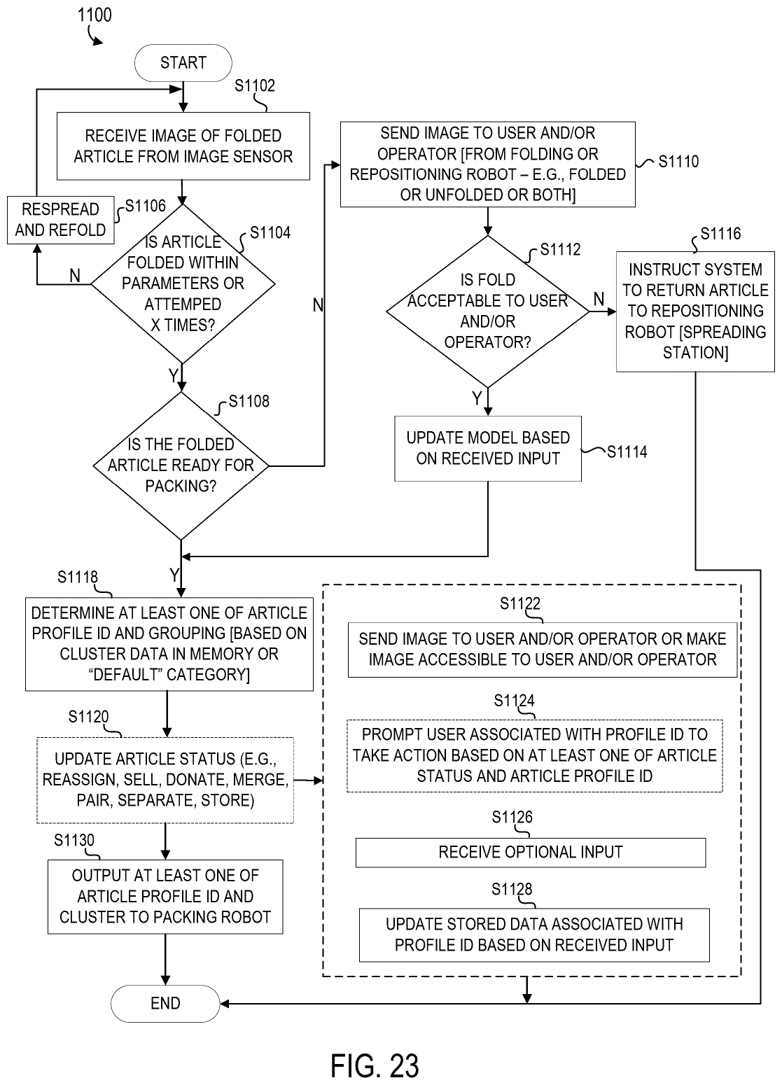

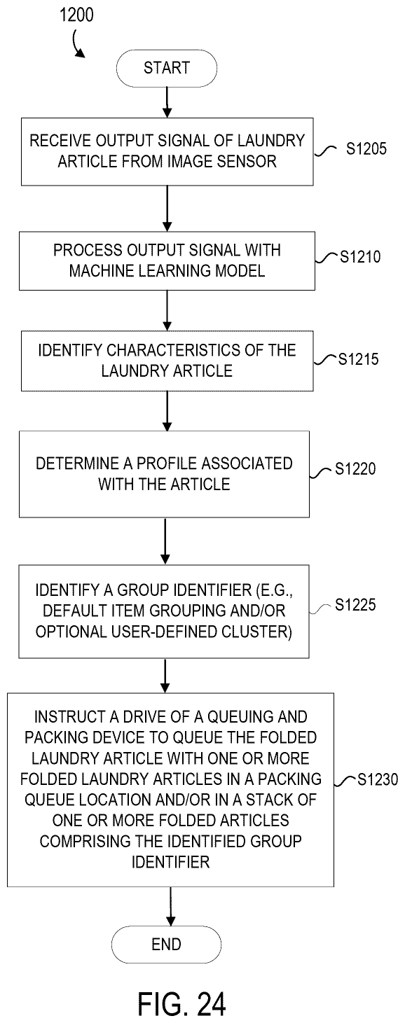

In implementations, the at least one controller 6005, 7005, 205 is configured to retrieve from the at least one memory 6010, 7010, 210, 235, 236, 237 240, 250, based on the identified one or more characteristics, executable folding instructions executable by the at least one controller for operably controlling the one or more motor drives (e.g., 7230, 7235, 7240, 7430, 7435, 7440, 7552, 7630, 7635, 7640) of one of the one or more folding robots 7000, 7000a-b. In implementations, the executable instructions comprise default folding instructions based on the one or more identified characteristics comprising at least one of article type and size. Additionally or alternatively, as will be described subsequently with regard to at least the interactive graphical user interface screens of FIGS. 16A-21C and the methods of FIGS. 23-24, the executable instructions comprise implementing user folding and packing (e.g., grouping) preferences. In implementations, executable instructions implementing user-defined folding preferences take priority over default folding instructions.

In implementations, as described previously with regard to FIG. 11, the at least one controller 6005, 7005, 205 is configured to store, for each user account 600, data 610, 610a-n representative of a plurality of deformable laundry articles 7300a-n and one or more contemporaneous dates of detecting the plurality of deformable laundry articles 7300a-n by one or more robots 2000-8000 in the process line 100. As previously described, the data 610, 610a-n is stored in the at least one memory 6010, 7010, 210, 235, 236, 237 240, 250 in cross-referenced relation to articles 7300 belonging to a user account 600. Additionally, if a laundry article 7300 is newly introduced to the system 500, for the user account 600, the at least one controller 6005, 7005, 205 will create a novel, date-stamped entry comprising the data 610, 610a-n. In implementations, storing the image data 610, 610a-n, including a contemporaneous date of detection, comprises at least one of: creating a novel storage entry for the image data 610, 610a-n and the contemporaneous date for the laundry article not previously detected by at least one of the one or more sensors 7160, 7160a-n, 7709, 7709a-n, 7952, 7952a-n, and associating the stored image data 610, 610a-n and associated date with previously stored image data of a recognized one of the plurality of the laundry articles. In implementations, the previously stored image data is at least one of detected by the at least one sensor 7160,7160a-n, 7709, 7709a-n, 7952, 7952a-n, output by the at least one controller 6005, 7005, 205, and provided by the user 208, and stored in the at least one memory (e.g., memory 6010, memory 7010, memory 210, database 235, data lake 236, data warehouse 237, server 240, server farm 250).

In implementations, the at least one controller 6005, 7005, 205 is configured to retrieve optionally provided user preference data associated with the user account 600 and stored in the at least one memory 6010, 7010, 210, 235, 236, 237 240, 250. As previously described, the user preference data comprises at least one of one or more folding preferences associated with one or more of the plurality of laundry articles 7300, 7300a-n for supplanting or modifying a default folding routine determined based on one or more sensor signal inputs. Additionally or alternatively, in implementations, user preference data comprises stored user input regarding a final folded article appearance previously qualified as “acceptable” by the user 208. The user 208 can interact with at least one of a website and application based graphical user interface 300 displaying an image of a folded article 7300 and requesting the user 208 deem (as depicted in S1112 of FIG. 23) the article as acceptably folded or as requiring reprocessing by the at least one spreading device 7705 and the at least one folding device 7000a-b. The user 208 can provide such input for example by touching, clicking, speaking, and otherwise entering a proactive response on the graphical user interface (GUI) 300 (e.g., toggling a button, selecting from a drop down menu, speaking a selection, typing a response, and selecting a radio button or clicking on a particular field).

Additionally or alternatively, in implementations, user-defined preference data comprises data representative of a cluster (e.g., also herein referred to as a “drawer”) of laundry articles comprising one or more of the plurality of laundry articles 7300a-n. Taking user account 600a as an example, a cluster is represented by a subset of the data 610aa(1-n) associated with a profile 605al and can be indicative of a group of laundry articles to be clustered together for packing, the group of laundry articles comprising a portion of the plurality of laundry articles 7300a-n associated with an account 600. Grouping laundry articles in a packing container for return to a household (e.g., location associated with an account 600) enables a user 208 to unload groups of articles conveniently in a batch to be placed together on a shelf or in a drawer, for example. A user 208 can define one or more clusters of image data 610 associated with the user account 600. For example, a user 208 can elect to cluster all purple sweaters in a group, to require all components of particular outfits be grouped together for wearing each day of the week, and to cluster all work out wear together. A cluster, therefore, enables customized organization (e.g., grouping) defined by the user 208. The at least one memory is configured to receive and store user preference data comprising the at least one of one or more folding preferences and the cluster identification optionally inputted at a remote terminal of an owner of the user account, as will be described subsequently with regard to at least the interactive graphical user interface screens of FIGS. 16A-21C and FIGS. 22-23. Additionally or alternatively, in implementations, the system 500 comprises default grouping, e.g., grouping based on at least one of article type and wearer (e.g., profile 605), for example putting socks, shirts, underwear together for all profiles in the account or by individual profile associated with an account 600. In implementations, folding and packing routines associated with user preference data supplant default folding and routines and schema.

The at least one controller 6005, 7005, 205 is configured to instruct the one or more drives of one of the one or more autonomous folding devices 7000a-b, 7505a-b to operate to fold the laundry article 7300 based on at least one of the retrieved default executable instructions and the instructions incorporating retrieved or contemporaneously received user preference data. As described previously, in implementations, the at least one controller 6005, 7005, 205 is configured to update the machine learning model based on the optionally provided user preference data. For example, the machine learning model can iteratively improve at least one of the quality and completion success rate of folding pants based on one or more users providing input regarding successful, acceptable folding of a plurality of pants. For example, if one or more users indicates that a folded article having a top surface slope of 30 degrees is acceptable, the folding robot 7505 can learn to subsequently accept such a fold condition. For example, if one or more users indicate that a button down shirt folded with the collar on the inside of the fold is acceptable, the folding robot 7505 can learn to subsequently accept such a fold condition. The machine learning model therefore can be fed images of a plurality of acceptably folded laundry articles in a plurality of states to learn to detect other articles in similarly acceptable folded states and to detect articles that do not conform to the acceptably folded states.

In implementations, the autonomous laundry system 500 further comprises an autonomous queuing device configured to retrieve the folded laundry article 7300 from the at least one folding device (e.g., from a gantried conveyor 7960 at an unloading station 7950) and deliver the folded laundry article 7300 to an ordered location in a packing queue 8000 for packing in a shipping container for return to a household. The autonomous queuing device can comprise any of the implementations described in U.S. Patent Publication No. US 20220135351, “AUTONOMOUS DEVICES, SYSTEMS, AND METHODS FOR QUEUING FOLDED LAUNDRY,” herein incorporated by reference in its entirety.

In implementations, the at least one controller 6005, 7005, 8005, 205 is in operable communication with one or more drives of the autonomous queuing and packing device 8000, and the at least one controller 6005, 7005, 8005, 205 is further configured to instruct, based on at least one of the identified one or more characteristics and the optionally provided user preference data, the autonomous queuing and packing device 8000 to intelligently queue for the folded laundry article 7300 for ordered packing into a container. In implementations, the autonomous queuing device is configured to queue the folded laundry article at least one of adjacent to and atop one or more other folded laundry articles to be loaded together into the shipping container for aggregate unloading by a user 208 in a household retrieving the folded laundry to put away in home drawers, closets, and/or shelves. The one or more other folded laundry articles comprise the at least one of the identified one or more characteristics and the optionally provided user preference data associated with the folded laundry article for clustering or grouping the folded article and one or more other folded laundry articles together in a queue for packing (e.g., stacking on or adjacent one another for packing together in at least one of a default group and user-defined cluster).

In implementations, the folded laundry article 7300a and one or more other folded laundry articles 7300b-n are queued in one or more stacks in the queue awaiting packing into a shipping container. In implementations, the one or more stacks comprise one or more folded laundry articles of similar size. Additionally or alternatively, in implementations, the grouped folded laundry article and one more other folded laundry articles comprise one or more clusters associated with the identified profile 601, 610a-n. For example, the one or more identified characteristics can comprise a tee shirt article type belonging to a single profile of a child in the household. All of the tee-shirts belonging to this identified child's profile can be folded and queued together for loading into the shipping container in one or more aggregate stacks and/or rows. In implementations, a cluster associated with the identified profile 605 comprises user-defined cluster of data stored in the at least one memory in communication with the at least one controller 6005, 7005, 8005, 205. The at least one user-defined cluster of data represents a grouping of a subset of the plurality of laundry articles 7300a-n, such as all purple sweaters assigned to profile 1 being packed together. As described previously, in implementations, grouping data comprises at least one of default groupings comprising at least one of common articles type, sizes, and associated profile, and user-defined clusters defined by the user 208 of an account 600.

In implementations, the at least one cluster data comprises an image datum 610 of each laundry article 7300 of the grouping of a subset of the plurality of laundry articles 7300a-n, the image datum 610 being at least one of an image output by the one or more sensors 7160,7160a-n, 7709, 7709a-n, 7952, 7952a-n, a datum associated with a signal output by the one or more sensors and processed and assigned by the at least one controller 6005, 7005, 8005, 210, and a datum provided by the user 208 and stored in the at least one memory, for example in a relational database. The user 208 can be at least one of a wearer of the subset of laundry articles and a primary user of the user account 600 having access to manage data 610a-n associated with one or more profiles 605a-n of the user account 600 via a graphical user interface 300 in remote communication with the at least one controller 6005, 7005, 8005, 205. In implementations, the user-provided image comprises an image associated with a laundry article not previously detected by the one or more sensors 7160,7160a-n, 7709, 7709a-n, 7952, 7952a-n. Additionally or alternatively, the at least one controller 6005, 7005, 205 is further configured to replace in the at least one memory a user-provided image with an image output from the one or more sensors. Additionally or alternatively as described previously, in implementations, the at least one grouping of data comprises default characteristics comprising at least one of article folded size and article type. For example, the at least one controller can create a default cluster of “bedding” for large sheet and automatically assign the “bedding” cluster to laundry articles identified as such based on at least an identified size and identified article type.

Additionally or alternatively, a user 208 associated with a profile 605 can be at least one of a wearer of a subset of laundry articles and a primary user 208 of the user account 600 having access to manage data 610a-n associated with one or more profiles 605a-n of the user account 600 via a graphical user interface 300 in remote communication with the at least one controller 6005, 7005, 205. A primary user 208 of the user account 600 can be a parent, for example, who creates “drawers” of assigned laundry articles for clothing worn by one or more children. A user 208 can input commands on a remote device (e.g., at least one of a handheld smartphone or tablet 245, a smart watch 246, laptop or PC 247, and a voice assistant device 248, etc.) in wired or wireless communication with the at least one controller 6005, 7005, 205 over a wired or wireless network 230. Additionally, the remote device comprises two or more of a processor, a user input interface (e.g. a keyboard (including a digital keyboard), a microphone), and a display screen. In implementations, the remote device comprises two or more of a touch screen, keyboard (including digital keyboard), a network interface, a microphone, a camera, a display unit (e.g., a screen), a haptic module, and a sound output module.

As depicted in FIGS. 16A-18, for example, the remote device is a handheld smartphone 245 configured to operate at least one of an interactive application and a URL web-based interface for displaying one or more images 306, 306a-n of each of the plurality of laundry articles 7300a-n. In implementations, the one or more images 306, 306a-n are associated with the image data 610, 610a stored in memory. The displayed one or more images 306, 306a-n are presented in a selectable format for a user 208 to select one or more images 306, 306a-n to form one or more user-defined groupings. As previously described, the one or more groupings can comprise one or more user preferences for grouping one or more subsets of a plurality of articles 7300a-n. Additionally or alternatively, as shown in the example of FIG. 16D, the system 500 can group subsets of a plurality of articles 7300a-n by default by associating each image 306, 306a-n with one or more characteristics. In FIG. 16D, the default groupings 615a-c associated with a user account 600 (e.g., an account comprising a “Family closet” 611 comprising a plurality of laundry articles 7300a-n) are associated with article types, e.g., sweater grouping 615a, shirt grouping 615b, and pant grouping 615c.

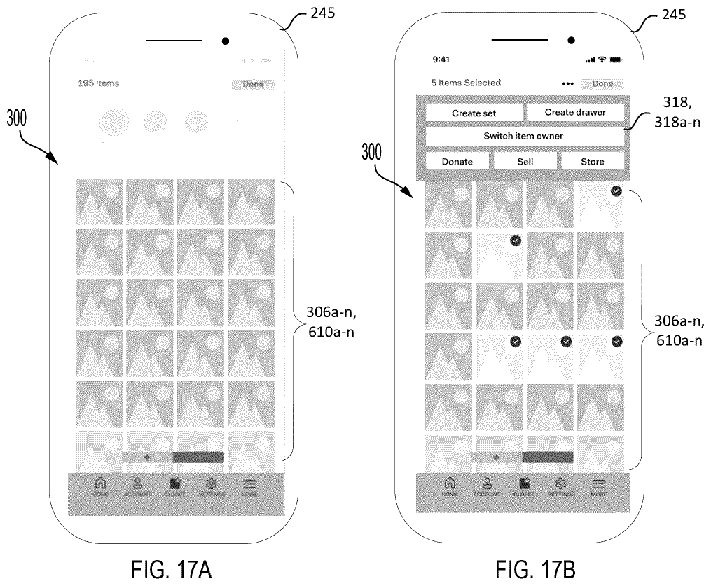

As depicted in FIGS. 16A-E for example, a user account 600 comprises one or more profiles 605a-c associated with a selectable profile icon 307a-c. Each profile icon 307a-c is associated with a name of a unique wearer of a portion of the plurality of the laundry articles of the user account 600 (e.g., depicted as a “Family” closet 611a-n of a plurality of laundry articles 7300a-n). A user 208 of the remote device 245 can select one or more profile icons 605a-c to view a plurality of selectable images 306b or other selectable fields visually identifying each one of a plurality of laundry articles associated with the selected profile icon. In implementations, the selectable format comprises at least one of a selectable radio button, a check box, a drop down selection, a drag and drop selection, a hamburger menu, a text prompt, and a selectable action button actively selected by a user input comprising at least one of a touch screen tap, a mouse click, a stylus tap, a voice command, and a keyboard entry. A user 208 can individually select a filed and batch select one or more fields representing a respective one or more laundry articles 7300 for at least one of categorizing (e.g., grouping or “clustering”) the one or more laundry articles for packing together and taking action on one or more laundry articles 7300 as will be described with regard to FIGS. 17A-B. In implementations, as depicted in FIGS. 16D-E, the graphical user interface (GUI) 300 comprises one or more selectable fields configured to add a profile to the user account. For example, a user can tap a plus sign icon 316 to open a fillable entry field 317 for adding a named profile to the at least one memory in communication with the at least one controller 6005, 7005, 205. The user 208 can select one or more of the selectable fields comprising a laundry article image 306, 306a-n for associating one or more articles 7300 with the newly added profile 605 represented by a profile icon 307a-n.

Additionally or alternatively, in implementations, the at least one controller 6005, 7005, 205 is configured to automatically assign a laundry article 7300 to a stored profile 605 of a plurality of profiles 605a-n associated with an account 600 if an article newly detected by at least one sensor 7160a-n, 7709a-n, 7952a-n has not been previously detected and associated with a profile 605. The at least one controller 6005, 7005, 205 can assign the detected laundry article 7300 based on matching the one or more determined characteristics with one or more stored characteristics of image data 610, 610a-n associated with a profile 605. Additionally, in implementations, below a certain threshold of likelihood that at least one controller 6005, 7005, 205 correctly identified a profile 605 associated with the laundry article, the at least one controller 6005, 7005, 205 is configured to provide at least one of a real time and post processing prompt to a user 208 at the remote device user interface 3000 requesting the user 208 review one or more images of the article 7300 detected by the at least one sensor 7160a-n, 7709a-n, 7952a-n and provide an input that assigns the article 7300 to a profile 605, 605a-n. In examples, the one or more images comprises at least one of an image 306 of the article 7300 spread flat and hanging by one or more lifter arms 6110 at the spreading robot 6000, 7705, an image of the article 7300 spread flat on the platter 7100, and an image of the article 7300 at least partially folded by the folding robot 7000 in one of the plurality of folding bays 7505, 7505a-b or at the unloading elevator 7900 or discharge station 7950. User input on the GUI 300 responsive to the request to review an image 306 assigns the detected laundry article 7300 to a profile 605 in memory and, optionally, assigned the laundry article to a packing cluster (e.g., a user-defined grouping or “drawer”). This input teaches a machine learning model of the at least one processor 6005, 7005, 205 to correctly assign the article to a profile in subsequent processing cycles, when the laundry article is seen one or more additional times by the system 500.

In implementations, the at least one controller 6005, 7005, 205 is configured to provide the user 208 with a display on the GUI 300 of one or both of folded and unfolded images of the article 7300. In implementations, the at least one controller is configured to send an unfolded image from at least one of a spreading station 7705 and the one or more folding devices 7000a-b (e.g., one or more folding bays 7505, 7505a-b) and to send a folded image from at least one of the one or more folding devices 7000a-b and the unloading station 7950 (based on output of the one or more sensors 7952a-n). Unfolded article images can be particularly useful if the article is one of a small (e.g., a children's tee shirt) or medium sized article 7300. Folded article images 306, 306a-n can be particularly useful if the article is large (e.g., a pair of XL pants, a king sized sheet, etc.) and more easily discerned in a folded state. In implementations, the at least one controller 6005, 7005, 205 is configured to store both a folded and unfolded article image 306, 306a-n and image data 610 of an article 7300 and provide at the user interface 300 a selectable option to display either or both of an image of the unfolded article 7300 hanging above or laid flat on the platter 7100 or an image of the folded article. In implementations, the at least one controller 6005, 7005, 205 is configured to employ a background subtraction routine to extract a portion of an image detected by the at least one sensor 7160a-n, 7709a-n, 7952a-n that is attributable to only the folded article 7300 and not background environment. The at least one controller 6005, 7005, 205 can then display an image 306, 306a-n of the extracted article 7300 only and not the extraneous surround environment beneath and or adjacent the article hanging above or disposed on a platter 7100.

In implementations, the at least one sensor 7160a-n, 7952a-b is disposed at least one of adjacent to or above at least one of the one or more platters 7100, 7100a-n disposed in at least one of the plurality of folding bays 7505a-n and the discharge station 7950, and the at least one controller 6005, 7005, 8005, 205 is further configured to determine the laundry article is folded and ready for packing. In implementations, the at least one controller 6005, 7005, 8005, 205 is configured to determine the laundry article 7300 is folded and ready for packing based on at least one of: receiving a signal indicative of a user input on or at least one remote device 245, 246, 247, 248 in communication with the at least one controller 6005, 7005, 8005, 205, and processing the received output signal of the one or more sensors with the machine learning model configured to classify an article 7300 as folded. As described previously with regard to implementations, the user input comprises at least one of a touch screen tap, a mouse click, a stylus tap, a voice command, and a keyboard entry responsive to at least one of a visual, haptic, and audible prompt on a remote device in communication with the at least one controller 6005, 7005, 8005, 205.

In implementations, the at least one controller 6005, 7005, 8005, 205 is further configured to train the machine learning model with the user input for more efficient recognition of articles that link in a memory store (e.g., a database) to the user's preferred folding conditions (e.g., adequately folded for aesthetics, folded to one of a set of preferred sizes for orderly packing in a shipping container, folded in a particular user-preferred configuration such as a face up or face down collared shirt fold, a face up or face down graphic tee shirt, pants folding in thirds, pants folded with the zipper on the inside of the fold, etc.). In implementations, the at least one controller 6005, 7005, 8005, 205 of the system is configured to instruct one or more of the robots 6000, 7000, 8000 to execute complementary routines to achieve a user-defined folding preference. For example, in one implementation, a user-defined preference for folding a graphic tee shirt with the graphic pattern on the front of the tee shirt facing outward and upward in a final folded state requires instructing the spreading robot 6000, 7705 to spread the tee shirt and lay it face down on a platter 7100 delivered to a folding bay 7505, 7505a-b for folding in a particular sequence to achieve the final preferred folded configuration.

As described previously with regard to implementations, the machine learning model of the at least one controller 6005, 7005, 8005, 205 comprises a classification and object detection model. In implementations, the machine learning model comprises at least one of a decision tree, random forest, k-nearest neighborhood, Bayesian network, support vector machine, and neural network. In implementations, the machine learning model comprises a neural network and the sensor output is processed with a neural network classifier. In implementations, the machine learning models rely on trained datasets tagged and stored in the at least one memory comprising at least one of a local memory 6010, 7010, 8010, 210, a database 235, a server 240, a server farm 250, a data lake 236, and a data warehouse 237.

Additionally, as previously described, the machine learning model is trained on images of the plurality of laundry articles 7300a-n associated with the plurality of user accounts 600a-n. In implementations, the at least one memory 6010, 7010, 8010, 210, 240, 250 in communication with the at least one controller 6005, 7005, 8005, 205 is configured to store user defined folding preferences associated with a laundry article 7300 and input via a remote computing device 245, 426, 247, 248 in communication with the at least one controller 6005, 7005, 205. The at least one controller 6005, 7005, 205 is further configured to instruct the two or more folding drives (e.g. sweep drives 7430, 7535, 7440, clamp drives 7230, 7235, 7240, blade drives 7630, 7635, 7640, table drive 7552) of the one of the plurality of folding bays 7505a-n (e.g., plurality of folding robots 7000a-n) to fold a laundry article 7300 according to user-defined folding preferences.

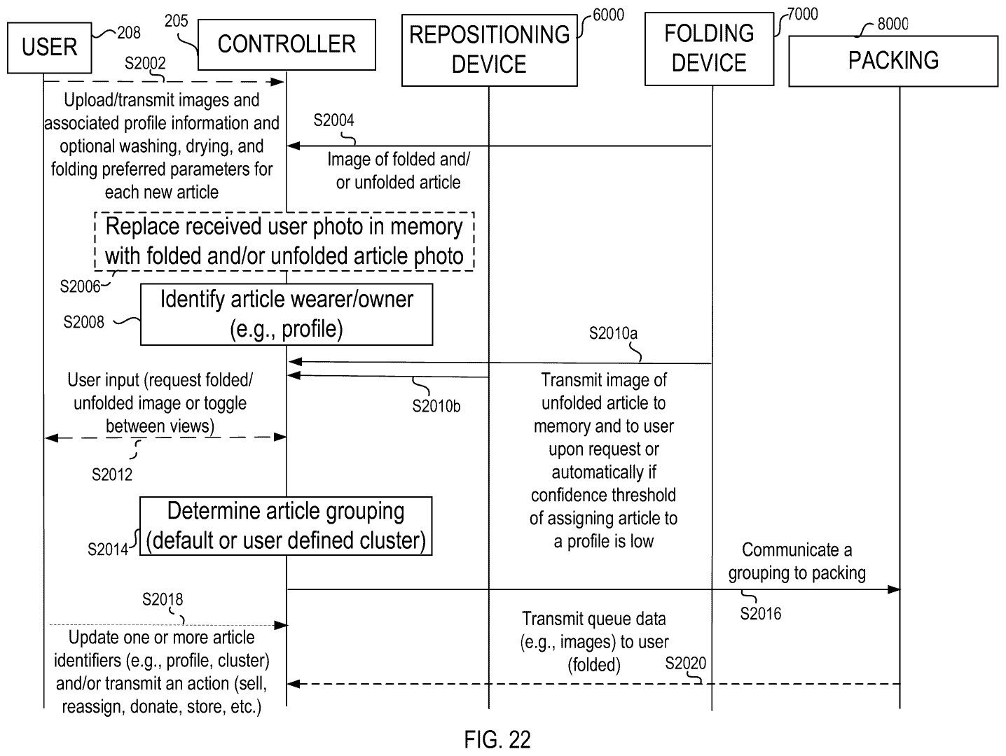

Turning now to the method 1100 of FIG. 23 (taken together with the communication schematic of FIG. 22 depicting user inputs and data communications between devices (e.g., controllers) of the system 500), the at least one controller 7005, 8005, 205 is configured to determine automatically and/or with input from a user 208 whether a laundry article is folded and ready for packing either in a default grouping or a user-defined cluster. In implementations, the method 1100 comprises receiving S1102 an output (e.g., image data) from the at least one sensor 7160, 7160a-n, 7952, 7952a-n, and determining based on the received at least one sensor signal whether the article is folded within parameters or whether a fold has been attempted X number of times, where X can comprise any value with in a range of 1-10 attempts to achieve folded parameters. In implementations, X comprises a value in a range of 2-5 attempts. In implementations, the number of attempts can be a set value, e.g., 3 attempts. Additionally or alternatively, the number of attempts can increase if the added attempt or attempts does not gate another process step or extend the overall processing time more than 5 minutes. In implementations, determining an article is within folded parameters comprises at least one of: detecting the folded article is not more than 10% outside a bounded area of one of a plurality of predetermined area dimensions, detecting a lean of a top surface of the garment is not greater than a slope of 30 degrees relative to a horizontal plane, detecting a top surface high point (wrinkle) measuring a distance from the top surface of no greater than 10 percent of the overall height of the garment, detecting less than 10 perfect of the top surface being wrinkled, and detecting user one or more preferences being achieved (e.g., tee shirt folded with graphic showing outward and upward). If the article is not folded within parameters or the number of attempts has exceeded X number of attempts, the at least one controller 205, 7005 instructs one or more drives to return S1106 the article 7300 to the spreading robot 6000, 7005 for being respread and refolded by the folding robot 7000, 7505a-b. Once the article is folded within parameters or folding is attempted X number of times, the at least one controller 7005, 205 determines S1108 whether the article is ready for packing.

If the at least one controller 7005, 205 determines S1108 the article is not folded within parameters for packing in a shipping container, the at least one controller 7005, 205 is configured to at least one of: instruct one or more drives of the folding robot 7000, 7505a-b to return the laundry article to the spreading station 7705, 6000 for retrying the processes of spreading and folding, and send S1110 an image 306 of the laundry article 7300 to a user account 600 accessible through a user interface 300 (comprising at least one of a web interface and a remote device application) for the user 208 to provide input regarding whether the laundry article is at least one of sufficiently folded or not and ready for packing. In implementations, a user 208 can determine an article is ready for packing despite being unfolded, folding in an aesthetically non uniform appearance, and/or partially folded. Additionally or alternatively, after one or more attempts to fold an article, the at least one controller 205, 7005 can send the article to the packing robot 8000. In implementations the at least one controller 205, 7005 will send the article to the packing robot 8000 regardless after folding is attempted X number of times, but if the article is not folded within parameters, in implementations, the at least one controller 205, 7005 will query a user 208 for subjective input regarding the acceptability of the fold. The query can be at least one of time delayed and real time for informing operation of one or more drives of the system. In implementations, the user 208 receives the query in response to accessing the application or website on the remote user device 245, 246, 247.

As described previously with regard to implementations, the at least one sensor 7160, 7160a-n, 7709, 7709a-n, 7952, 7952a-n comprises an image device disposed at least at one of the spreading station 7705, the one or more folding device 7000a-b, a discharge station 7950 adjacent the one or more folding devices from which a queuing and packing device 8000 retrieves each folded laundry article, and a queue location at the packing device 8000 at which a folded laundry article 7300 is delivered for packing into a container. The GUI 300 is configured to display an image 306 of each laundry article of the plurality of laundry articles 7300a-n. As previously described, the at least one controller 6005, 7005, 205 is further configured to determine whether to provide an image 306 of the laundry article 7300 displayed at the user interface 300 in a folded state or an unfolded state. In implementations, the folded state is chosen based on a determined size of the laundry article 7300. For example, an image of a small or medium size laundry article can be displayed in an unfolded state for clarity and an image of a large laundry article can be displayed in a folded state. Additionally or alternatively, a user 208 optionally can request to view either or both of a folded and unfolded image of an article 7300.

Returning to the method 1100, the at least one controller 6005, 7005, 205 upon receiving a user input at a GUI 300, determines S1112 whether the fold is acceptable to the remote user 208. Additionally or alternatively, in implementations, if a user 208 is not responsive to the query in real time a local facility operator 209 of the system 500 can respond to the query to keep the processes in the autonomous system 500 moving. If the fold is unacceptable and the folded article is not deemed “done” by the user 208 (or a local facility operator 209), the at least one controller 7005, 8005, 205 is configured to instruct S1116 one or more drives of the system 500 to return the laundry article to the spreading station 7705 (e.g., repositioning robot 6000). If the fold is acceptable and the folded article is deemed folded by the user 208, the at least one controller 6005, 7005, 205 is configured to update S1114 the machine learning model based on the received input. In implementations, the machine learning model is a globally applied model shared among a plurality of user accounts 600a-n and data output from the one or more sensors can be stored in aggregate, for example, in a data lake 236 and/or data warehouse 237. Additionally or alternatively, in implementations the machine learning model is applied to a unique user account 600a and a data store associated with the unique user account 600a.

Once a laundry article 7300 is determined to be folded, the at least one controller 6005, 7005, 205 is configured to determine S1118 at least one of a profile 605 associated with the laundry article 7300, a default grouping for packing, and a cluster (e.g., drawer) for packing. In implementations, as previously described, identifying an article 7300 as being associated with a datum 610 assigned to a profile 605 associated with a user account 600 requires being above a threshold likelihood of accuracy. In implementations, the threshold likelihood of accuracy is a confidence score of 50 percent or higher. As depicted at optional steps S2010a, S2010b in FIG. 22, the at least one controller 205 is configured to prompt a user 208 to identify a profile 605 associated with an image 306 of the laundry article 7300 output by the at least one sensor if the controller's determination of the profile 605 is below a threshold likelihood of accuracy and two or more profiles 605, 605a-n are associated with a user account 600. Additionally or alternatively, the at least one controller 7005, 8005, 205 can prompt the user 208 to identify the profile 605 upon the user 208 voluntarily accessing the GUI 300. The prompt need not be in real time. Additionally or alternatively, the user 208 can proactively detect an incorrect profile assignment and actively correct the profile assigned for an article.

Additionally or alternatively, in implementations, at least one controller 6005, 7005, 205 is configured to determine at least one of a profile 605 associated with the laundry article 7300, a default grouping for packing, and a user-defined packing cluster (e.g., drawer) prior to the article reaching the folding robot 7000, 7505a-b. For example, the at least one controller can determine at least one of a profile 605 associated with the laundry article 7300, a default grouping for packing items together, and a user-defined cluster (e.g., drawer) for packing items together, at a separating robot 5000 and a spreading station 6000, 7705. The method comprises outputting S1130 at least one of an identified article profile 605 and cluster 615 to a controller 8005 of the queuing and packing robot 8000 for ordered and intelligently batched packing of a plurality of folded laundry articles 7300a-n.

In implementations, as will be described subsequently with regard to interactive user interface screens, optionally updating S1120 an article status can comprise at least one of sending S1122 an image and optionally a notification prompt to the remote user 208 (and/or a local facility operator 209, FIG. 3), and making an image accessible to the user 208 (and/or operator 209) through a device application or website page. Additionally, updating S1120 comprises prompting S1124 a user 208 associated with the identified profile 605 (or a primary account user with access to and administrative rights over all account profiles 605a-n associated with an account 600) to take action based on at least one of an article status and article profile. The at least one controller 6005, 7005, 205 is configured to receive S1126 the optional input and update S1128 in at least one memory a datum 610 associated with the profile 605 based on the received input. The at least one controller optionally can receive an instructional input from the user 208 updating S1120 an article status based on at least one of reassigning an article, selling, donating, merging, pairing, separating, and storing an article.

The method 1100 describes implementations of interactions between various robots and controllers of the system, with and without user input. The schematic of FIG. 22 depicts an implementation of communications between various processors of the system 500 and between the system 500 and a user 208 during the identification of a profile associated with an article 7300 for determining whether the article 7300 belongs to a user-defined grouping for packing by the packing robot 8000. The schematic further comprises actions executed by the at least one controller of the system 500.

As shown at communication step S2002, a user 208 can upload through at least one of a website and an application running on a remote device 245, 246, 247 one or more images of a new article 7300 not previously provided to the system 500 for processing. In implementations, the user device 245, 246, 247 comprises a camera, for example a smartphone camera, and the user can access the image from a memory on the device for directly uploading the image to the at least one controller 205 through a website or a user application running on the device. In implementations, the user application comprises a program stored in a memory of the device and enables the user to communicate directly with and receive communications from the at least one controller 205, 6005, 7005. The user 208 can transmit the one or more images along with associated data 610, 610a-n comprising at least one of profile information, one or more preferred washing parameters (e.g., temperature, agitation level, extra rinse, etc.), one or more preferred drying parameters (e.g., drying temp, damp dry, fully dry, etc.), one or more folding parameters (e.g., style of fold, direction of fold, etc.), and one or more packing parameters (e.g., placement position in a container (e.g., top or bottom), packing with a cluster, packing as a set, etc.). The at least one controller 205 is configured to store the uploaded one or more images in a memory 210, 6010, 7010, 8010, 235, 236, 237, 240, 250 in relation to at least the user account 600. The at least one controller 205 is configured to, at communication step S2004, receive one or more photographs of the article 7300 from at least one of the repositioning device 6000 and the folding device 7000 in one or more of a spread state and at least partially folded state.

As previously described with regard to implementations, at optional step S2006 the at least one controller 205 is configured to replace the uploaded one or more images with the one or more images received from one or more of the repositioning device 6000 and the folding device 7000 such that the one or more articles appear in the stored images as they will upon subsequent processing by the system 500. Additionally, the at least one controller 210, 6010, 7010 is configured to replace the stored images 306 with images processed with a background subtraction routine so that the stored images contain only the articles and not background environment. This assists the machine learning model with identifying articles and produces clear, easily discerned images 306, 306a-n for presentation to a remote user 208 viewing the images 306, 306a-n on a display of a user device interface 300 as will be described subsequently with regard to implementations.

In implementations, the at least one controller 205 is configured to identify a profile 605 associated with an article by comparing one or more uploaded images to an article 7300 in process. Additionally or alternatively, the at least one controller 205 processes at least one sensor signal output by the at least one sensor 7160, 7160a-n, 7709, 7709a-n, 7952, 7952a-n of the system 500 and applies the images to one or more machine learning models to identify S2008 a profile 605 associated with the article 7300. In implementations, as will be described subsequently with regard to FIG. 17B, a user 208 optionally can review one or more images associated with a profile 605 and reassign one or more images to another profile of a plurality of profiles 605a-n associated with an account 600. As shown in FIG. 22, a user 208 optionally can request to review an image of an article 7300 in a folded or unfolded state and toggle between images and provide input S2012. The folded and unfolded images can be transmitted S2010a-n to the at least one controller 205 at least one of upon request and by default from one or more robots comprising at least the folding robot 7000, 7505a-b and the spreading robot 6000, 7705. Additionally, as depicted in FIG. 22, the at least one controller 205 is configured to determine S2014 an article grouping. In implementations, the at least one controller 205 is configured to access a relational database in a memory 210, 235, 236, 237, 240, 250 to determine whether an article 7300 is assigned to one or more clusters for packing in a user-defined group at the packing robot 8000. Additionally or alternatively, the at least one controller 205 is configured to determine at least one of a packing order and grouping for an article based on a default grouping based on at least one of folded article size, article type, and profile.

At any point during and after processing of a plurality of laundry articles 7300a-n by the system 500, a user 208 optionally can update S2018 for one or more articles at least one of an associated profile and a cluster. As will be described subsequently with regard to implementations of an interactive user interface 300, in implementations, the user 208 can instruct the at least one controller 205, 6005, 7005, 8005 to take an action (e.g., sell, reassign, donate, store, merge, separate, consign, etc.). Additionally, in implementations, the packing robot controller 8005 is configured to transmit S2020 images of folded articles in a packing queue to a user 208 upon request or to a memory 210, 6010, 7010, 8010, 235, 240, 250 for accessing at any time.

Although the at least one controller 205 referenced with regard to the implementation of FIG. 22 is a facility terminal, any of the controllers (2005, 3005, 4005, 5005, 6005, 7005, 8005) of the system 500 taken alone or in combination can provide the functionality described herein.

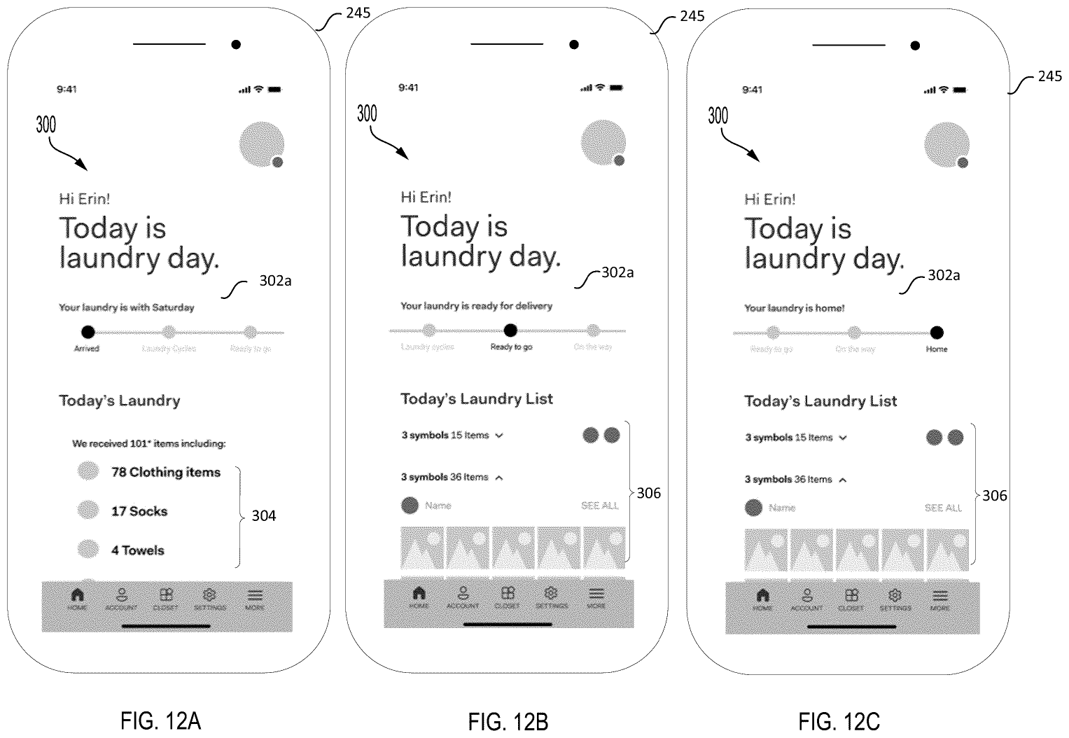

Turning now to a graphical user interface 300 of a remote user device 245, 246, 247, 205, in implementations, as depicted in FIGS. 12A to 21C, the at least one controller 6005, 7005, 205 is configured to push status information and notifications to a user interface 300 of a remote communication device. Additionally, in implementations, the at least one controller 6005, 7005, 205 is configured to receive instructions from the user 208 through the remote communication device for instructing the operation of one or more drives of the system 500 with regard to folding, packing, donating, selling, assigning and recharacterizing one or more articles 7300 as will be described subsequently with regard to implementations.

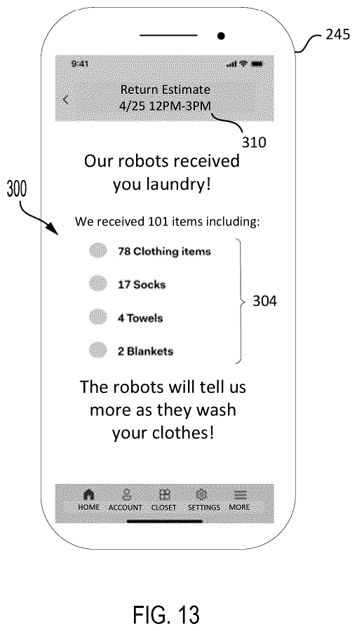

For example, as depicted in FIG. 12A and FIG. 13, the at least one controller 6005, 7005, 205 is configured to send to a GUI 300 (e.g., a user display) on a remote device 245 information comprising itemized intake details 304 of a plurality of received laundry articles 7300a-n associated with a user account 600. The display comprises one or more text based and graphic indicators comprising at least one of a laundry processing status indicator 302a (e.g., arrived, in process, ready to go, home), intake details 304 comprising a roster of articles (e.g., “items”) received comprising quantity and article type, and an optional return estimate indication 310 of an estimated return delivery time and date for the plurality of laundry articles 7300a-n received by the system 500. The at least one controller 205 can calculate a return estimate based on at least one of a volume of laundry received for the user account, a percentage of available robots for processing the received laundry, and process status of one or more robots processing the laundry received for the user account. In implementations, a user 208 can at least one of customize the display of information on the GUI 300 and optionally expand menus to display more information about various articles, clusters of articles, profiles, and progress cycles. Additionally or alternatively, in implementations, a user 208 can toggle between displays of information on the GUI 300 by navigating a bottom bar menu, a hamburger menu, or selecting other toggle icons provided on the GUI 300.

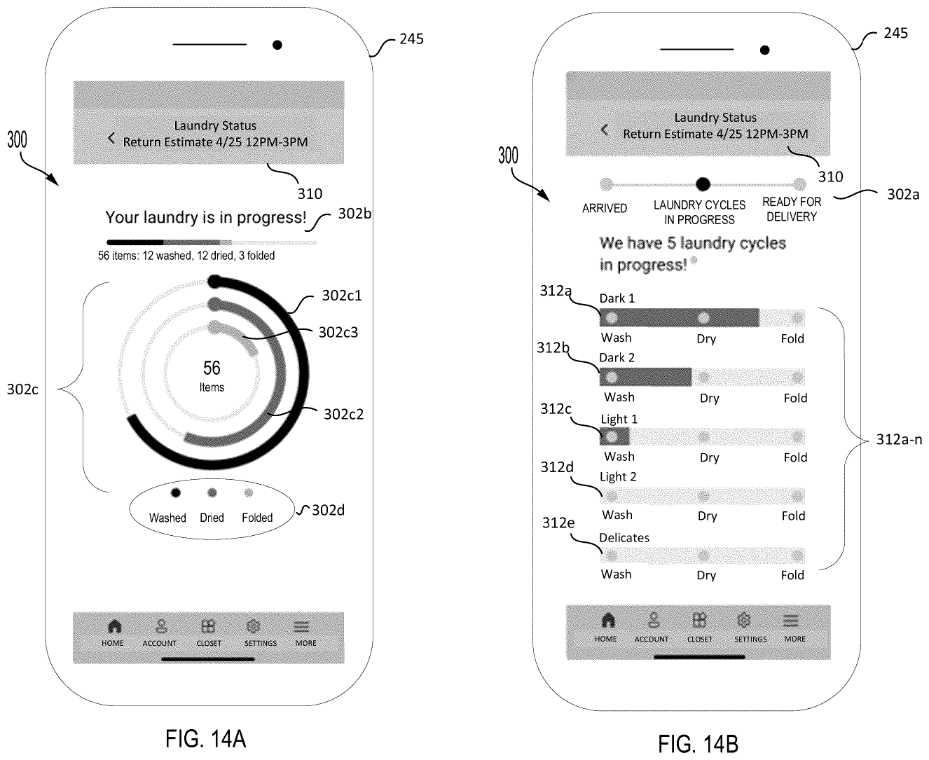

As depicted in FIGS. 12B and 14A-B, in implementations, the at least one controller 6005, 7005, 205 is configured to send to a user display 300 on a remote device 245 information comprising progress details indicative of laundry processing status. The progress details can be displayed in one or more formats comprising at least one of a progress bar such as the laundry progress status indicator bar 302b (e.g., arrived, in process, washed, dried, folded, ready to go, delivered to home) and another at-a-glance informative progress icon 302a. For example, as depicted in the example user interface display screen 300 of FIG. 14A, a progress icon 302c comprises three concentric annuli 302c1-c3 indicative of progress through the system 500 of portions of the received plurality of laundry articles 7300a-n. Each annulus 302c1-c3 represents a major process step, e.g., washing 302c1, drying 302c2, and folding 302c3, and each annulus comprises at least one of a colored and patterned portion indicating the percentage to completion in degrees of each annulus colored. A fully filled annulus (e.g., filled with colored and/or patterned shading) indicates completion of that portion of the autonomous laundry process. In implementations, the annuli are circular rings. In other implementations, the display can comprise concentric loops tracing another shape other than circular rings. In implementations, the concentric loops can comprise concentric ovals, triangles, squares, rectangles, hexagons, octagons, etc. In implementations a number of straight sides of each closed loop equals the number of separated loads of a user's plurality of laundry articles being processed by the system and each side can fill independently to represent a status of each load so that the display presents independent real-time process status (e.g., tracking progress toward process step completion) of each load.

In the example, laundry progress status indicator bar 302b and associated text indicates 56 articles (e.g., “items”) were received, 12 laundry articles 7300 are more than halfway through completion of a wash cycle, 12 laundry articles 7300 are more than halfway through completion of a drying cycle, and 3 items are partially through the folding cycle at the one or more folding devices 7000a-b (e.g., folding bays 7505a-b). Additionally, the progress icon 302c of concentric loops centered on the GUI visually displays an easily and quickly comprehended view of this same progress at each step of washing, drying, and folding. In implementations, the GUI 300 comprises a key 302d configured to identify each process step indicated by each loop 302c1-c3. The key 302d comprises at least one of matching colors and patterns to those of each loop and a text descriptor of each process step in the laundering cycle. The progress icon 302c of FIG. 14A provides concentric annuli for each of washing, drying, and folding in that order from the outside annulus to the inside annulus. Because all articles 7300a-n necessarily will be washed before they are dried and folded, the rings will close (e.g., fully fill) from the outside to the inside as the laundering process progresses to completion so that a user 208 can discern at any point in time at a glance how far their laundry has progressed through the system 500. Although the implementation of FIG. 14A displays washing, drying, and folding progress, additionally or alternatively, in implementations, other combinations of process steps can be displayed. For example, progress of sorting at the sorting robot 5000, spreading at the spreading station 6000, 7705 and packing at the packing robot 8000 can also be indicated in at least one of one or more visual icons and text based displays on the GUI 300. These may be represented, for example, with one or more additional concentric loops.

Because the at least one controller 6005, 7005, 205 is in operative communication with controllers and processors of each of the robots 2000-8000 in the system 500, the at least one controller can query each robot for a time-to-completion cycle status and provide real time data with regard to processing status of one or more robots for display on the GUI 300. The at least one controller 2005, 3005, 4005, 5005, 6005, 7005, 8005, 205 is configured to track the plurality of laundry articles 7300a-n of each household (e.g., user account 600) through each process step of the system 500, for example the separating and sorting, washing, drying, clean laundry separating, spreading, folding, discharge, and packing processes. In implementations, a user 208 can send a request through a user application running on a GUI 300 of a handheld device or through a website for a status update. In implementations, the user application comprises a program stored in a memory of the device and enables the user to communicate directly with and receive communications from the at least one controller 205, 6005, 7005. As described previously, the request can comprise at least one of a touch, tap, click, typing, and spoken request for a device having a microphone. The at least one controller 2005, 3005, 4005, 5005, 6005, 7005, 8005, 205 can then update the progress icons 302a-c to display a real-time status.

For example, the at least one controller 2005, 3005, 4005, 5005, 6005, 7005, 8005, 205 is configured to track the percentage of the plurality of laundry articles 7300a-n separated at a separating and sorting robot 3000 and sent to one or more washing and drying robots 4000. The at least one controller 2005, 3005, 4005, 5005, 6005, 7005, 8005, 205 is configured to monitor process and cycle status of the washing and drying processes at each of the one or more washing and drying robots receiving the plurality of laundry articles 7300a-n associated with the user account 600 and provide this information via a communication network to the GUI 300 upon request. Additionally or alternatively, in implementations, when a user 208 accesses the GUI 300, the application is configured to refresh and deliver for display a contemporaneous status of the plurality of laundry articles 7300a-n being processed by the system 500. Because the autonomous robots 2000-8000 are in operative communication with the at least one controller 2005, 3005, 4005, 5005, 6005, 7005, 8005, 205, accurate, real-time percentages of completion are calculable for presentation in one or more formats on a display 300 to a remote user 208.

In implementations, the at least one controller 7005, 205 is configured to determine a folding status of a laundry article based on receiving an output signal of one or more sensors disposed above and adjacent the one or more folding devices of the system 500.

In implementations, the at least one controller 6005, 205 is configured to identify the one or more washing and drying devices receiving the plurality of laundry articles by tracking one or more uniquely identifiable (e.g., RFID tag, bar code label, etc.) laundry bins transported to the one or more washing and drying devices. Each one of the one or more laundry bins contains a load of laundry comprising one or more of the plurality of laundry articles. The one or more identified washing and drying devices are configured to communicate via the network processing updates including washing and drying cycle progress.

In implementations, the at least one controller 8005, 205 is further configured to autonomously track progress of the plurality of laundry articles through an autonomous packing process following the folding process and provide a real time packing status on the user display. In implementations, the packing robot 8000 comprises one or more sensors configured to detect the plurality of folded laundry articles processed by the autonomous packing device. In implementations, the one or more sensors are configured to output one or more signals to the at least one controller indicative of at least one of receiving in a packing queue and packing in a container one or more of the plurality of folded laundry articles.

Any number of real-time contemporaneous progress indicators 302 can be displayed to a user 208 on a display screen of a remote user device 245, 246, 247 and/or audibly spoken to a user 208 through a user device 245, 246, 247, 248 equipped with a speaker. As depicted in the example user interface display 300 on a screen of a remote device 245 of FIG. 14B, additional or alternatively as compared to the implementations of indicators 302b-c of FIG. 14A, the at least one controller 6005, 7005, 205 is configured to send additional detailed information to a user 208. The additional detailed information can be displayed based on the one or more characteristics of the plurality of received laundry articles 7300a-n detected by the one or more sensors of the at least one sensor 7160, 7160a-n, 7709, 7709a-n, 7952, 7952a-n of the system 500 as described previously with regard to implementations. In implementations, the detailed information, for example common one or more characteristics for a sorted wash load, can be displayed in a series of progress bars 312a-n, each progress bar 312 representing processing a single load of laundry constructed by a laundry separating robot 3000. In implementations, the one or more characteristics comprise a common color and article material of the articles 7300 in each sorted load of laundry. For example, a progress bar 312a for a first dark load, Dark1, indicates the load is through the wash and drying cycle, a progress bar 312b for a second dark colored load, Dark 2, indicates the load is through the washing cycle and heading for drying, a progress bar 312c for a first light colored load, Light 1, indicates the load is through the washing cycle, and a progress bar 312d for a second light colored load, Light 2 and a progress bar 312e for a delicates load, Delicates, indicate these loads are not yet at the washing process. The plurality of progress bars 312a-e provide readily discerned visual indicators of cycle progress to a user 208.

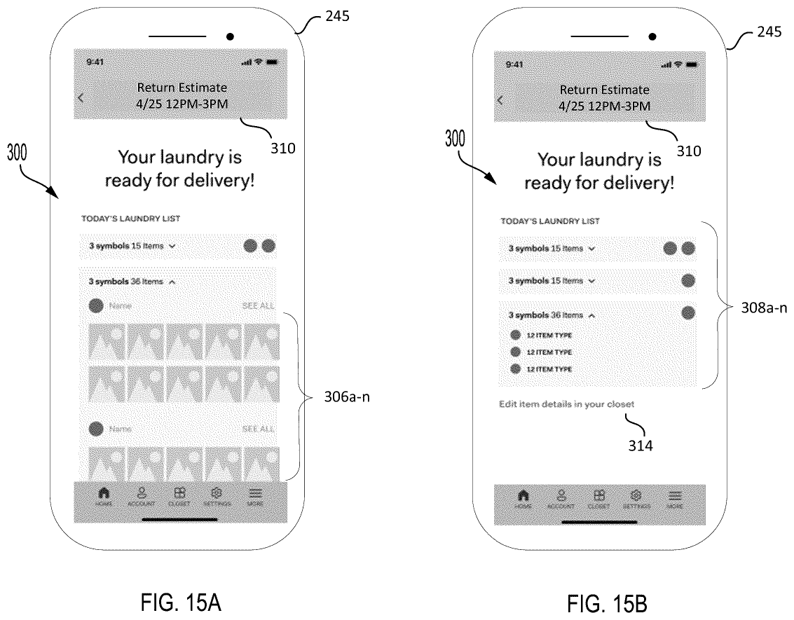

In implementations, as depicted in the example user interface display screens of FIG. 15A-B, the at least one controller 6005, 7005, 205 is configured to send visible cycle completion information to a user display 300 on a remote device 245, 246, 247 based on process completion through the system 500. At process completion, the plurality of laundry articles 7300a-n associated with the user account 600 and accounted for by the system 500 as having been delivered are folded, packed, and queued for return delivery to the residential address associated with the user account 600. The user display 300 can include a return estimate field 310 indicative of an expected date and time window for delivery. In implementations, the cycle completion information can include a display of laundry article images 306, 306a-n associated with each profile 605a-n of a user account 600. In implementations, such as that of FIG. 15B, a user 208 can set the display 300 to present the laundry items as text-based icons 308a-n without an image displayed. In implementations, a user 208 can select one or more individual laundry articles to be represented on the display 300 only as text-based icons 308, 308a-n while other laundry articles are displayed as laundry article images 306a-n. Such privacy settings can be individualized to all laundry items 7300a-n associated with a profile 605, 605a-n or images of particular, selected laundry items associated profile 605, 605a-n. For example, as a privacy preference, a user 208 may select all undergarments to be displayed only as text-based icons 308, 308a-n in an undergarments group and not as laundry article images 306, 306a-n.

As described previously with regard to implementations, the at least one controller 3005, 4005, 5005, 6005, 7005, 8005, 205 is configured to at least one of push an audible, visible, and/or haptic notification to remote device 245, 246, 247, 248 of a user 208. In implementations, the system 500 prompts a user 208 through the user interface 300 to review one or more images 306, 306a-n of each one of the plurality of household laundry articles 7300a-n. In implementations, the notifications can be pushed in real time during the separating and sorting, washing, drying, clean laundry separating, spreading, folding, discharge, and packing processes by the system 500. Additionally or alternatively, the notifications can be delivered to a remote user device 245, 246, 247, 248 upon completion of processing the received laundry articles, for example while the folded laundry articles are packed and being processed for return delivery. In implementations, the at least one laundry image 306, 306a-n is made available for access through a user application or browser interface 300 operational on a remote device 245, 246, 247. In implementations, the user application comprises a program stored in a memory of the device and enables the user to communicate directly with and receive communications from the at least one controller 205, 6005, 7005.

Additionally or alternatively, a user 208 can proactively access a display of images 306, 306a-n and/or text icons 308a-n representing each laundry article 7300, 7300a-n at any step in the process between intake and completion (e.g., a laundry article imaged at any of the plurality of robots 2000-8000) and proactively instruct at least one controller 3005, 4005, 5005, 6005, 7005, 8005, 205 of the system 500 to instruct a drive motor of a robot 2000-8000 take an action based on an instruction delivered from an interface. Additionally or alternatively, the at least one controller, upon receipt of a user instruction, is configured to provide at least one of a visual, audible, and haptic prompt to an operator 209 via a handheld device or a facility computer terminal to take an action based on the received instruction.

For example, as depicted in the user interface 300 of FIGS. 17A-B, a user 208 can batch select selectable fields comprising one or more laundry article images 306, 306a-n and take an action by selecting one of a plurality of interactive command fields (e.g., selectable screen icons or “button”). For example, as depicted in FIGS. 17B, 18, and 20 the user interface 300 is configured to, for each selected image 306 or batch of selected images 306a-n, provide a user with one or more interactive instruction fields 318, 318a, 318b for instructing the at least one controller 2005, 3005, 4005, 5005, 6005, 7005, 8005, 205 of the system 500 to take an action with regard to the one or more selected laundry articles 7300, 7300a-n associated with one or more selected images 306, 306a-n of household laundry articles. As depicted in the example of FIG. 17B, five images 306a-e are selected as indicated by a darked overlaid “check mark” in a circle within the selectable field comprising the images.

The interactive instruction fields 318, 318a-b can comprise at least one of selectable image icons 306, drop down, pop out, or other expandable menus 320-334, and radio buttons 318b selected by tapping a screen with a fingertip or stylus, clicking with a mouse pointer, or selecting by voice command, for example. In implementations, the action selected by the user 208 comprises at least one of donate, merge, pair (e.g., create a set), separate (e.g., assign an article to a unique entry because of mistaken identification), reassign to another profile (e.g., switch item wearer, for example, by handing down an article outgrown by an older child's profile to a younger child's profile), sell, recycle, and store (e.g., store seasonal articles, like winter sweaters, as a geographic location warms). In implementations, the at least one controller 6005, 7005, 8005, 205 is configured to provide a “store” notification prompt on the user interface 300 based on at least article type and location-based seasonal weather trends. For example, the controller 6005, 7005, 8005, 205 can prompt a user 208 to select an option to store a swimsuit on the first of October if the user lives in a colder northern climate, like that of New England, USA. Upon affirmation by the user 208, the at least one controller can then send the article to a seasonal storage box or bag for packing and return to the customer. Additionally or alternatively, a user 208 can instruct the at least one controller 6005, 7005, 8005, 205 proactively to take such an action without a user prompt.

In another example, the at least one controller 6005, 7005, 8005, 205 is configured to process a date stamped image datum 610 associated with a laundry article 7300 stored in the at least one memory 210, 6010, 7010, 8010, 235, 236, 237, 240, 250, and determine based on an age comparison that the laundry article 7300 is deteriorating and should be recycled. In implementations, the at least one memory is configured to store for a period of time a plurality of date tracked images of each laundry article received and processed by the system 500. In implementations, the period of time comprises at least one of a week, a month, a season (approximately 3 months), six months, a year, two years, three years, four years, and five years. Based on date-based comparison of two or more stored images, the at least one controller 6005, 7005, 8005, 205 can then push a recommendation notice to a user 208 on the interface 300 to consider taping or otherwise selecting a field requesting (e.g., sending an affirmative instruction) the system 500 send the article 7300 to a donation center rather than returning the article 7300 in the shipping container to the user's household. The at least one controller 6005, 7005, 8005, 205 is therefore configured to monitor usage trends and detect a change in article condition over time and provide recommendations to a user based on the monitored trends and detected condition. In implementations, the totality of laundry articles 7300 received by the system for a user account 600 comprises a closet 611, as will be described subsequently with regard to implementations.

In implementations, the at least one controller 6005, 7005, 8005, 205 is further configured to delete from the at least one memory (e.g., a relational database stored in a local memory 6010, 7010, 8010, 210 or a remote storage 235, 236, 237 240, 250) one or more stored images 306, 306a-n and associated image data 610, 610a-n of a laundry article 7300, 7300a-n associated with an account 600 in response to receiving an instruction from the user 208 to sell, donate, or recycle the selected laundry article. In implementations, the at least one controller 6005, 7005, 8005, 205 is further configured to push at least one of a visible, audible, and haptic prompt a remote user device 245, 246, 247 running the user interface 300 to confirm a suggested deletion of a database entry comprising at least one of one or more images 306, 306a-n and associated image data 610, 610a-n if the at least one sensor 7160, 7160a-n, 7709, 7709a-n, 7952, 7952a-n has not detected the laundry article 7300 in a threshold period of time. For example, depending on article type (e.g., a non-season-specific worn article) the threshold period of time can be a single season (e.g., approximately 3 months). In examples, the threshold period of time is a range of about 1 to three months. In examples, for an article of a type worn specifically in a particular season, the threshold period of time is greater than one season beyond one year from the last date of detection stored in the at least one memory for that article.

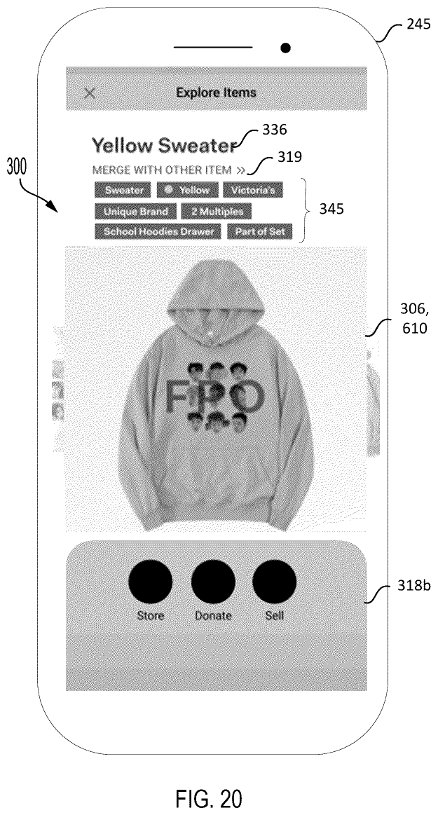

In implementations, the at least one controller 6005, 7005, 8005, 205 is configured to provide on the GUI 300 one or more interactive merge fields 319 for instructing the at least one controller to take an action merging an image 306 of a laundry article 7300 with a stored image of another laundry article associated with the user account 600 memory. For example, if the at least one sensor 7160, 7160a-n, 7709, 7709a-n, 7952, 7952a-n detects a yellow hoodie and determines that article is a yellow sweater belonging to Victoria's profile, as depicted in FIG. 20, the user 208 (e.g., Victoria and/or a primary account user who is not Victoria) can select a merge field 319 to merge the “yellow sweater” image 306 and associated image data 610 (e.g., date stamp) with images of the yellow hoodie previously stored in the at least one memory 6010, 7010, 8010, 210, 235, 240, 250 in relation to the user account 600. Merging an article with another stored entry in the at least one memory therefore addresses and corrects for the at least one controller not recognizing an article and determining that the article is new and not previously detected by the at least one sensor.

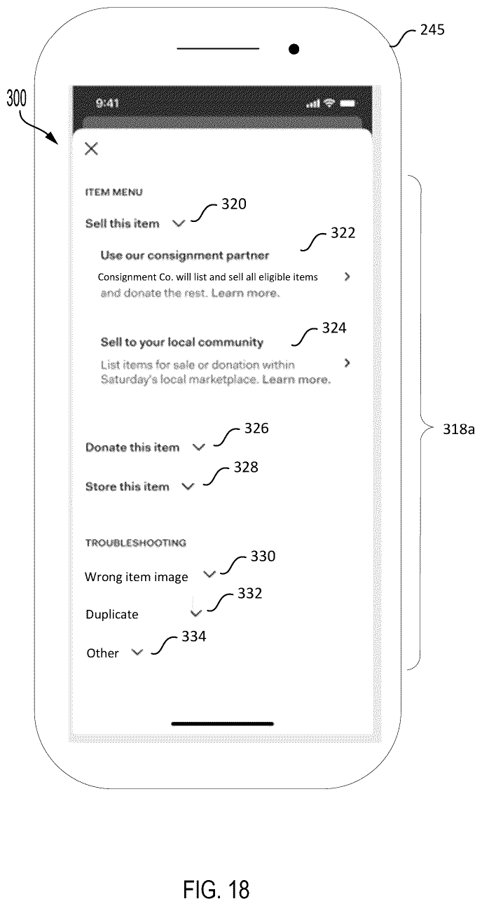

Additionally, in implementations, the at least one controller 6005, 7005, 8005, 205 can provide a selectable separation field 330 (FIG. 18), such as a radio button or dropdown menu, for separating an image 306 of a wrongly identified item from an association with another article stored in the at least one memory 6010, 7010, 8010, 210, 235, 240, 250. A user 208 can select one or more interactive fields (e.g., separation field 330) for instructing the at least one controller to take an action further comprising unassigning an image 306 of a laundry article 7300 from an identified laundry article 7300 associated with the user account 600 and stored in the at least one memory. For example, if the at least one controller identifies a grey shirt with a stripe as a grey shirt without a stripe that is stored in the at least one memory, the user 208 can reassign the grey shirt with a stripe to a correct entry or a new entry in the at least one memory. To avoid having to separate an item (e.g., a laundry article 7300), in implementations, upon the first time sending an article to the system 500 for processing, a user 208 can upload an image of a new laundry article into the user account 600 through the GUI 300 and optionally assign one or more characteristics, such as a profile 605 and article type. During subsequent laundry processing by the system 500, the at least one controller 6010, 7010, 8010, 210, 235, 240, 250 can optionally replace the user image with an image 306 of at least one of the folded article and unfolded article output from at least one sensor 7160, 7160a-n, 7709, 7709a-n, 7952, 7952a-n of one or more robots 2000-8000 of the system 500.

Additionally, in implementations, as depicted in FIGS. 16B-18 and 21A-C, the at least one controller 6010, 7010, 8010, 210, 235, 240, 250 can provide on the user interface 300 one or more displayed interactive fields 307a-n, 347-356, such as at least one of radio buttons, selectable text buttons, calendars, and dropdown menus for at least one of filtering and sorting a display of at least one of images 306a-n, text, and icons 308a-n representative of one or more laundry articles 7300, 7300a-n associated with a user account 600. For example, in implementations as shown in FIGS. 16A-D and 17A-B, a user 208 can filter images 306a-n of all laundry articles associated with a user account 600. As described previously, the totality of images 306a-n associated with a user account 600 comprises a closet 611. The user 208 can select a profile radio button 307 to sort the closet on a single wearer or owner of articles in the closet 611. As depicted in the GUI screen of FIG. 18, the user 208 can instruct the at least one controller to take an action on one or more selected articles by selecting a field such as one or more sell fields 320, 324, a consign field 322, a donate field 326. In implementations, the user 208 is the manager of the account. Additionally or alternatively, the user 208 comprises a person associated with one of a plurality of profiles 605a-n of the account 600. In addition to taking an action to remove an article from the closet 611 by selling, consigning, and donating, a user 208 can address incorrectly identified items using a wrong item image filed 330, a duplicate field 332 and an “other” field 334. Additionally, in implementations, as depicted in FIG. 17B, interactive fields 318a-n enable a user to reassign an article (e.g., switch item owner/profile), recycle an article, store an article, create a set with another article, create a drawer (e.g., cluster), etc. Additionally or alternatively, as shown in FIGS. 16C-D, user 208 can filter a display of laundry articles by person in a household (e.g., by profile 605), article type (e.g., socks), article cluster 615a-n (e.g., Monday clothes drawer for profile 1, athletic shirt drawer for profile 2, etc.), article color, recently washed/newest processed, frequently worn, least worn, etc.

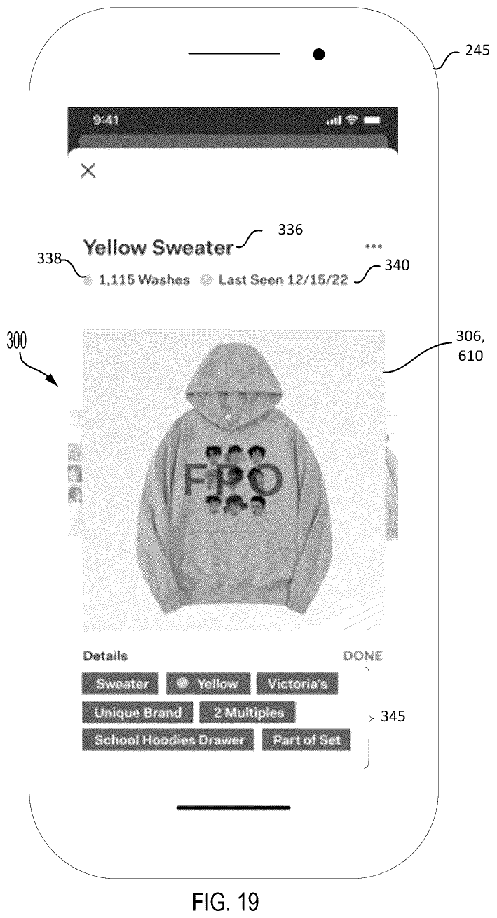

A user 208 can batch select (FIG. 17B) two or more icons 306a-n indicative of two or more laundry articles 7300 or select an image of a single article and at least one of take an action and review displayed associated details pertaining to the selected laundry article or articles 7300a-n. Additionally or alternatively, a user 208 can view a display of additional details by selecting one or more interactive fields. For example, in implementations, as depicted in FIG. 19, a selected single laundry article 7300 can appear as an image 306 on the user display 300 along with one or more associated details indicative of an article type 336, a number of cumulative washes 338 by the system 500, a date 340 of last detection by the at least one sensor 7160, 7160a-n, 7709, 7709a-n, 7952, 7952a-n, and other associated information 345 (e.g., article type, article color, article profile, article brand, article multiples count, a drawer (“cluster”) assignment, and a set assignment for pairing with one or more other articles). The other associated information 345 can be provided in response to a user 208 tapping, clicking, or voice selecting one or more interactive fields displayed on the user interface 300. Additionally, in implementations the user 208 can interact with the stored information as described previously with regard to FIGS. 16B-18B. In implementations, the associated details 336, 338, 240 and other associated information 345 comprises the image data 610, 610a-n stored in a memory 6010, 7010, 8010, 210, 235, 240, 250, 236, 237 in relation to at least one of at least one image 306, 306a-n and at least one of a user account 600 and profile 605, for example in a relational database.

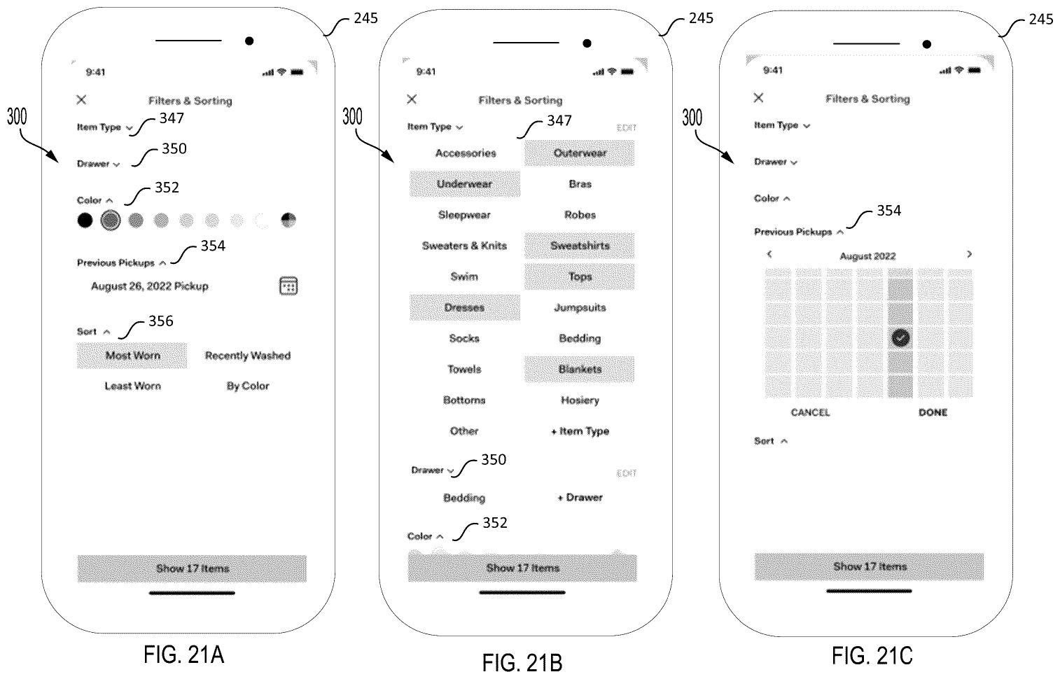

In implementations, the additional information 245 can be provided in an expandable menu, a pop up screen, a pull down menu, and as a new page display. Additionally and alternatively, in implementations as depicted in FIGS. 21A-C, a user 208 can filter and sort at least one of data 610a-n, text, and images 306a-n associated with a plurality of laundry articles 7300a-b by interacting with one or more displayed fields on a GUI 300. The displayed fields can be accessed, for example, through at least one of menu (e.g., hamburger menu, bottom bar menu, etc.), an icon, a pulldown, and a selectable page link. For example, as shown in FIG. 21A, a user 208 can select to sort on item (e.g., article) type 347 which expands to display a list, as shown in FIG. 21B, from which a user 208 can select a display of one or more particular item types. A user 208 can select a drawer (e.g., cluster) expandable menu 350 and select to display articles of one or more drawer types. A user 208 can select a color 352 on which to filter and display articles. A user 208 can enter or select to display one or more articles processed by the system 500 on a previous pick up date 354 by selecting a date from a calendar (FIG. 21C) or drop down list of dates. A user 208 can sort a display of one or more articles 7300 by another field 356 assigned by the system 500 based on observed data trends, such as one or more of most worn articles, recently washed articles, least worn articles, and color. By selecting one or more of the fields, a user 208 can filter and sort a display of at least one of image data 610a-n, text, and images 306a-n associated with a plurality of laundry articles 7300a-b and as stored over time in the at least one memory 6010, 7010, 210, 235, 236, 237, 240, 250.

Referring now to FIG. 24, any of the examples and implementations described previously with regard to an autonomously operated tiered folding system 500 are applicable to implementations described herein with regard to a method 1200 of autonomously grouping a plurality of household laundry articles 7300a-n for packing.

In implementations, the method 1200 is configured to be executed autonomously by the at least one controller 6005, 7005 205. As previously described with regard to implementations, at least one controller is configured to be in operative communication with at least the at least one sensor 7160, 7160a-c, 7709, 7709a-n, 7952, 7952a-n, the drive motor 7110 of the rotatable platter 7100, the conveyor drive motor 7517, one or more lift actuators 7520, 7520a-n, one or more attachment sensors (not shown) of the receiving coupling 7510, one or more position sensors of each pair of transfer conveyors 7515a-b, the drive motors and position sensors of the at least one clamp 7200, and the drive motors and position sensors of at least one of the elongated sweep rod 7400 and blade 7650. In examples, the controller 7005 is configured to communicate with a network 230 via at least one of wired and wireless communication protocols. In implementations, the method 1200 comprises executing one or more default folding routines and executing a folding routine based on one or more instructions (e.g., folding completion and/or non-acceptance) transmitted by a user 208 from a remote device in operable communication with the network 230.

In implementations, the method comprises receiving S1205 at the at least one controller 6005, 7005, 205 an output signal of one or more sensors 7160a-n, 7709a-n, 7952a-n disposed adjacent to at least one of an autonomous folding device 7000, 7505a-b, an autonomous spreading device 7705, 6000, and a discharge station 7950. The at least one controller is in operable communication with one or more drives of the at least one autonomous folding device, the autonomous spreading device, and at least one autonomous queuing and packing device 8000. The one or more sensors are configured to detect a laundry article 7300 of the plurality of household laundry articles 7300a-n.

The method comprises processing S1210 the output signal with one or more machine learning models stored in at least one memory in communication with the at least one controller, identifying S1215, based on processing the output signal with the machine learning model, one or more characteristics of the laundry article comprising at least one of an article type, an unfolded article size, an article shape, and one or more features of the laundry article, and determining S1220, based on a comparison of the at least one of the identified one or more characteristics to data stored in the at least one memory, a profile associated with the laundry article. The profile and associated laundry data are stored relationally in the at least one memory in communication with the at least one controller 7005, 8005, 205.

The method 1200 comprises identifying S1225 a group identifier associated with the laundry article based on at least one of: the one or more determined characteristics and associated profile, and a user-defined group identifier (e.g., cluster) associated with the profile and stored in the at least one memory in communication with the at least one controller. The method comprises instructing S1230 a drive of a queuing and packing device to queue the folded laundry article with one or more folded laundry articles in a packing queue at at least one of a location associated with the group identifier and in a stack of one or more folded articles comprising the group identifier. In implementations, queuing the folded laundry article comprises stacking the folded laundry article on or adjacent to another laundry article in a packing queue in an intelligent order for packing. An intelligent order comprises batching together articles for removal by the user and insertion into a drawer or shelf without any need for additional sorting.

In implementations, the profile 605 is one of a plurality of profiles 605a-n associated with a user account 600 and representative of an individual wearer and/or owner of the laundry article 7300. As previously described with regard to implementations of the system 500, in implementations, the method 1200 further comprises receiving a group identifier (e.g., cluster identifier) from a remote user device 245, 246, 247, 248 in communication with the at least one controller 6005, 7005, 8005, 205 over a wired or wireless network 230, and storing the group identifier in the at least one memory 6010, 7010, 8010, 210, 235, 236, 237, 240, 250. In implementations, the group identifier is input by a user 208 of the user account 600 accessing an application on a GUI and or accessing a website on GUI of the remote user device. In implementations, the method 1200 further comprises retrieving optionally provided user preference data associated with the user account 600 and stored in the at least one memory. The user preference data comprises at least one of one or more folding preferences associated with one or more laundry articles and one or more user-defined packing preferences (e.g., an optionally user-defined cluster or “drawer”) for associated one or more laundry articles. The at least one memory is configured to receive and store user preference data comprising the at least one of one or more folding preferences and the optionally inputted cluster identifier transmitted through a tap, touch, click or voice command at one or more remote devices 245, 246, 247, 248. The method 1200 further comprises instructing the one or more drives of one of the one or more autonomous folding devices to operate to fold the laundry article based on at least one of retrieved default executable instructions and at least one of generating and retrieving instructions incorporating optionally provided user folding and packing preferences.

In implementations, the at least one sensor 7160a-n, 7709a-n, 7952a-n is disposed at least one of adjacent to and above at least one of the at least one spreading station and the one or more autonomous folding devices. The at least one sensor is configured to detect the article of clean laundry and output a signal comprising image data (e.g., 3D point cloud data and/or 2D RGB image data) of the article of laundry in at least one of a folded and unfolded state.

In implementations, the method 1200 further comprises storing image data of the laundry article and a contemporaneous image data in the at least one memory in cross-referenced relation to the user account. Storing the image data and contemporaneous date includes at least one of: associating the stored image data with stored image data of the laundry article previously output by the at least one sensor and stored in the at least one memory and creating a unique entry for the stored image data and the contemporaneous date for the laundry article not previously detected by the at least one sensor. Each laundry article detected by the at least one sensor comprises a status of: (1) new and previously unidentified, (2) new and identified as associated with a profile by a user of the user account, or (3) previously detected by the at least one sensor and having at least one image previously stored in a memory location in cross reference to the user account in the at least one memory.

Additionally or alternatively, in implementations, at least one controller 7005, 205 of system 500 can determine based on one or more received signals that a laundry article is too small for folding. For example, the article could be a baby sock, a pair of underwear, or a long, thin article like a scarf. In such instances, the controller 7005 can instruct at least one of the spreading robot 6000 and the folding robot 7000 to forgo folding the laundry article 7300 and instead pass the unfolded laundry article through the remainder of the process line unfolded. A packing robot conveyor or queue platform can receive the article and deposit the unfolded laundry article into one or more containers such that the unfolded articles are deposited in a container prior to loading the one or more folded laundry articles and/or stacks of folded laundry articles from a queue platform into the conveyor. Additionally or alternatively, the packing robot conveyor can deposit the unfolded laundry articles in one or more piles on the queue platform for conveyance in aggregate into a container for returning to a household.

In embodiments, any of the one or more robots in the process line preceding the queueing and packing robot 8000 can determine one or more articles of household laundry is too small for folding and provide the one or more too small for folding laundry articles to the packing station for loading into an empty container. For example, a repositioning robot 6000 can identify and collect in a container the one or more too small for folding laundry articles and the collection container can transit on rails to the packing station, skipping any processing by subsequent robots in the process line and eliminating the time of those subsequent robots having to handle the article.

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors or circuitry or collection of circuits, e.g., a module) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips and/or magnetic disks, into a different state.

Although the subject matter contained herein has been described in detail for the purpose of illustration, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

Other examples are within the scope and spirit of the description and claims. Additionally, certain functions described above can be implemented using software, hardware, firmware, hardwiring, or combinations of any of these. Features implementing functions can also be physically located at various positions, including being distributed such that portions of functions are implemented at different physical locations.

Example embodiments of the present inventive concepts may be embodied in various devices, apparatuses, and/or methods. For example, example embodiments of the present inventive concepts may be embodied in hardware and/or in software (including firmware, resident software, micro-code, etc.). Furthermore, example embodiments of the present inventive concepts may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Example embodiments of the present inventive concepts are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors or circuitry or collection of circuits, e.g. a module) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips and/or magnetic disks, into a different state.

Although the subject matter contained herein has been described in detail for the purpose of illustration, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

Other examples are within the scope and spirit of the description and claims. Additionally, certain functions described above can be implemented using software, hardware, firmware, hardwiring, or combinations of any of these. Features implementing functions can also be physically located at various positions, including being distributed such that portions of functions are implemented at different physical locations.

As used herein, a “neural network” refers to machine learning structures. Neural networks include one or more layers of “neurons” that each receive input information and produce an output as, for example, a weighted sum of the inputs with an optional internal bias value within the neuron, or some other predetermined function that produces an output numeric value based on a combination of the input values to the neuron. The weights that are assigned to different inputs in the structure of the neural network are produced during a training process for the neural network. A simple neural network includes an input layer of neurons connected to an output layer of neurons. The output layer of neurons is configured to produce outputs based on numeric functions applied to the inputs received at the output layer such as threshold functions with parameters that are produced during a training process. A neural network may include “deep” neural networks in which multiple layers of “hidden” neurons are arranged between the input layer and the output layer with varying structures for the hidden layers including fully connected layers where the output of a neuron in a first layer is connected to an input of each neuron in the next layer or partially connected layers where the outputs of neurons in a first layer are only connected to inputs of a portion of the neurons in the next layer.

A “pose” is the position and orientation of an object in a reference frame. In some embodiments, the pose is a position and orientation of a deformable laundry article. The pose can be specified by a position in two-(x,y) or three-dimensions (x,y,z) and a heading (θ). The pose can also be further specified by an orientation including a deformable shape or volume of the laundry article, which may take into account folds, creases, curves or other shapes and positions of the laundry article. The reference frame may be a global reference frame that is fixed to the environment or may be a relative reference frame that is in relationship to another object in the environment.

“Deformable” means that a shape of an article can be bent or folded. Deformable laundry articles are typically fabric clothing or washable household items as described herein. Deformable laundry articles do not typically hold a particular or stiff shape when lifted or manipulated.

“Intelligently sorted” refers to grouping or ordering articles, for example, by size, weight, shape, function, color, fabric type, washing and/or drying requirements or other characteristics.

Throughout all implementations herein, the subscript “n” following a number identifier is intended to indicate an integer greater than one.

Throughout all implementations described herein, for clarity one or more base numbers are used in the singular to refer to a single one of a plurality of elements without any subscript identifier.

1) A remote device for displaying laundry status for a user account, comprising:
a network interface configured to communicate over a wired or wireless communication network with at least one controller of an autonomous laundry system configured to wash, dry, and fold a plurality of laundry articles associated with the user account;
a graphical user interface comprising a user display; and
a processor configured to
receive a communication from the at least one controller via the communication network, and
display in response to real time communications from the autonomous laundry system a contemporaneous status of the plurality of laundry articles processed by one or more washing and drying devices and one or more folding devices of the autonomous laundry system, wherein the contemporaneous status comprises a visual display of a percentage to completion of each of washing, drying, and folding processes for the plurality of laundry articles received by the autonomous laundry system.

2) The device of claim 1, wherein the autonomous laundry system is configured to count the plurality of articles at an intake step prior to washing the plurality of articles.

3) The device of claim 2, wherein the autonomous laundry system is configured to autonomously track progress of the plurality of articles through the one or more washing and drying devices and the one or more folding devices and the at least one controller is configured to calculate for display a percentage to completion of washing, drying, and folding the plurality of laundry articles.

4) The device of claim 3, wherein the autonomous laundry system is further configured to autonomously track progress of the plurality of laundry articles through an autonomous packing process following the folding process and provide a real time packing status on the display, the autonomous packing process being implemented by an autonomous packing device comprising one or more sensors configured to detect the plurality of laundry articles processed by the autonomous packing device, the one or more sensors being configured to output one or more signals to the at least one controller indicative of processing one or more of the plurality of laundry articles.

5) The device of claim 3, wherein the autonomous laundry system is configured to identify the plurality of laundry articles with one or more sensors disposed above and adjacent the one or more folding devices.

6) The device of claim 3, wherein the autonomous laundry system is configured to identify the one or more washing and drying devices receiving the plurality of laundry articles by tracking one or more laundry bins transported to the one or more washing and drying devices, each one of the one or more laundry bins containing a load of laundry comprising one or more of the plurality of laundry articles, wherein the one or more identified washing and drying devices are configured to communicate via the communication network a plurality of processing updates including washing and drying cycle progress.

7) The device of claim 1 further comprising an interactive user interface.

8) The device of claim 7, wherein a user can request through the interactive user interface a display of a contemporaneous status of washing, drying, and folding.

9) The device of claim 1, wherein the processor is configured to operate a local user application through which the contemporaneous status of washing, drying, and folding is displayed.

10) The device of claim 9, wherein the at least one controller of the autonomous laundry system is configured to push the contemporaneous status of washing, drying, and folding to the local user application.

11) The device of claim 9, wherein the user is configured to send at least one of a user preference and a user instruction to the at least one controller of the autonomous laundry system.

12) The device of claim 1, wherein the display of a contemporaneous status of washing, drying, and folding comprises at least three concentric annuli, wherein the percentage of fill within a first annulus of the at least three concentric annuli represents the percentage to completion of washing the plurality of laundry articles, the percentage of fill of a second annulus of the at least three concentric annuli represents the percentage to completion of drying the plurality of laundry articles, and the percentage of fill of a third annulus of the at least three concentric annuli represents the percentage to completion of folding the plurality of laundry articles.

13) The device of claim 1, wherein the display of a contemporaneous status of washing, drying, and folding comprises at least one gradually filled status bar comprising an ordered indication of washing, drying, and folding from one end of the bar to an opposite end of the bar.

14) The device of claim 13, wherein the at least one status bar comprises a plurality of status bars, wherein each bar represents a unique load of laundry displayed with a load identifier for one or more sorted loads of the plurality of laundry articles.

15) The device of claim 1, wherein the display is generated by a user application program stored in a memory of the device, the user application program being configured to facilitate communication with the autonomous laundry system.

16) An autonomous laundry system comprising:
at least one autonomous washing and drying device configured to wash and dry a plurality of household laundry articles associated with a user;
at least one autonomous folding device configured to fold the washed and dried plurality of clean household laundry articles;
one or more sensors disposed at least one of adjacent to and above at least one of the one or more autonomous folding devices, the one or more sensors being configured to detect the article of clean laundry and output a signal comprising image data of the article of laundry in at least one of a folded and unfolded state; and
at least one controller in operative communication with one or more drives of the at least one autonomous washing and folding device, one or more drives of the at least one autonomous folding device, and the one or more sensors, the at least one controller configured to
monitor one or more statuses of the plurality of household laundry articles, the one or more statuses comprising, a percentage completion of washing, drying, and folding the plurality of household laundry articles at one or more of the one or more autonomous washing and drying devices and one or more of the at least one autonomous folding device; and
push a contemporaneous percentage completion status of each of washing, drying, and folding processes for the plurality of household laundry articles to a remote user device for display on a user interface, the remote user device being in communication with the at least one controller via a wired or wireless communication network.

17) The system of claim 16, wherein the remote user device is at least one of a smartphone, a tablet, a smart watch, and a computer.

18) The system of claim 17, wherein the remote user device comprises a memory configured to store a user application and a processor configured to execute instructions for running the user application.

19) The system of claim 16, wherein the washing, drying, and folding processes are configured to operate concurrently to process a plurality of laundry loads sorted from the plurality of laundry articles.

20) The system of claim 19, wherein a display of the percentage completion of washing, drying, and folding processes comprises a graphic display of concurrently operating processes.

21) The system of claim 20, wherein the graphic display comprises at least one of contemporaneous statuses of washing, drying, and folding represented as at three fillable concentric annuli and contemporaneous statuses of washing, drying, and folding represents by at least one gradually filled status bar with an indication in order of washing, drying, and folding from one end of the bar to an opposite end of the bar.

22)-80) (canceled)
